SEQUENCE LISTING (8 sequences)

SEQ ID NO: 1 - DNA, 20 bp, Artificial Sequence
  Synthetic Construct
ttcctcttcctacagtactc

SEQ ID NO: 2 - DNA, 20 bp, Artificial Sequence
  Synthetic Construct
gcaaccagccctgtcgtctc

SEQ ID NO: 3 - DNA, 20 bp, Artificial Sequence
  Synthetic Construct
accatgagcgctgctcagat

SEQ ID NO: 4 - DNA, 20 bp, Artificial Sequence
  Synthetic Construct
agttgcaaaccagacgtcag

SEQ ID NO: 5 - DNA, 20 bp, Artificial Sequence
  Synthetic Construct
gtgttgtctcctaggttcgc

SEQ ID NO: 6 - DNA, 20 bp, Artificial Sequence
  Synthetic Construct
caagtggctcctgacctgga

SEQ ID NO: 7 - DNA, 20 bp, Artificial Sequence
  Synthetic Construct
cctatcctgagtagtggtaa

SEQ ID NO: 8 - DNA, 20 bp, Artificial Sequence
  Synthetic Construct
tgaatctgaggcataactgc

(19) United States
(12) Patent Application Publication
(10) Pub. No.: US 2015/0302140 A1
(43) Pub. Date: Oct. 22, 2015

(54) IN SILICO IDENTIFICATION OF CANCER MOLECULAR SIGNALING PATHWAYS AND DRUG CANDIDATES

(71) Applicant: H. LEE MOFFITT CANCER CENTER AND RESEARCH INSTITUTE, INC., Tampa, FL (US)

(72) Inventors: Johnathan M. Lancaster, Tampa, FL (US); Yin Xiong, Tampa, FL (US)

(73) Assignee: H. LEE MOFFIT CANCER CENTER AND RESEARCH INSTITUTE, INC., Tampa, FL (US)

(21) Appl. No.: 14/438,696

(22) PCT Filed: Nov. 4, 2013
(86) PCT No.: PCT/US13/68338

§ 371 Date: Apr. 27, 2015

Related U.S. Application Data
(60) Provisional application No. 61/721,754, filed on Nov. 2, 2012.

(51) Int. Cl. G06F 19/12; G06F 19/20

(52) U.S. Cl. CPC G06F 19/12; G06F 19/20

(57) ABSTRACT

Disclosed is an in silico method to identify molecular signaling pathways that influence cancer development as well as therapeutic compounds with activity against them.

### CROSS-REFERENCE TO RELATED APPLICATIONS

This application claims benefit of U.S. Provisional Application No. 61/721,754, filed Nov. 2, 2012, which is hereby incorporated herein by reference in its entirety.

### STATEMENT REGARDING FEDERALLY SPONSORED RESEARCH OR DEVELOPMENT

This invention was made with Government Support under Grant No. CA76292 awarded by the National Institutes of Health. The Government has certain rights in the invention.

### BACKGROUND

Ovarian cancer (OVCA) has the highest mortality of all gynecologic cancers (Siegel R, et al. CA Cancer J Clin. 2012 62(1):10-29). Although patients are initially sensitive to cytotoxic therapy (using platinum/taxane-based regimens), resistance to existing therapies develops in the majority of patients with OVCA (Baker V V. Hematol Oncol Clin North Am. 2003 17(4):977-88; Gadducci A, et al. Gynecol Oncol. 1998 68(2):150-5; Hansen H H, et al. Ann Oncol. 1993 4 Suppl 4:63-70; McGuire W P, et al. N Engl J Med. 1996 334(1):1-6). Once chemoresistance has developed, for most patients, overall survival is extremely short (Herrin V E, et al. Semin Surg Oncol. 1999 17(3):181-8). The lack of progress in improvement in cure rates for this disease is somewhat reflective of an incomplete understanding of the molecular basis to disease development. Improvements in understanding the molecular basis to ovarian carcinogenesis will hopefully lead to the identification of more active therapies.

### SUMMARY

Disclosed is an in silico strategy that identifies 1) new cancer therapeutic targets (molecular signaling pathways associated with cancer development) and 2) new cancer therapeutic candidates (drugs and agents that target molecular signaling pathways associated with cancer development). These may include new uses for existing drugs (drug re-purposing). This method was used to identify 1) genes and molecular signaling pathways associated with the development of cancer and 2) new drugs/agents that target those molecular signaling pathways and that could potentially lead to new therapeutics for ovarian cancer.

Also disclosed is an in silico method for individualized treatment of a subject with cancer that involves assaying an RNA sample from a tumor biopsy for differential gene expression in one or more molecular pathways, and using that information to select a suitable therapeutic regimine.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows results for principal component analysis (PCA) of gene expressions in NOSE (open circles), primary pelvic (filled circles), and extrapelvic (triangles) samples. The first principal component (PC1) explains 35.4% of the variation, whereas the second (PC2) explains 6.3%.

FIGS. 2A-2C are Kaplan-Meier curves depicting the association between the TGF-WNT/cytoskeleton remodeling-pathway PCA score (using median PCA threshold) and overall survival from OVCA (GSE9891, survival information available for 218 of the 220 samples) (FIG. 2A), colon cancer (GSE17538, n=177) (FIG. 2B), and leukemia (TCGA database, n=182) (FIG. 2C). Log-rank test P values indicate significance.

FIG. 3 shows Kaplan-Meier curves depicting the association between the chemokines/cell adhesion pathway PCA score (using median PCA threshold) and overall survival from colon cancer (GSE17538, n=177). Log-rank test P values indicate significance.

FIGS. 4A and 4B are Kaplan-Meier curves depicting the association between the chemokines/cell adhesion pathway PCA score (using median PCA threshold) and overall survival from OVCA (MCC dataset, n=142) (FIG. 4A) and colon cancer (GSE17538, n=177) (FIG. 4B). Log-rank test P values indicate significance.

FIG. 5 shows HeyA8 cells treated with 25 mM and 50 mM artesunate (ART) were impaired in their ability to fill in the gap of a scratch test. In contrast, cells cultured in the presence of DMSO vehicle completely closed the gap within 2 days.

FIGS. 6A to 6C are maps of the TGF-WNT/cytoskeleton remodeling pathway (FIG. 6A), chemokines/cell adhesion pathway (FIG. 6B), and histamine signaling/immune response pathway (FIG. 6C). Thermometers indicate direction change (upward or downward) in expression of genes associated with extrapelvic implant samples.

FIG. 7 is a flow chart depicting an embodiment of an in silico method to identify therapeutic agents to treat cancer.

FIG. 8 is a flow chart depicting an embodiment of an in silico method for selecting a cancer treatment regimen for a subject.

### DETAILED DESCRIPTION

Currently, the management of advanced-stage ovarian cancer (OVCA) includes cytoreductive surgery (debulking) followed by platinum-based chemotherapy. Approximately 70% of patients will demonstrate a complete clinical response to this primary therapeutic approach, however, the majority of these complete responders will eventually develop platinum-resistant, progressive or recurrent disease. Once platinum-resistance has developed, few active therapeutic options exist and patient survival is generally short-lived. These dismal statistics reflect in-part, an incomplete understanding of the root causes of ovary carcinogenesis and a lack of targeted agents that specifically attack the molecular basis of disease development.

Disclosed is an in silico method to identify molecular signaling pathways that influence cancer development, as well as to identify therapeutic compounds with activity against them. The method involves evaluating gene expression datasets to identify genes differentially expressed in cancer. For example, the method can involve identifying genes and represented pathways whose expression is increased or decreased in cancer by at least 50%, by at least 100%, or by at least 200%. The method can further involve identifying pathways represented by differentially expressed genes.

In some embodiments, the cancer is ovarian cancer (OVCA). However, the disclosed method may be used to identify molecular signaling pathways and drug candidates for any cancer type or subtype. A representative but non-limiting list of cancers include lymphoma, B cell lymphoma, T cell lymphoma, mycosis fungoides, Hodgkin's Disease, myeloid leukemia, bladder cancer, brain cancer, nervous system cancer, head and neck cancer, squamous cell carcinoma of head and neck, kidney cancer, lung cancers such as small cell lung cancer and non-small cell lung cancer, neuroblastoma/glioblastoma, ovarian cancer, pancreatic cancer, prostate cancer, skin cancer, liver cancer, melanoma, squamous cell carcinomas of the mouth, throat, larynx, and lung, colon cancer, cervical cancer, cervical carcinoma, breast cancer, epithelial cancer, renal cancer, genitourinary cancer, pulmonary cancer, esophageal carcinoma, head and neck carcinoma, large bowel cancer, hematopoietic cancers (e.g., leukemia); testicular cancer; rectal cancers, prostatic cancer, and pancreatic cancer.

In some cases, the method involves identifying genes and represented pathways within the genomic datasets that have a False Discovery Rate (FDR) less than 0.1, less than 0.05, or less than 0.01. Instead of controlling the chance of any false positives (as Bonferroni or random field methods do), FDR controls the expected proportion of false positives among suprathreshold voxels. An FDR threshold is determined from the observed p-value distribution, and hence is adaptive to the amount of signal in the data.

The method can further involve evaluating the differentially expressed pathways for associations with survival as an indication of biological relevance. The method can involve assaying a biological sample, such as a tumor biopsy, from the subject for gene expression levels, comparing these levels to control values to identify differentially expressed genes, identifying molecular pathways represented by the differentially expressed genes, evaluating the molecular pathways for associations with cancer survival as an indication of biological relevance, and identifying agents or drugs that have activity against the pathways associated with cancer survival.

In some embodiments, gene expression levels are determined using a gene expression microarray. Gene expression microarrays provide a snapshot of all the transcriptional activity in a biological sample. Unlike most traditional molecular biology tools, which generally allow the study of a single gene or a small set of genes, microarrays facilitate the discovery of totally novel and unexpected functional roles of genes. Non-limiting examples of gene expression microarrays include those produced by Affymetrix, Agilent, and Nimblegen. Affymetrix microarrays are composed of spots of 25-bp probes. A target sequence is associated with a “probe-set,” typically 11-16 probes whose signal is integrated to produce a single intensity. The sample is labeled by incorporation of biotin-labeled nucleotides, and a dedicated fluidics system washes the hybridized sample. Nimblegen and Agilent use different array synthesis methods that can create longer probes (up to ˜60 bp), and labeling is by cy3,5 fluores, which are also used to label cDNA arrays.

A wide range of methods to adjust for testing multiple samples to identify differential gene expression are available. Many rely on the assumption that the tests are independent. However, the preferred approach for microarray analysis is to control the “false-discovery rate” (FDR), the probability that any particular significant finding is a false-positive. To better account for the dependencies within the data, multiple testing adjustment using “permutation-based” methods can be used, which estimate the null distribution by permuting the actual data. If that is not feasible, the Benjamini-Hochberg step-down method offers a reasonable combination of statistical rigor and power for microarray analysis. As an example, the BioConductor software package or the GenePattern analysis pipeline software can be used to identify differential expression. Users of a multtest package can choose among several parametric methods (which make assumptions about the normality of the data), including the Welch t-test, paired t-test, or ANOVA. All of these look for differences in the average expression level between groups. Since assumptions about normality are often inappropriate, the reported p-values are more appropriately used as a guide to prioritizing the genes, not as accurate probabilities, even after adjusting for multiple testing.

Molecular pathways represented by the differentially expressed genes can be identified using databases of protein interactions and metabolic and signaling pathways. Examples of suitable databases include Ariadne Genomics' PathwayStudio®, BIOBASE's The ExPlain™ Analysis System, GeneGo's MetaCore™, Genomatix′ BiblioSphere Pathway Edition, and Ingenuity Pathways Analysis (IPA).

Multivariate statistical analysis can then be used to summate the expression of one or more molecular pathways into a single numeric value. For example, the method can involve the use of multivariate regression analysis (e.g., determined by linear regression) or principal component analysis (PCA) to generate a single numeric value for each molecular pathway. PCA is a multivariate technique that analyzes a data table in which observations are described by several inter-correlated quantitative dependent variables. Its goal is to extract the important information from the table, to represent it as a set of new orthogonal variables called principal components, and to display the pattern of similarity of the observations and of the variables as points in maps. Pathways with expression scores associated with 2 or more survival datasets can then evaluated in vitro.

The method can further involve in silico analysis to identify agents or drugs that have activity against the differentially expressed pathways associated with survival. For example, pathway scores and agent/drug sensitivity/activity scores can be compared, e.g., by Pearson's correlation, to identify drugs that demonstrate activity that correlate with the expression of each of the specific differentially expressed pathways associated with survival.

For example, using four paired normal/cancer genomic datasets from a total of 58 normal ovarian surface epithelium (NOSE) specimens and 756 epithelial ovarian cancer samples genes and represented pathways associated with OVCA were first identified in each dataset. Pathways found common to at least 3 datasets meeting an FDR<0.05 (n=14) were evaluated for associations with survival as an indication of biologic relevance. To do this, the expression of each pathway was summated into a single numeric value using PCA modeling of all objects (probesets/genes) within the pathway as defined by GeneGO Metacore™ software, and evaluated within 5 independent OVCA survival datasets. Those pathways with expression scores associated with 2 or more survival datasets were then evaluated within the NCI60 cancer cell line panel, drug screening database for associations with GI50 values over 48,000 compounds.

In this manner, TGF-WNT/cytoskeleton remodeling pathway, WNT2 pathway, integrin pathway, chemokines/cell adhesion pathway, and histamine signaling/immune response pathway were found differentially associated with OVCA and had expression (PCA) scores that suggested a biologic relevance to overall survival from the disease. Of course, it may be an oversimplification to discuss these pathways or any others as separate entities as more and more research highlights the networking and interconnectedness of biologic processes. For instance, targeting integrins directly or indirectly may decrease the invasive potential of OVCA (Choi Y P, et al. Biochem Biophys Res Commun. 2012 Epub. Sep. 28, 2012; Lau M T, et al. Cancer Lett. 2012 320(2):198-204; Sawada K, et al. J Oncol. 2012 Epub. Dec. 25, 2011), and influence chemoresponse (Loessner D, et al. Gynecol Oncol. 2012 Epub. Sep. 8, 2012), the latter of which may be associated with a downstream modulation of TGF-beta activity (Tumbarello D A, et al. Mol Cancer. 2012 11:36). For example, Integrins, TGF/Wnt, and Wnt pathways are known to affect epithelial-mesenchymal transition (EMT) (Kiefel H, et al. Carcinogenesis. 2012 33(10):1919-29; Shah P P, et al. Oncogene. 2012 31(26):3124-35; Gil D, et al. Adv Enzyme Regul. 2011 51(1):195-207; Jing Y, et al. Cell Biosci. 2011 1:29; Borok Z. J Clin Invest. 2009 119(1):7-10; Mamuya F A, et al. J Cell Mol Med. 2012 16(3):445-55; Chen Y S, et al. Mol Cell Proteomics. 2011 10(2):M110 001131).

The expression of the Integrins, TGF/Wnt, and Wnt pathways correlated with NCI60 cell line GI50 values to 89, 446, and 42 agents, respectively (Bonferroni adjusted P<0.01). Five agents were correlated with Integrins, TGF/Wnt, and Wnt pathways, while 38 compounds were common between the TGF/Wnt and Wnt pathway associations. In theory, agents identified by this methodology should demonstrate a negative influence on OVCA cell growth and/or survival through the targeted inhibition of the associated pathway. As proof of principle for this methodology, two agents were selected to test for activity against a panel of OVCA cells; Dasatinib, uniquely associated with Integrins pathway expression, and Artesunate, uniquely associated with TGF/Wnt pathway expression. Dasatinib showed significant anti-proliferative activity against a panel of OVCA cells. Similar outcomes were observed for the anti-malarial drug, Artesunate, which the in silico analysis identified to be associated with TGF/Wnt pathway expression. Artesunate has been reported to disrupt Wnt signaling as well as decrease the transcriptional expression of TGF-beta (Wang Y, et al. Zhonghua Gan Zang Bing Za Zhi. 2012 20(4):294-9; Li L N, et al. Int J Cancer. 2007 121(6):1360-5; Wenisch C, et al. J Clin Immunol. 1995 15(2):69-73). Artesunate also showed anti-proliferative activity against OVCA cells.

Therefore, also disclosed is a method of treating ovarian cancer. The method can involve administering to the subject a composition that inhibits the TGF-WNT/cytoskeleton remodeling pathway, WNT2 pathway, integrin pathway, chemokines/cell adhesion pathway, histamine signaling/immune response pathway, or any combination thereof. In some cases, the composition inhibits all of these pathways. The composition can contain, for example, Dasatinib, which is an inhibitor of the integrin pathway. The composition can contain Artesunate, which is an inhibitor of the TGF/Wnt pathway. Other agents for use in the disclosed compositions and methods can be identified by the methods disclosed herein.

In general, candidate agents can be identified from large libraries of natural products or synthetic (or semi-synthetic) extracts or chemical libraries according to methods known in the art. Those skilled in the field of drug discovery and development will understand that the precise source of test extracts or compounds is not critical to the screening procedure(s) used.

Accordingly, virtually any number of chemical extracts or compounds can be screened using the exemplary methods described herein. Examples of such extracts or compounds include, but are not limited to, plant-, fungal-, prokaryotic- or animal-based extracts, fermentation broths, and synthetic compounds, as well as modification of existing compounds. Numerous methods are also available for generating random or directed synthesis (e.g., semi-synthesis or total synthesis) of any number of chemical compounds, including, but not limited to, saccharide-, lipid-, peptide-, and nucleic acid-based compounds. Synthetic compound libraries are commercially available, e.g., from purveyors of chemical libraries including but not limited to ChemBridge Corporation (16981 Via Tazon, Suite G, San Diego, Calif., 92127, USA, www.chembridge.com); ChemDiv (6605 Nancy Ridge Drive, San Diego, Calif. 92121, USA); Life Chemicals (1103 Orange Center Road, Orange, Conn. 06477); Maybridge (Trevillett, Tintagel, Cornwall PL34 OHW, UK)

Alternatively, libraries of natural compounds in the form of bacterial, fungal, plant, and animal extracts are commercially available from a number of sources, including 02H, (Cambridge, UK), MerLion Pharmaceuticals Pte Ltd (Singapore Science Park II, Singapore 117528) and Galapagos NV (Generaal De Wittelaan L11 A3, B-2800 Mechelen, Belgium).

In addition, natural and synthetically produced libraries are produced, if desired, according to methods known in the art, e.g., by standard extraction and fractionation methods or by standard synthetic methods in combination with solid phase organic synthesis, micro-wave synthesis and other rapid throughput methods known in the art to be amenable to making large numbers of compounds for screening purposes. Furthermore, if desired, any library or compound, including sample format and dissolution is readily modified and adjusted using standard chemical, physical, or biochemical methods.

When a crude extract is found to have a desired activity, further fractionation of the positive lead extract is necessary to isolate chemical constituents responsible for the observed effect. The same assays described herein for the detection of activities in mixtures of compounds can be used to purify the active component and to test derivatives thereof. Methods of fractionation and purification of such heterogeneous extracts are known in the art. If desired, compounds shown to be useful agents for treatment are chemically modified according to methods known in the art. Compounds identified as being of therapeutic value may be subsequently analyzed using in vitro cell based models and animal models for diseases or conditions, such as those disclosed herein.

Candidate agents encompass numerous chemical classes, but are most often organic molecules, e.g., small organic compounds having a molecular weight of more than 100 and less than about 2,500 Daltons. Candidate agents can include functional groups necessary for structural interaction with proteins, particularly hydrogen bonding, and typically include at least an amine, carbonyl, hydroxyl or carboxyl group, for example, at least two of the functional chemical groups. The candidate agents often contain cyclical carbon or heterocyclic structures and/or aromatic or polyaromatic structures substituted with one or more of the above functional groups.

In some embodiments, the candidate agents are proteins. In some aspects, the candidate agents are naturally occurring proteins or fragments of naturally occurring proteins. Thus, for example, cellular extracts containing proteins, or random or directed digests of proteinaceous cellular extracts, can be used. In this way libraries of procaryotic and eucaryotic proteins can be made for screening using the methods herein. The libraries can be bacterial, fungal, viral, and vertebrate proteins, and human proteins.

The term “subject” refers to any individual who is the target of administration or treatment. The subject can be a vertebrate, for example, a mammal. Thus, the subject can be a human or veterinary patient. The term “patient” refers to a subject under the treatment of a clinician, e.g., physician.

The term “sample from a subject” refers to a tissue (e.g., tissue biopsy), organ, cell (including a cell maintained in culture), cell lysate (or lysate fraction), biomolecule derived from a cell or cellular material (e.g. a polypeptide or nucleic acid), or body fluid from a subject.

The term “treatment” refers to the medical management of a patient with the intent to cure, ameliorate, stabilize, or prevent a disease, pathological condition, or disorder. This term includes active treatment, that is, treatment directed specifically toward the improvement of a disease, pathological condition, or disorder, and also includes causal treatment, that is, treatment directed toward removal of the cause of the associated disease, pathological condition, or disorder. In addition, this term includes palliative treatment, that is, treatment designed for the relief of symptoms rather than the curing of the disease, pathological condition, or disorder; preventative treatment, that is, treatment directed to minimizing or partially or completely inhibiting the development of the associated disease, pathological condition, or disorder; and supportive treatment, that is, treatment employed to supplement another specific therapy directed toward the improvement of the associated disease, pathological condition, or disorder.

The term “tumor” or “neoplasm” refers to an abnormal mass of tissue containing neoplastic cells. Neoplasms and tumors may be benign, premalignant, or malignant. The term “cancer” or “malignant neoplasm” refers to a cell that displays uncontrolled growth, invasion upon adjacent tissues, and often metastasis to other locations of the body. The term “metastasis” refers to the spread of malignant tumor cells from one organ or part to another non-adjacent organ or part. Cancer cells can “break away,” “leak,” or “spill” from a primary tumor, enter lymphatic and blood vessels, circulate through the bloodstream, and settle down to grow within normal tissues elsewhere in the body. When tumor cells metastasize, the new tumor is called a secondary or metastatic cancer or tumor.

### EXAMPLES

### Example 1

### Materials and Methods

Identification of Molecular Signaling Pathways Associated with OVCA Development:

To identify molecular signaling pathways associated with OVCA development, an in silico analysis of 4 paired normal/cancer genomic datasets from a total of 58 normal ovarian surface epithelium (NOSE) specimens and 756 epithelial ovarian cancer samples was performed. The four datasets included: 1) the Moffitt (MCC) dataset (Affymetrix U133Plus GeneChips), 28 NOSE versus 78 OVCA; 2) the Total Cancer Care (TCC)™ dataset (Affymetrix Custom GeneChip Arrays), 12 NOSE versus 57 OVCA; 3) the Cancer Genome Atlas (TCGA) dataset (Affymetrix U133A GeneChips, publicly available), 8 NOSE versus 568 OVCA; and 4) the MD Anderson (MDA) Dataset (Affymetrix U133Plus GeneChips; publicly available), 10 NOSE versus 53 OVCA.

The MCC and TCC datasets were subjected to RMA using the Affymetrix Expression Console. Genes with an False Discovery Rate (FDR)<1% and a fold change >2 were selected for further pathway analysis. These genes were uploaded to GeneGo Metacore systems biology analysis software. Pathways represented within genes differentially expressed between NOSE and OVCA were identified and compared between the 4 datasets for commonly represented pathways.

Identification of Associations Between Expression of Molecular Signaling Pathways and Overall Survival of Patients with OVCA:

For pathways that were identified as common in 3 or more of the datasets, Principal Component Analysis (PCA) was used to generate a score that summarized the overall expression of each pathway. In this way, selecting the first principal component (PC1), a single numeric score was generated for each pathway, which summarized its level of expression. Associations were then explored between pathway expression (using median PC1 score as the threshold to define high versus low pathway score) and overall survival in 5 datasets for which both gene expression and overall survival data were available, including 1) The Moffitt (MCC) dataset (Affymetrix U133Plus GeneChips), n=142 OVCAs; 2) the Total Cancer Care (TCC)™ dataset (Affymetrix Custom GeneChip Arrays), n=57 OVCAs; 3) the Cancer Genome Atlas (TCGA) dataset (Affymetrix U133A GeneChips, publicly available), n=492 OVCAs; 4) the MD Anderson (MDA) Dataset (Affymetrix U133Plus GeneChips; publicly available), n=53 OVCAs; and 5) the Australian (Aus) Dataset (Affymetrix U133Plus GeneChips, publicly available), n=218 OVCAs.

Identification of Agents and Drugs that Target Molecular Signaling Pathways Associated with the Development of and Overall Survival from OVCA:

Pathways associated with the development of OVCA (differentially expressed between NOSE and OVCA) that also demonstrated associations between expression (PCA score) and overall patient survival in >2/5 datasets were subjected to further in silico analysis in an effort to identify novel agents or drugs that may have activity against the pathway. For this analysis, the aim was to identify novel therapeutic approaches to OVCA, either using agents that have not previously been explored as cancer therapeutics or re-purposing existing drugs as OVCA therapeutic agents. To accomplish this, Affymetrix HG-U133A expression genomic data was downloaded for 60 human cancer cell lines (6 leukemia, 9 melanoma, 9 non-small cell lung, 7 colon, 6 central nervous system, 7 ovarian, 8 renal, 2 prostate, and 6 breast cancer cell lines) and also measures of sensitivity (GI50) for each of the 60 cancer cell lines to ˜48,000 agents from the NCI website. For each pathway and all 48,000 agents/drugs in 59 NCI60 cells, a Pearson's correlation analysis was performed between pathway score and agent/drug sensitivity/activity (measured by GI50). The Pearson's correlation was between each pathway PC1 score and GI50 for ˜48,000 agents/drugs. Analysis was conducted to identify which of the 48,000 drugs demonstrated activity that correlated with the expression of each of the specific pathways. In this way, for each of the molecular signaling pathways found to be associated with both 1) OVCA development (differentially expressed between NOSE and OVCA) and 2) patient survival from OVCA, a list of agents was identified that showed activity correlated with pathway expression (that is, drugs predicted to target each specific pathway).

Statistical Analyses:

For each of the four datasets, gene expression data was compared at a probe-set level between NOSE and OVCA using Student's t-test. P-values were adjusted using the FDR methodology. For correlation analyses, significance was evaluated statistically by Pearson's score, P value, and Bonferroni-corrected P value.

Cell Culture and Survival Assays:

Ovarian cancer cell lines were either obtained from the European Collection of Cell Cultures, Salisbury, England (A2780S), or were kind gifts from Dr. Patricia Kruk, Department of Pathology, College of Medicine, University of South Florida, Tampa, Fla., and Susan Murphy, PhD, Dept of OB/GYN, Division of GYN Oncology, Duke University, Durham, N.C. (HeyA8, OVCAR2, OVCAR8, and OVCA420). Cell lines were maintained in RPMI-1640 (Invitrogen; Carlsbad, Calif.) supplemented with 10% fetal bovine serum (Fisher Scientific; Pittsburgh, Pa.), 1% sodium pyruvate, 1% penicillin/streptomycin, and 1% nonessential amino acids (HyClone; Hudson, N.H.). Mycoplasma testing was performed every 6 months following manufacturer's protocol (Lonza, Rockland, Me.).

The MTS assay was used to assess viability of the OVCA cell lines. For the assays, 3-5×10⁴ cells in 100 μL were plated to each well of a 96-well plate and allowed to adhere overnight at 37° C. and 5% CO₂. The following day, cells were incubated with increasing concentrations of drug for 72 hours. Cell viability was analyzed using the CellTiter96® MTS assay kit (Promega, Madison, Wis.). Three replicate wells were used for each drug concentration, and an additional three control wells received a diluent control without drug. After drug incubation, the optical density of each well was read at 490 nm using a SpectraMax 190 microplate reader (Molecular Devices Inc., Sunnyvale, Calif.). Percent cell survival was expressed as (control-treated)/(control-blank)×100. All experiments were performed three times, or the minimum number of times to ensure reproducibility and accuracy of the results.

Results

Identification of Molecular Signaling Pathways Associated with OVCA Development

In the in silico analysis of 4 paired normal/cancer genomic datasets from a total of 58 normal ovarian surface epithelium (NOSE) specimens and 756 epithelial ovarian cancer samples, the following numbers of differentially expressed genes (FDR<1%, fold-change >2) and represented pathways (FDR<5%) were identified: 923 genes in the Moffitt Cancer Center (MCC) dataset (506 upregulated, 417 downregulated), 2,942 genes in the Total Cancer Care (TCC) dataset (2,236 upregulated, 706 downregulated), 368 genes in The Cancer Genome Atlas (TCGA) dataset (117 upregulated, 251 downregulated), and 1,353 genes in the MD Anderson (MDA) dataset (231 upregulated, 1,122 downregulated) (Table 1). The following number of represented pathways (FDR<5%) were also identified: 19 in the MCC dataset, 35 in the TCC dataset, 18 pathways in the TCGA dataset, and 41 in the MDA dataset (Table 1).

TABLE 1
Genes and pathways associated
with the development of OVCA.

| | | # | # | # | Total | # Sig. |
|---|---|---|---|---|---|---|
| | # | OVCA | Up | Down | Sig. | Represented |
| Dataset | NOSE | Samples | Genes | Genes | Genes | Pathways |
| MCC | 28 | 78 | 506 | 417 | 923 | 19 |
| (U133PLUS) | | | | | | |
| TCC | 12 | 57 | 2236 | 706 | 2942 | 35 |
| (HuRSTA) | | | | | | |
| TCGA | 8 | 568 | 117 | 251 | 368 | 18 |
| (U133A) | | | | | | |
| MDA | 10 | 53 | 231 | 1122 | 1353 | 41 |
| (U133PLUS) | | | | | | |

Gene cutoff: FDR < 0.01, fold change > 2
Pathway cutoff: FDR < 0.05

Of the pathways identified, 4 pathways were common to all 4 datasets, 28 pathways were common to 3, and 66 pathways were common to two datasets (Table 6). We found 181 pathways that were uniquely represented in one dataset only. The 4 pathways that were identified to be common in all 4 datasets were the following: 1) Cytoskeleton remodeling_TGF, WNT and cytoskeletal remodeling, 2) Immune response_Alternative complement pathway, 3) Immune response_MIF—the neuroendocrine-macrophage connector, and 4) Integrins (Table 2). A list of these pathways can be found in Table 2 along with the number of genes (objects) found differentially expressed in cancer belonging to that pathway over the total number of objects within that pathway, and the represented P-value.

TABLE 2
Common biologic pathways associated
with OVCA development in all used databases.

| | Cytoskeleton remodeling_TGF, | | | | Immune response_ | | | |
|---|---|---|---|---|---|---|---|---|
| | WNT and | | | | Alternative | | | |
| Pathway | cytoskeletal remodeling | | | | complement pathway | | | |
| Database | MCC | TCC | TCGA | MDA | MCC | TCC | TCGA | MDA |
| # Objects | 7/111 | 16/111 | 5/111 | 10/111 | 4/39 | 16/39 | 3/39 | 10/39 |
| P-Value | 0.033 | 0.009 | 0.034 | 0.008 | 0.022 | <0.001 | 0.025 | <0.001 |
| FDR < 0.05? | No | No | No | No | No | Yes | No | Yes |
| | Immune response_MIF- | | | | | | | |
| | the neuroendocrine- | | | | | | | |
| Pathway | macrophage connector | | | | Integrins | | | |
| Database | MCC | TCC | TCGA | MDA | MCC | TCC | TCGA | MDA |
| # Objects | 5/46 | 8/46 | 3/46 | 7/46 | 3/22 | 5/22 | 2/22 | 3/22 |
| P-Value | 0.008 | 0.021 | 0.038 | 0.001 | 0.022 | 0.022 | 0.049 | 0.046 |
| FDR < 0.05? | No | No | No | Yes | No | No | No | No |

MCC: Moffitt Cancer Center
TCC: Total Cancer Care Protocol
TCGA: Thel Cancer Genome Atlas
MDA: MD Anderson

Out of the 28 pathways found common in 3 datasets, 10 pathways showed an FDR<0.05, including: 1) Cell cycle_The metaphase checkpoint, 2) Cell cycle_Spindle assembly and chromosome separation, 3) Cell cycle_Role of APC in cell cycle regulation, 4) Cell cycle_Chromosome condensation in prometaphase, 5) Cell cycle_Initiation of mitosis, 6) Cell cycle_Nucleocytoplasmic transport of CDK/Cyclins, 7) Reproduction_Progesterone-mediated oocyte maturation, 8) Cell cycle_Role of Nek in cell cycle regulation, 9) Cell adhesion_Tight junctions, and 10) Development_WNT signaling pathway, Part 2.

Identification of Associations Between Expression of Molecular Signaling Pathways and Overall Survival of Patients with OVCA

To analyze associations between pathway expression and patient overall survival, the PCA methodology was used to derive a numeric score that summarized the overall expression of each pathway. The first principal component (PC1), which contains the highest variance, was used to define high versus low pathway score. Using the median PC1 as a threshold, each of the 14 pathways (pathways common to ≧3 datasets with FDR<0.05) was tested for an association with overall survival in 5 independent OVCA datasets (Table 3). Only pathways associated with survival in more than one OVCA dataset were considered further. This analysis indicated that overall survival from OVCA was associated with the expression of TGF/WNT, Integrins, and WNT2 pathways. Expression of the TGF/WNT pathway was associated with survival in two datasets (MCC, P<0.01 and Aus, P<0.01). Expression of the Integrins pathway was associated with survival in three datasets (MCC, P<0.001, Aus, P=0.02; and TCC™, P=0.05). WNT2 was associated with survival in two datasets (MCC, P<0.01; and TCC™, P<0.01) (Table 3). Genes included in the PC1 signature scores for the Integrins, TGF/WNT, and WNT2 pathways are listed in Table 4.

TABLE 3
The association of pathway expression scores, as determined by PCA modeling, with
survival from OVCA. Median PCA score was used as a threshold.

| | | p-values | | | | |
|---|---|---|---|---|---|---|
| Pathway Name | Abbreviation | MCC | MDA | AUS | TCC | TCGA |
| Cytoskeleton remodeling_TGF, | TGF.WNT | 0.0099 | 0.1247 | 0.0055 | 0.4695 | 0.9162 |
| WNT and cytoskeletal remodeling | | | | | | |
| Immune response_Alternative | Immune | 0.3255 | 0.6733 | 0.6925 | 0.5714 | 0.2034 |
| complement pathway | | | | | | |
| Immune response_MIF - the | MIF | 0.0016 | 0.8244 | 0.3228 | 0.9348 | 0.1161 |
| neuroendocrine-macrophage | | | | | | |
| connector | | | | | | |
| Integrins | Integrins | 4.00E−04 | 0.9618 | 0.0221 | 0.0457 | 0.723 |
| Cell cycle_The metaphase | metaphase | 0.7817 | 0.4034 | 0.8891 | 0.264 | 0.9152 |
| checkpoint | | | | | | |
| Cell cycle_Spindle assembly and | Spindle | 0.3587 | 0.5336 | 0.6782 | 0.2669 | 0.6367 |
| chromosome separation | | | | | | |
| Cell cycle_Role of APC in cell | APC | 0.2925 | 0.7035 | 0.8763 | 0.3237 | 0.6887 |
| cycle regulation | | | | | | |
| Cell cycle_Chromosome | prometaphase | 0.123 | 0.2978 | 0.9533 | 0.1674 | 0.461 |
| condensation in prometaphase | | | | | | |
| Cell cycle_Initiation of mitosis | mitosis | 0.0779 | 0.9422 | 0.8708 | 0.0808 | 0.2365 |
| Cell cycle_Nucleocytoplasmic | CDK | 0.515 | 0.5642 | 0.8876 | 0.6047 | 0.5741 |
| transport of CDK/Cyclins | | | | | | |
| Reproduction_Progesterone- | oocyte | 0.0059 | 0.7217 | 0.1051 | 0.5166 | 0.7599 |
| mediated oocyte maturation | | | | | | |
| Cell cycle_Role of Nek in cell | Nek | 0.6154 | 0.9161 | 0.8622 | 0.1557 | 0.7758 |
| cycle regulation | | | | | | |
| Cell adhesion_Tight junctions | Tight | 0.0249 | 0.9733 | 0.0631 | 0.8872 | 0.9205 |
| Development_WNT signaling | WNT2 | 0.002 | 0.4174 | 0.1594 | 0.0081 | 0.343 |
| pathway. Part 2 | | | | | | |

TABLE 4
Genes used for PCA modeling from the Integrins, TGF/Wnt, and Wnt
pathways.

| TGF-WNT | WNT2 | Integrins |
|---|---|---|
| ACTA1 | APC | ANGPT1 |
| ACTA2 | AXIN1 | ANGPT2 |
| ACTB | AXIN2 | EGFR |
| ACTC1 | BMP4 | F11R |
| ACTG1 | SMARCA4 | FGF1 |
| ACTG2 | BCL9 | FIGF |
| ACTN1 | CTNNB1 | FLT1 |
| ACTN2 | CREBBP | ITGA1 |
| ACTN3 | CD44 | ITGA3 |
| ACTN4 | CBY1 | ITGA5 |
| ACTR2 | CSNK1E | ITGA9 |
| ACTR3 | CSNK2A1 | ITGAV |
| ACTR3B | CSNK2A2 | ITGB1 |
| AKT1 | CLDN1 | ITGB3 |
| AKT2 | CCND1 | ITGB6 |
| AKT3 | DAB2 | ITGB8 |
| ARPC1A | DKK1 | KDR |
| ARPC1B | DVL1 | NGF |
| ARPC2 | DVL2 | PRKCA |
| ARPC3 | DVL3 | PRKCB |
| ARPC4 | CDH1 | PRKCD |
| ARPC5 | ENC1 | PRKCE |
| AXIN1 | FRAT1 | PRKCG |
| AXIN2 | FOSL1 | PRKCH |
| BCAR1 | FZD1 | PRKCI |
| CASP9 | FZD10 | PRKCQ |
| CAV1 | FZD2 | PRKCZ |
| CCND1 | FZD3 | PRKD1 |
| CDC42 | FZD4 | PRKD2 |
| CDKN1A | FZD5 | PRKD3 |
| CDKN2B | FZD6 | PTK2 |
| CFL1 | FZD7 | SEMA7A |
| CFL2 | FZD8 | SRC |
| CHUK | FZD9 | VEGFA |
| COL4A1 | GSK3B | VEGFC |
| COL4A2 | TCF4 | |
| COL4A3 | LRP5 | |
| COL4A4 | LEF1 | |
| COL4A5 | MESDC2 | |
| COL4A6 | MMP26 | |
| CRK | MMP7 | |
| CSNK2A1 | NLK | |
| CSNK2A2 | NRCAM | |
| CSNK2B | REST | |
| CTNNB1 | PPM1A | |
| DOCK1 | PPARD | |
| DSTN | PYGO1 | |
| DVL1 | PYGO2 | |
| DVL2 | GAST | |
| DVL3 | RUVBL1 | |
| EIF4E | RUVBL2 | |
| EIF4EBP1 | RHOA | |
| FN1 | SNAI2 | |
| FOXO3 | SNAI1 | |
| FRAT1 | BIRC5 | |
| FZD1 | TAB1 | |
| FZD10 | MAP3K7 | |
| FZD2 | TCF7L2 | |
| FZD3 | TCF7 | |
| FZD4 | TCF7L1 | |
| FZD5 | VEGFA | |
| FZD6 | VIM | |
| FZD7 | WIF1 | |
| FZD8 | WNT1 | |
| FZD9 | WNT10A | |
| GRB2 | WNT10B | |
| GSK3B | WNT11 | |
| HRAS | WNT16 | |
| ILK | WNT2 | |
| JUN | WNT2B | |
| KDR | WNT3 | |
| LAMA1 | WNT3A | |
| LAMB1 | WNT4 | |
| LAMC1 | WNT5A | |
| LEF1 | WNT5B | |
| LIMK1 | WNT6 | |
| LIMK2 | WNT7A | |
| LRP5 | WNT7B | |
| MAP2K1 | WNT8A | |
| MAP2K2 | WNT8B | |
| MAP2K3 | WNT9A | |
| MAP3K11 | WNT9B | |
| MAP3K7 | JUN | |
| MAPK1 | MYC | |
| MAPK11 | | |
| MAPK12 | | |
| MAPK13 | | |
| MAPK14 | | |
| MAPK3 | | |
| MDM2 | | |
| MKNK1 | | |
| MMP13 | | |
| MMP7 | | |
| MTOR | | |
| MYC | | |
| MYL1 | | |
| MYL12A | | |
| MYL12B | | |
| MYL2 | | |
| MYL3 | | |
| MYL4 | | |
| MYL5 | | |
| MYL6 | | |
| MYL6B | | |
| MYL7 | | |
| MYL9 | | |
| MYLK | | |
| MYLK2 | | |
| MYLK3 | | |
| MYLPF | | |
| NCL | | |
| NLK | | |
| PAK1 | | |
| PIK3CA | | |
| PIK3CB | | |
| PIK3CD | | |
| PIK3R1 | | |
| PIK3R2 | | |
| PIK3R3 | | |
| PLAT | | |
| PLAU | | |
| PLAUR | | |
| PLG | | |
| PPARD | | |
| PPP1CB | | |
| PPP1R12A | | |
| PTK2 | | |
| PXN | | |
| RAC1 | | |
| RAF1 | | |
| RHEB | | |
| RHOA | | |
| ROCK1 | | |
| ROCK2 | | |
| RPS6KA5 | | |
| SERPINE1 | | |
| SERPING1 | | |
| SHC1 | | |
| SMAD2 | | |
| SMAD3 | | |
| SOS1 | | |
| SOS2 | | |
| SP1 | | |
| SRC | | |
| TAB1 | | |
| TCF7 | | |
| TCF7L1 | | |
| TCF7L2 | | |
| TGFB1 | | |
| TGFBR1 | | |
| TGFBR2 | | |
| TLN1 | | |
| TLN2 | | |
| TP53 | | |
| TSC2 | | |
| VAV1 | | |
| VCL | | |
| VEGFA | | |
| VTN | | |
| WASL | | |
| WIF1 | | |
| WNT1 | | |
| WNT10A | | |
| WNT10B | | |
| WNT11 | | |
| WNT16 | | |
| WNT2 | | |
| WNT2B | | |
| WNT3 | | |
| WNT3A | | |
| WNT4 | | |
| WNT5A | | |
| WNT5B | | |
| WNT6 | | |
| WNT7A | | |
| WNT7B | | |
| WNT8A | | |
| WNT8B | | |
| WNT9A | | |
| WNT9B | | |
| XIAP | | |
| ZFYVE9 | | |

Identification of Compounds that Target Molecular Signaling Pathways Associated with the Development of and Overall Survival from OVCA

In an effort to identify novel therapeutic approaches for the treatment of OVCA, either using agents not previously explored as cancer therapeutics or by re-purposing existing drugs as OVCA therapeutic agents, compounds were identified with in vitro activity that correlated with pathway expression. Pathways that were associated with the development of OVCA (differentially expressed between NOSE and OVCA) and that demonstrated associations between expression (PCA score) and overall patient survival in more than one OVCA dataset were correlated with in-vitro sensitivity of the NCI60 cell line panel to 48,000 compounds. Pearson's correlation indicated that in-vitro expression of the Integrins pathway (quantified by PC1 score) was associated with NCI60 cell line sensitivity (quantified by GI50) to 89 agents (P<0.01, Bonferroni adjusted), whereas the WNT2 pathway PC1 score was associated with sensitivity to 42 agents (P<0.01, Bonferroni adjusted), and the TGF/WNT pathway PC1 score was associated with sensitivity to 446 agents (P<0.01, Bonferroni adjusted) (Tables 7-9).

Identified Compounds Decrease OVCA Cell Proliferation

The cytotoxic effects of continuous exposure to dasatinib and artesunate were assessed for five OVCA cell lines at 72 hours using the MTS assay (Table 5). The mean IC₅₀ of Dasatinib was 0.577 uM (log 10; −0.30486 uM) with a range of 0.214 uM to 0.953 uM (log 10; −0.02085 uM to −0.6685 uM). The median IC₅₀ of artesunate was 7.13 uM (log 10; 0.6321 uM) with a range of 1.23 uM to 19.32 uM (log 10; 0.0882 uM to 1.286 uM).

TABLE 5
Sensitivity of OVCA cell lines to Dasatinib and Artesunate as determined
by MTS cell proliferation assays.

| | A2780S | OVCA420 | OVCA2 | OVCA8 | HEYA8 |
|---|---|---|---|---|---|
| Dasatinib: | | | | | |
| Log₁₀ IC₅₀ | −0.03735 | −0.3655 | −0.02085 | −0.4321 | −0.6685 |
| SEM | 0.03997 | 0.1225 | 0.1337 | 0.05971 | 0.07254 |
| Artesunate: | | | | | |
| Log₁₀ IC₅₀ | 0.0882 | 1.286 | 0.1173 | 0.7705 | 0.8985 |
| SEM | 0.0564 | 0.06618 | 0.02667 | 0.05188 | 0.07381 |

TABLE 6
Pathways common to all datasets

| | FDR | | | | |
|---|---|---|---|---|---|
| Pathway Name | <0.05 | p-value | ratio | dataset | common |
| Cytoskeleton remodeling_TGF, WNT and | no | 9.05E−03 | 16/111 | tcc | 4 |
| cytoskeletal remodeling | | | | | |
| Cytoskeleton remodeling_TGF, WNT and | no | 3.39E−02 | 5/111 | tcga | 4 |
| cytoskeletal remodeling | | | | | |
| Cytoskeleton remodeling_TGF, WNT and | no | 8.06E−03 | 10/111 | mda | 4 |
| cytoskeletal remodeling | | | | | |
| Cytoskeleton remodeling_TGF, WNT and | no | 3.33E−02 | 7/111 | mcc | 4 |
| cytoskeletal remodeling | | | | | |
| Immune response_Alternative complement | yes | 6.99E−09 | 16/39 | tcc | 4 |
| pathway | | | | | |
| Immune response_Alternative complement | no | 2.49E−02 | 3/39 | tcga | 4 |
| pathway | | | | | |
| Immune response_Alternative complement | yes | 1.05E−06 | 10/39 | mda | 4 |
| pathway | | | | | |
| Immune response_Alternative complement | no | 2.17E−02 | 4/39 | mcc | 4 |
| pathway | | | | | |
| Immune response_MIF - the | no | 2.07E−02 | 8/46 | tcc | 4 |
| neuroendocrine-macrophage connector | | | | | |
| Immune response_MIF - the | no | 3.81E−02 | 3/46 | tcga | 4 |
| neuroendocrine-macrophage connector | | | | | |
| Immune response_MIF - the | yes | 1.40E−03 | 7/46 | mda | 4 |
| neuroendocrine-macrophage connector | | | | | |
| Immune response_MIF - the | no | 8.30E−03 | 5/46 | mcc | 4 |
| neuroendocrine-macrophage connector | | | | | |
| Integrins | no | 2.18E−02 | 5/22 | tcc | 4 |
| Integrins | no | 4.87E−02 | 2/22 | tcga | 4 |
| Integrins | no | 4.63E−02 | 3/22 | mda | 4 |
| Integrins | no | 2.16E−02 | 3/22 | mcc | 4 |
| Apoptosis and survival_BAD | no | 4.58E−03 | 4/42 | tcga | 3 |
| phosphorylation | | | | | |
| Apoptosis and survival_BAD | yes | 8.00E−04 | 7/42 | mda | 3 |
| phosphorylation | | | | | |
| Apoptosis and survival_BAD | no | 5.63E−03 | 5/42 | mcc | 3 |
| phosphorylation | | | | | |
| Apoptosis and survival_Role of IAP- | no | 1.34E−02 | 3/31 | tcga | 3 |
| proteins in apoptosis | | | | | |
| Apoptosis and survival_Role of IAP- | no | 2.66E−02 | 4/31 | mda | 3 |
| proteins in apoptosis | | | | | |
| Apoptosis and survival_Role of IAP- | yes | 1.69E−04 | 6/31 | mcc | 3 |
| proteins in apoptosis | | | | | |
| Cell adhesion_Endothelial cell contacts by | yes | 1.15E−06 | 11/26 | tcc | 3 |
| junctional mechanisms | | | | | |
| Cell adhesion_Endothelial cell contacts by | no | 1.46E−02 | 4/26 | mda | 3 |
| junctional mechanisms | | | | | |
| Cell adhesion_Endothelial cell contacts by | yes | 5.94E−05 | 6/26 | mcc | 3 |
| junctional mechanisms | | | | | |
| Cell adhesion_Plasmin signaling | no | 3.88E−03 | 8/35 | tcc | 3 |
| Cell adhesion_Plasmin signaling | yes | 1.63E−03 | 6/35 | mda | 3 |
| Cell adhesion_Plasmin signaling | no | 2.51E−03 | 5/35 | mcc | 3 |
| Cell adhesion_Tight junctions | yes | 2.39E−04 | 10/36 | tcc | 3 |
| Cell adhesion_Tight junctions | yes | 1.90E−03 | 6/36 | mda | 3 |
| Cell adhesion_Tight junctions | yes | 3.99E−04 | 6/36 | mcc | 3 |
| Cell cycle_Cell cycle (generic schema) | yes | 1.71E−05 | 5/21 | tcga | 3 |
| Cell cycle_Cell cycle (generic schema) | no | 6.76E−03 | 4/21 | mda | 3 |
| Cell cycle_Cell cycle (generic schema) | yes | 1.57E−05 | 6/21 | mcc | 3 |
| Cell cycle_Chromosome condensation in | yes | 2.71E−13 | 10/21 | tcga | 3 |
| prometaphase | | | | | |
| Cell cycle_Chromosome condensation in | yes | 4.40E−07 | 8/21 | mda | 3 |
| prometaphase | | | | | |
| Cell cycle_Chromosome condensation in | yes | 4.39E−08 | 8/21 | mcc | 3 |
| prometaphase | | | | | |
| Cell cycle_Initiation of mitosis | yes | 2.23E−06 | 6/25 | tcga | 3 |
| Cell cycle_Initiation of mitosis | yes | 2.06E−06 | 8/25 | mda | 3 |
| Cell cycle_Initiation of mitosis | yes | 3.46E−06 | 7/25 | mcc | 3 |
| Cell cycle_Nucleocytoplasmic transport of | yes | 4.37E−08 | 6/14 | tcga | 3 |
| CDK/Cyclins | | | | | |
| Cell cycle_Nucleocytoplasmic transport of | yes | 1.04E−04 | 5/14 | mda | 3 |
| CDK/Cyclins | | | | | |
| Cell cycle_Nucleocytoplasmic transport of | yes | 3.21E−08 | 7/14 | mcc | 3 |
| CDK/Cyclins | | | | | |
| Cell cycle_Regulation of G1/S transition | yes | 2.92E−05 | 6/38 | tcga | 3 |
| (part 1) | | | | | |
| Cell cycle_Regulation of G1/S transition | yes | 2.52E−03 | 6/38 | mda | 3 |
| (part 1) | | | | | |
| Cell cycle_Regulation of G1/S transition | no | 3.63E−03 | 5/38 | mcc | 3 |
| (part 1) | | | | | |
| Cell cycle_Regulation of G1/S transition | yes | 7.47E−04 | 4/26 | tcga | 3 |
| (part 2) | | | | | |
| Cell cycle_Regulation of G1/S transition | no | 1.46E−02 | 4/26 | mda | 3 |
| (part 2) | | | | | |
| Cell cycle_Regulation of G1/S transition | no | 5.21E−03 | 4/26 | mcc | 3 |
| (part 2) | | | | | |
| Cell cycle_Role of APC in cell cycle | yes | 1.30E−12 | 11/32 | tcga | 3 |
| regulation | | | | | |
| Cell cycle_Role of APC in cell cycle | yes | 9.96E−09 | 11/32 | mda | 3 |
| regulation | | | | | |
| Cell cycle_Role of APC in cell cycle | yes | 1.26E−07 | 9/32 | mcc | 3 |
| regulation | | | | | |
| Cell cycle_Role of Nek in cell cycle | yes | 1.21E−09 | 9/32 | tcga | 3 |
| regulation | | | | | |
| Cell cycle_Role of Nek in cell cycle | yes | 1.59E−05 | 8/32 | mda | 3 |
| regulation | | | | | |
| Cell cycle_Role of Nek in cell cycle | yes | 1.67E−03 | 5/32 | mcc | 3 |
| regulation | | | | | |
| Cell cycle_Sister chromatid cohesion | yes | 3.84E−04 | 4/22 | tcga | 3 |
| Cell cycle_Sister chromatid cohesion | no | 8.03E−03 | 4/22 | mda | 3 |
| Cell cycle_Sister chromatid cohesion | no | 2.16E−02 | 3/22 | mcc | 3 |
| Cell cycle_Spindle assembly and | yes | 1.29E−15 | 13/33 | tcga | 3 |
| chromosome separation | | | | | |
| Cell cycle_Spindle assembly and | yes | 1.45E−08 | 11/33 | mda | 3 |
| chromosome separation | | | | | |
| Cell cycle_Spindle assembly and | yes | 1.10E−08 | 10/33 | mcc | 3 |
| chromosome separation | | | | | |
| Cell cycle_The metaphase checkpoint | yes | 1.80E−13 | 12/36 | tcga | 3 |
| Cell cycle_The metaphase checkpoint | yes | 3.13E−09 | 12/36 | mda | 3 |
| Cell cycle_The metaphase checkpoint | yes | 1.79E−09 | 11/36 | mcc | 3 |
| Cell cycle_Transition and termination of | yes | 9.97E−04 | 4/28 | tcga | 3 |
| DNA replication | | | | | |
| Cell cycle_Transition and termination of | no | 1.89E−02 | 4/28 | mda | 3 |
| DNA replication | | | | | |
| Cell cycle_Transition and termination of | yes | 9.28E−05 | 6/28 | mcc | 3 |
| DNA replication | | | | | |
| Cytoskeleton remodeling_Keratin filaments | yes | 7.33E−06 | 12/36 | tcc | 3 |
| Cytoskeleton remodeling_Keratin filaments | no | 4.32E−02 | 4/36 | mda | 3 |
| Cytoskeleton remodeling_Keratin filaments | yes | 3.85E−07 | 9/36 | mcc | 3 |
| Development_EPO-induced PI3K/AKT | no | 4.08E−02 | 7/43 | tcc | 3 |
| pathway and Ca(2+) influx | | | | | |
| Development_EPO-induced PI3K/AKT | no | 3.20E−02 | 3/43 | tcga | 3 |
| pathway and Ca(2+) influx | | | | | |
| Development_EPO-induced PI3K/AKT | no | 2.99E−02 | 4/43 | mcc | 3 |
| pathway and Ca(2+) influx | | | | | |
| Development_Regulation of epithelial-to- | no | 2.10E−02 | 10/64 | tcc | 3 |
| mesenchymal transition (EMT) | | | | | |
| Development_Regulation of epithelial-to- | yes | 8.65E−10 | 16/64 | mda | 3 |
| mesenchymal transition (EMT) | | | | | |
| Development_Regulation of epithelial-to- | no | 8.11E−03 | 6/64 | mcc | 3 |
| mesenchymal transition (EMT) | | | | | |
| Development_TGF-beta-dependent | no | 4.53E−02 | 6/35 | tcc | 3 |
| induction of EMT via SMADs | | | | | |
| Development_TGF-beta-dependent | yes | 3.46E−07 | 10/35 | mda | 3 |
| induction of EMT via SMADs | | | | | |
| Development_TGF-beta-dependent | no | 2.51E−03 | 5/35 | mcc | 3 |
| induction of EMT via SMADs | | | | | |
| Development_WNT signaling pathway. Part 2 | yes | 1.73E−03 | 11/53 | tcc | 3 |
| Development_WNT signaling pathway. Part 2 | yes | 6.81E−04 | 8/53 | mda | 3 |
| Development_WNT signaling pathway. Part 2 | yes | 5.76E−04 | 7/53 | mcc | 3 |
| G-protein signaling_Regulation of CDC42 | no | 3.51E−02 | 6/33 | tcc | 3 |
| activity | | | | | |
| G-protein signaling_Regulation of CDC42 | yes | 1.87E−03 | 4/33 | tcga | 3 |
| activity | | | | | |
| G-protein signaling_Regulation of CDC42 | yes | 1.18E−03 | 6/33 | mda | 3 |
| activity | | | | | |
| Histamine metabolism | yes | 1.14E−03 | 4/29 | tcga | 3 |
| Histamine metabolism | no | 2.13E−02 | 4/29 | mda | 3 |
| Histamine metabolism | no | 4.45E−02 | 3/29 | mcc | 3 |
| PGE2 pathways in cancer | yes | 6.78E−04 | 12/55 | tcc | 3 |
| PGE2 pathways in cancer | no | 1.57E−02 | 6/55 | mda | 3 |
| PGE2 pathways in cancer | yes | 1.17E−04 | 8/55 | mcc | 3 |
| Reproduction_Progesterone-mediated | yes | 4.32E−04 | 5/40 | tcga | 3 |
| oocyte maturation | | | | | |
| Reproduction_Progesterone-mediated | yes | 1.18E−05 | 9/40 | mda | 3 |
| oocyte maturation | | | | | |
| Reproduction_Progesterone-mediated | yes | 7.17E−04 | 6/40 | mcc | 3 |
| oocyte maturation | | | | | |
| Retinol metabolism/Rodent version | yes | 2.01E−03 | 13/70 | tcc | 3 |
| Retinol metabolism/Rodent version | no | 2.65E−02 | 4/70 | tcga | 3 |
| Retinol metabolism/Rodent version | no | 4.49E−02 | 6/70 | mda | 3 |
| Signal transduction_PKA signaling | no | 1.32E−02 | 9/51 | tcc | 3 |
| Signal transduction_PKA signaling | no | 3.98E−02 | 5/51 | mda | 3 |
| Signal transduction_PKA signaling | no | 1.27E−02 | 5/51 | mcc | 3 |
| Apoptosis and survival_HTR1A signaling | no | 3.26E−02 | 8/50 | tcc | 2 |
| Apoptosis and survival_HTR1A signaling | no | 1.00E−02 | 6/50 | mda | 2 |
| Apoptosis and survival_p53-dependent | yes | 1.14E−03 | 4/29 | tcga | 2 |
| apoptosis | | | | | |
| Apoptosis and survival_p53-dependent | yes | 1.05E−03 | 5/29 | mcc | 2 |
| apoptosis | | | | | |
| Apoptosis and survival_Role of CDK5 in | no | 1.73E−02 | 3/34 | tcga | 2 |
| neuronal death and survival | | | | | |
| Apoptosis and survival_Role of CDK5 in | no | 2.20E−03 | 5/34 | mcc | 2 |
| neuronal death and survival | | | | | |
| Cell adhesion_Cadherin-mediated cell | yes | 4.72E−04 | 8/26 | tcc | 2 |
| adhesion | | | | | |
| Cell adhesion_Cadherin-mediated cell | no | 3.37E−02 | 3/26 | mcc | 2 |
| adhesion | | | | | |
| Cell adhesion_Chemokines and adhesion | yes | 4.45E−04 | 18/100 | tcc | 2 |
| Cell adhesion_Chemokines and adhesion | yes | 3.11E−04 | 12/100 | mda | 2 |
| Cell adhesion_ECM remodeling | yes | 9.49E−05 | 13/52 | tcc | 2 |
| Cell adhesion_ECM remodeling | yes | 2.40E−06 | 11/52 | mda | 2 |
| Cell adhesion_Ephrin signaling | no | 5.77E−03 | 9/45 | tcc | 2 |
| Cell adhesion_Ephrin signaling | yes | 1.22E−03 | 7/45 | mda | 2 |
| Cell adhesion_Histamine H1 receptor | no | 5.77E−03 | 9/45 | tcc | 2 |
| signaling in the interruption of cell barrier | | | | | |
| integrity | | | | | |
| Cell adhesion_Histamine H1 receptor | no | 3.46E−02 | 4/45 | mcc | 2 |
| signaling in the interruption of cell barrier | | | | | |
| integrity | | | | | |
| Cell adhesion_Role of CDK5 in cell | no | 3.01E−03 | 4/9 | tcc | 2 |
| adhesion | | | | | |
| Cell adhesion_Role of CDK5 in cell | no | 2.39E−02 | 2/9 | mcc | 2 |
| adhesion | | | | | |
| Cell cycle_Role of 14-3-3 proteins in cell | no | 5.11E−03 | 3/22 | tcga | 2 |
| cycle regulation | | | | | |
| Cell cycle_Role of 14-3-3 proteins in cell | no | 2.16E−02 | 3/22 | mcc | 2 |
| cycle regulation | | | | | |
| Cell cycle_Role of SCF complex in cell | no | 1.12E−02 | 3/29 | tcga | 2 |
| cycle regulation | | | | | |
| Cell cycle_Role of SCF complex in cell | no | 7.76E−03 | 4/29 | mcc | 2 |
| cycle regulation | | | | | |
| Cell cycle_Start of DNA replication in early | no | 1.46E−02 | 3/32 | tcga | 2 |
| S phase | | | | | |
| Cell cycle_Start of DNA replication in early | no | 2.96E−02 | 4/32 | mda | 2 |
| S phase | | | | | |
| CFTR-dependent regulation of ion channels | no | 1.60E−02 | 8/44 | tcc | 2 |
| in Airway Epithelium (norm and CF) | | | | | |
| CFTR-dependent regulation of ion channels | no | 6.88E−03 | 5/44 | mcc | 2 |
| in Airway Epithelium (norm and CF) | | | | | |
| Chemotaxis_Inhibitory action of lipoxins on | no | 4.93E−02 | 3/51 | tcga | 2 |
| IL-8- and Leukotriene B4-induced | | | | | |
| neutrophil migration | | | | | |
| Chemotaxis_Inhibitory action of lipoxins on | no | 3.98E−02 | 5/51 | mda | 2 |
| IL-8- and Leukotriene B4-induced | | | | | |
| neutrophil migration | | | | | |
| Chemotaxis_Leukocyte chemotaxis | yes | 4.12E−04 | 15/75 | tcc | 2 |
| Chemotaxis_Leukocyte chemotaxis | no | 3.31E−02 | 4/75 | tcga | 2 |
| Cytoskeleton remodeling_Reverse signaling | no | 2.65E−02 | 6/31 | tcc | 2 |
| by ephrin B | | | | | |
| Cytoskeleton remodeling_Reverse signaling | no | 2.66E−02 | 4/31 | mda | 2 |
| by ephrin B | | | | | |
| Development_A1 receptor signaling | no | 4.43E−02 | 8/53 | tcc | 2 |
| Development_A1 receptor signaling | yes | 6.81E−04 | 8/53 | mda | 2 |
| Development_Angiotensin signaling via | no | 3.06E−02 | 6/32 | tcc | 2 |
| STATs | | | | | |
| Development_Angiotensin signaling via | no | 2.96E−02 | 4/32 | mda | 2 |
| STATs | | | | | |
| Development_Delta- and kappa-type opioid | no | 6.07E−03 | 6/23 | tcc | 2 |
| receptors signaling via beta-arrestin | | | | | |
| Development_Delta- and kappa-type opioid | no | 9.44E−03 | 4/23 | mda | 2 |
| receptors signaling via beta-arrestin | | | | | |
| Development_Hedgehog signaling | yes | 1.93E−03 | 10/46 | tcc | 2 |
| Development_Hedgehog signaling | yes | 2.51E−04 | 8/46 | mda | 2 |
| Development_Leptin signaling via | no | 3.66E−02 | 5/25 | tcc | 2 |
| JAK/STAT and MAPK cascades | | | | | |
| Development_Leptin signaling via | no | 3.04E−02 | 3/25 | mcc | 2 |
| JAK/STAT and MAPK cascades | | | | | |
| Development_MicroRNA-dependent | no | 5.01E−03 | 3/10 | mda | 2 |
| inhibition of EMT | | | | | |
| Development_MicroRNA-dependent | no | 2.94E−02 | 2/10 | mcc | 2 |
| inhibition of EMT | | | | | |
| Development_PEDF signaling | no | 4.46E−02 | 3/49 | tcga | 2 |
| Development_PEDF signaling | no | 3.43E−02 | 5/49 | mda | 2 |
| Development_PIP3 signaling in cardiac | no | 4.02E−02 | 3/47 | tcga | 2 |
| myocytes | | | | | |
| Development_PIP3 signaling in cardiac | no | 3.98E−02 | 4/47 | mcc | 2 |
| myocytes | | | | | |
| Development_Role of CDK5 in neuronal | no | 1.73E−02 | 3/34 | tcga | 2 |
| development | | | | | |
| Development_Role of CDK5 in neuronal | no | 3.60E−02 | 4/34 | mda | 2 |
| development | | | | | |
| Development_SSTR1 in regulation of cell | no | 1.94E−02 | 6/29 | tcc | 2 |
| proliferation and migration | | | | | |
| Development_SSTR1 in regulation of cell | no | 4.45E−02 | 3/29 | mcc | 2 |
| proliferation and migration | | | | | |
| Development_TGF-beta-dependent | no | 3.81E−02 | 3/46 | tcga | 2 |
| induction of EMT via RhoA, PI3K and ILK. | | | | | |
| Development_TGF-beta-dependent | yes | 3.91E−05 | 9/46 | mda | 2 |
| induction of EMT via RhoA, PI3K and ILK. | | | | | |
| Development_Thrombospondin-1 signaling | no | 1.89E−02 | 4/28 | mda | 2 |
| Development_Thrombospondin-1 signaling | no | 4.07E−02 | 3/28 | mcc | 2 |
| Development_VEGF signaling and | no | 3.20E−02 | 3/43 | tcga | 2 |
| activation | | | | | |
| Development_VEGF signaling and | no | 4.77E−03 | 6/43 | mda | 2 |
| activation | | | | | |
| Development_VEGF signaling via VEGFR2 - | no | 2.35E−02 | 12/84 | tcc | 2 |
| generic cascades | | | | | |
| Development_VEGF signaling via VEGFR2 - | no | 4.71E−02 | 4/84 | tcga | 2 |
| generic cascades | | | | | |
| DNA damage_ATM/ATR regulation of G2/ | yes | 7.47E−04 | 4/26 | tcga | 2 |
| M checkpoint | | | | | |
| DNA damage_ATM/ATR regulation of G2/ | no | 5.21E−03 | 4/26 | mcc | 2 |
| M checkpoint | | | | | |
| DNA damage_ATM/ATR regulation of | yes | 1.67E−03 | 4/32 | tcga | 2 |
| G1/S checkpoint | | | | | |
| DNA damage_ATM/ATR regulation of | no | 1.10E−02 | 4/32 | mcc | 2 |
| G1/S checkpoint | | | | | |
| DNA damage_Brca1 as a transcription | no | 1.23E−02 | 3/30 | tcga | 2 |
| regulator | | | | | |
| DNA damage_Brca1 as a transcription | yes | 1.40E−04 | 6/30 | mcc | 2 |
| regulator | | | | | |
| ENaC regulation in airways (normal and | no | 4.01E−02 | 8/52 | tcc | 2 |
| CF) | | | | | |
| ENaC regulation in airways (normal and | no | 4.28E−02 | 5/52 | mda | 2 |
| CF) | | | | | |
| G-protein signaling_G-Protein alpha-i | yes | 2.81E−03 | 5/27 | mda | 2 |
| signaling cascades | | | | | |
| G-protein signaling_G-Protein alpha-s | no | 4.32E−02 | 4/36 | mda | 2 |
| signaling cascades | | | | | |
| G-protein signaling_Proinsulin C-peptide | no | 9.78E−03 | 4/52 | tcga | 2 |
| signaling | | | | | |
| G-protein signaling_Proinsulin C-peptide | no | 4.28E−02 | 5/52 | mda | 2 |
| signaling | | | | | |
| G-protein signaling_Regulation of RAC1 | no | 2.01E−02 | 3/36 | tcga | 2 |
| activity | | | | | |
| G-protein signaling_Regulation of RAC1 | no | 1.00E−02 | 5/36 | mda | 2 |
| activity | | | | | |
| G-protein signaling_RhoA regulation | yes | 7.22E−04 | 9/34 | tcc | 2 |
| pathway | | | | | |
| G-protein signaling_RhoA regulation | no | 3.60E−02 | 4/34 | mda | 2 |
| pathway | | | | | |
| Immune response_CD28 signaling | no | 4.87E−02 | 8/54 | tcc | 2 |
| Immune response_CD40 signaling | no | 8.92E−03 | 11/65 | tcc | 2 |
| Immune response_Classical complement | yes | 4.74E−12 | 22/52 | tcc | 2 |
| pathway | | | | | |
| Immune response_Classical complement | yes | 3.50E−09 | 14/52 | mda | 2 |
| pathway | | | | | |
| Immune response_CXCR4 signaling via | no | 4.00E−02 | 6/34 | tcc | 2 |
| second messenger | | | | | |
| Immune response_CXCR4 signaling via | no | 3.60E−02 | 4/34 | mda | 2 |
| second messenger | | | | | |
| Immune response_IL-5 signalling | no | 4.54E−02 | 7/44 | tcc | 2 |
| Immune response_IL-5 signalling | no | 3.40E−02 | 3/44 | tcga | 2 |
| Immune response_Inflammasome in | no | 1.43E−02 | 7/35 | tcc | 2 |
| inflammatory response | | | | | |
| Immune response_Inflammasome in | no | 3.95E−02 | 4/35 | mda | 2 |
| inflammatory response | | | | | |
| Immune response_Lectin induced | yes | 1.00E−13 | 23/49 | tcc | 2 |
| complement pathway | | | | | |
| Immune response_Lectin induced | yes | 1.49E−07 | 12/49 | mda | 2 |
| complement pathway | | | | | |
| Immune response_MIF-JAB1 signaling | no | 6.56E−03 | 3/24 | tcga | 2 |
| Immune response_MIF-JAB1 signaling | no | 2.73E−02 | 3/24 | mcc | 2 |
| Immune response_Oncostatin M signaling | no | 1.66E−02 | 3/20 | mcc | 2 |
| via JAK-Stat in human cells | | | | | |
| Immune response_Oncostatin M signaling | no | 1.24E−02 | 3/18 | mcc | 2 |
| via JAK-Stat in mouse cells | | | | | |
| Immune response_PGE2 common pathways | no | 4.96E−03 | 10/52 | tcc | 2 |
| Immune response_PGE2 common pathways | yes | 2.89E−03 | 7/52 | mda | 2 |
| Immune response_PGE2 in immune and | no | 1.60E−02 | 8/44 | tcc | 2 |
| neuroendocrine system interactions | | | | | |
| Immune response_PGE2 in immune and | no | 5.36E−03 | 6/44 | mda | 2 |
| neuroendocrine system interactions | | | | | |
| Neurophysiological process_Corticoliberin | no | 3.70E−02 | 5/50 | mda | 2 |
| signaling via CRHR1 | | | | | |
| Neurophysiological process_Corticoliberin | no | 4.82E−02 | 4/50 | mcc | 2 |
| signaling via CRHR1 | | | | | |
| Neurophysiological process_Dopamine D2 | no | 4.25E−02 | 5/26 | tcc | 2 |
| receptor transactivation of PDGFR in CNS | | | | | |
| Neurophysiological process_Dopamine D2 | no | 1.46E−02 | 4/26 | mda | 2 |
| receptor transactivation of PDGFR in CNS | | | | | |
| Neurophysiological process_Netrin-1 in | no | 2.99E−03 | 9/41 | tcc | 2 |
| regulation of axon guidance | | | | | |
| Neurophysiological process_Netrin-1 in | no | 3.75E−03 | 6/41 | mda | 2 |
| regulation of axon guidance | | | | | |
| Neurophysiological process_PGE2-induced | no | 4.08E−02 | 7/43 | tcc | 2 |
| pain processing | | | | | |
| Neurophysiological process_PGE2-induced | no | 2.07E−02 | 5/43 | mda | 2 |
| pain processing | | | | | |
| Neurophysiological process_Receptor- | no | 5.77E−03 | 9/45 | tcc | 2 |
| mediated axon growth repulsion | | | | | |
| Neurophysiological process_Receptor- | no | 2.48E−02 | 5/45 | mda | 2 |
| mediated axon growth repulsion | | | | | |
| Proteolysis_Role of Parkin in the Ubiquitin- | yes | 1.62E−03 | 5/24 | mda | 2 |
| Proteasomal Pathway | | | | | |
| Proteolysis_Role of Parkin in the Ubiquitin- | no | 2.73E−02 | 3/24 | mcc | 2 |
| Proteasomal Pathway | | | | | |
| Pyruvate metabolism | no | 4.46E−02 | 3/49 | tcga | 2 |
| Pyruvate metabolism | no | 4.53E−02 | 4/49 | mcc | 2 |
| Retinol metabolism | yes | 3.54E−04 | 15/74 | tcc | 2 |
| Retinol metabolism | no | 3.17E−02 | 4/74 | tcga | 2 |
| Role of alpha-6/beta-4 integrins in | yes | 1.62E−03 | 10/45 | tcc | 2 |
| carcinoma progression | | | | | |
| Role of alpha-6/beta-4 integrins in | no | 2.48E−02 | 5/45 | mda | 2 |
| carcinoma progression | | | | | |
| Signal transduction_Activation of PKC via | yes | 1.47E−03 | 11/52 | tcc | 2 |
| G-Protein coupled receptor | | | | | |
| Signal transduction_Activation of PKC via | no | 4.28E−02 | 5/52 | mda | 2 |
| G-Protein coupled receptor | | | | | |
| Signal transduction_cAMP signaling | no | 2.21E−02 | 7/38 | tcc | 2 |
| Signal transduction_cAMP signaling | yes | 4.25E−04 | 7/38 | mda | 2 |
| Some pathways of EMT in cancer cells | no | 3.63E−02 | 8/51 | tcc | 2 |
| Some pathways of EMT in cancer cells | no | 1.10E−02 | 6/51 | mda | 2 |
| Transcription_Androgen Receptor nuclear | no | 1.82E−02 | 8/45 | tcc | 2 |
| signaling | | | | | |
| Transcription_Androgen Receptor nuclear | no | 2.48E−02 | 5/45 | mda | 2 |
| signaling | | | | | |
| Transcription_Ligand-dependent activation | no | 1.23E−02 | 3/30 | tcga | 2 |
| of the ESR1/SP pathway | | | | | |
| Transcription_Ligand-dependent activation | yes | 1.23E−03 | 5/30 | mcc | 2 |
| of the ESR1/SP pathway | | | | | |
| Transcription_P53 signaling pathway | yes | 2.07E−03 | 9/39 | tcc | 2 |
| Transcription_P53 signaling pathway | no | 2.49E−02 | 3/39 | tcga | 2 |
| Transcription_Role of heterochromatin | no | 4.87E−02 | 2/22 | tcga | 2 |
| protein 1 (HP1) family in transcriptional | | | | | |
| silencing | | | | | |
| Transcription_Role of heterochromatin | no | 4.63E−02 | 3/22 | mda | 2 |
| protein 1 (HP1) family in transcriptional | | | | | |
| silencing | | | | | |
| Translation_Non-genomic (rapid) action of | yes | 2.50E−03 | 9/40 | tcc | 2 |
| Androgen Receptor | | | | | |
| Translation_Non-genomic (rapid) action of | no | 2.66E−02 | 3/40 | tcga | 2 |
| Androgen Receptor | | | | | |
| wtCFTR and delta508-CFTR traffic/ | no | 3.26E−02 | 8/50 | tcc | 2 |
| Generic schema (norm and CF) | | | | | |
| wtCFTR and delta508-CFTR traffic/ | no | 3.70E−02 | 5/50 | mda | 2 |
| Generic schema (norm and CF) | | | | | |
| Apoptosis and survival_Anti-apoptotic | no | 3.24E−02 | 7/41 | tcc | 1 |
| TNFs/NF-kB/Bcl-2 pathway | | | | | |
| Apoptosis and survival_Beta-2 adrenergic | yes | 1.32E−03 | 5/23 | mda | 1 |
| receptor anti-apoptotic action | | | | | |
| Apoptosis and survival_Ceramides signaling | no | 2.66E−02 | 3/40 | tcga | 1 |
| pathway | | | | | |
| Apoptosis and survival_Regulation of | no | 1.23E−02 | 4/33 | mcc | 1 |
| Apoptosis by Mitochondrial Proteins | | | | | |
| Arachidonic acid production | no | 4.69E−02 | 3/50 | tcga | 1 |
| Atherosclerosis_Role of ZNF202 in | no | 1.80E−02 | 5/21 | tcc | 1 |
| regulation of expression of genes involved | | | | | |
| in Atherosclerosis | | | | | |
| Autophagy_Autophagy | no | 2.96E−02 | 4/32 | mda | 1 |
| Bacterial infections in CF airways | yes | 7.79E−05 | 14/58 | tcc | 1 |
| Blood coagulation_GPCRs in platelet | no | 4.76E−02 | 6/71 | mda | 1 |
| aggregation | | | | | |
| Blood coagulation_GPIb-IX-V-dependent | no | 3.31E−02 | 4/75 | tcga | 1 |
| platelet activation | | | | | |
| Blood coagulation_GPVI-dependent platelet | yes | 2.37E−03 | 11/55 | tcc | 1 |
| activation | | | | | |
| C and CxC3 Chemokines | no | 4.90E−02 | 2/5 | tcc | 1 |
| cAMP/Ca(2+)-dependent Insulin secretion | no | 2.07E−02 | 5/43 | mda | 1 |
| Cannabinoid receptor signaling in nicotine | no | 3.60E−02 | 4/34 | mda | 1 |
| addiction | | | | | |
| Cardiac Hypertrophy_Ca(2+)-dependent | yes | 3.94E−05 | 10/57 | mda | 1 |
| NF-AT signaling in Cardiac Hypertrophy | | | | | |
| Cardiac Hypertrophy_NF-AT signaling in | yes | 1.26E−04 | 10/65 | mda | 1 |
| Cardiac Hypertrophy | | | | | |
| Catecholamine metabolism | no | 2.91E−02 | 4/72 | tcga | 1 |
| Catecholamine metabolism/Human version | no | 3.04E−02 | 4/73 | tcga | 1 |
| CC chemokines/receptor faimly CC15- | no | 4.87E−02 | 2/22 | tcga | 1 |
| CCL28 | | | | | |
| Cell adhesion_Alpha-4 integrins in cell | no | 4.00E−02 | 6/34 | tcc | 1 |
| migration and adhesion | | | | | |
| Cell adhesion_Endothelial cell contacts by | no | 3.11E−02 | 5/24 | tcc | 1 |
| non-junctional mechanisms | | | | | |
| Cell adhesion_Gap junctions | no | 1.23E−02 | 3/30 | tcga | 1 |
| Cell adhesion_Integrin-mediated cell | no | 4.24E−02 | 3/48 | tcga | 1 |
| adhesion and migration | | | | | |
| Cell cycle_Influence of Ras and Rho | no | 1.05E−02 | 4/53 | tcga | 1 |
| proteins on G1/S Transition | | | | | |
| CFTR folding and maturation (norm and | no | 1.36E−02 | 3/14 | mda | 1 |
| CF) | | | | | |
| Chemotaxis_CCR4-induced chemotaxis of | no | 1.22E−02 | 7/34 | tcc | 1 |
| immune cells | | | | | |
| CXC Chemokine-receptor family | yes | 4.45E−04 | 7/20 | tcc | 1 |
| Cytokine production by Th17 cells in CF | no | 2.52E−02 | 7/39 | tcc | 1 |
| Cytokine production by Th17 cells in CF | no | 9.10E−03 | 6/49 | mda | 1 |
| (Mouse model) | | | | | |
| Cytoskeleton remodeling_Alpha-1A | no | 3.72E−02 | 2/19 | tcga | 1 |
| adrenergic receptor-dependent inhibition of | | | | | |
| PI3K | | | | | |
| Cytoskeleton remodeling_CDC42 in cellular | yes | 8.57E−04 | 7/22 | tcc | 1 |
| processes | | | | | |
| Cytoskeleton remodeling_Cytoskeleton | no | 2.47E−02 | 5/102 | tcga | 1 |
| remodeling | | | | | |
| Cytoskeleton remodeling_Neurofilaments | no | 7.37E−03 | 3/25 | tcga | 1 |
| Cytoskeleton remodeling_Regulation of | no | 5.81E−03 | 3/23 | tcga | 1 |
| actin cytoskeleton by Rho GTPases | | | | | |
| Cytoskeleton remodeling_Role of PDGFs in | no | 1.10E−02 | 4/24 | mda | 1 |
| cell migration | | | | | |
| Cytoskeleton remodeling_Role of PKA in | no | 2.86E−02 | 7/40 | tcc | 1 |
| cytoskeleton reorganisation | | | | | |
| Cytoskeleton remodeling_Thyroliberin in | no | 6.89E−03 | 5/33 | mda | 1 |
| cytoskeleton remodeling | | | | | |
| dCTP/dUTP metabolism | no | 3.31E−02 | 4/75 | tcga | 1 |
| Development_A2A receptor signaling | no | 4.08E−02 | 7/43 | tcc | 1 |
| Development_A3 receptor signaling | no | 3.43E−02 | 5/49 | mda | 1 |
| Development_ACM2 and ACM4 activation | no | 2.07E−02 | 5/43 | mda | 1 |
| of ERK | | | | | |
| Development_Activation of ERK by Kappa- | no | 4.32E−02 | 4/36 | mda | 1 |
| type opioid receptor | | | | | |
| Development_Alpha-2 adrenergic receptor | no | 1.78E−02 | 4/62 | tcga | 1 |
| activation of ERK | | | | | |
| Development_Angiotensin activation of Akt | no | 2.70E−02 | 5/46 | mda | 1 |
| Development_Angiotensin signaling via | no | 1.27E−02 | 4/25 | mda | 1 |
| beta-Arrestin | | | | | |
| Development_Beta-adrenergic receptors | no | 7.43E−03 | 6/47 | mda | 1 |
| regulation of ERK | | | | | |
| Development_Beta-adrenergic receptors | no | 4.28E−02 | 5/52 | mda | 1 |
| signaling via cAMP | | | | | |
| Development_Cross-talk between VEGF | no | 1.14E−02 | 6/26 | tcc | 1 |
| and Angiopoietin 1 signaling pathways | | | | | |
| Development_EDNRB signaling | no | 3.70E−02 | 5/50 | mda | 1 |
| Development_EGFR signaling pathway | no | 4.63E−02 | 9/63 | tcc | 1 |
| Development_EPO-induced Jak-STAT | no | 4.53E−02 | 6/35 | tcc | 1 |
| pathway | | | | | |
| Development_EPO-induced MAPK | no | 5.77E−03 | 9/45 | tcc | 1 |
| pathway | | | | | |
| Development_FGF-family signaling | no | 1.50E−02 | 9/52 | tcc | 1 |
| Development_FGFR signaling pathway | no | 4.87E−02 | 8/54 | tcc | 1 |
| Development_GDNF family signaling | no | 2.07E−02 | 8/46 | tcc | 1 |
| Development_Glucocorticoid receptor | no | 3.11E−02 | 5/24 | tcc | 1 |
| signaling | | | | | |
| Development_GM-CSF signaling | no | 4.69E−02 | 3/50 | tcga | 1 |
| Development_Growth hormone signaling | no | 1.43E−02 | 7/35 | tcc | 1 |
| via STATs and PLC/IP3 | | | | | |
| Development_Hedgehog and PTH signaling | no | 2.85E−03 | 5/36 | mcc | 1 |
| pathways in bone and cartilage development | | | | | |
| Development_HGF signaling pathway | no | 9.09E−03 | 5/47 | mcc | 1 |
| Development_Inhibition of angiogenesis by | no | 2.66E−02 | 4/31 | mda | 1 |
| PEDF | | | | | |
| Development_Melanocyte development and | no | 9.10E−03 | 6/49 | mda | 1 |
| pigmentation | | | | | |
| Development_Mu-type opioid receptor | no | 7.59E−03 | 6/24 | tcc | 1 |
| signaling via Beta-arrestin | | | | | |
| Development_Osteopontin signaling in | no | 6.02E−03 | 7/30 | tcc | 1 |
| osteoclasts | | | | | |
| Development_Oxytocin receptor signaling | yes | 3.30E−03 | 6/40 | mda | 1 |
| Development_PACAP signaling in neural | no | 1.40E−02 | 5/39 | mda | 1 |
| cells | | | | | |
| Development_PDGF signaling via MAPK | no | 2.93E−02 | 5/47 | mda | 1 |
| cascades | | | | | |
| Development_Prolactin receptor signaling | no | 2.13E−02 | 5/58 | mcc | 1 |
| Development_Regulation of CDK5 in CNS | no | 4.07E−02 | 3/28 | mcc | 1 |
| Development_Regulation of telomere length | no | 1.43E−02 | 7/35 | tcc | 1 |
| and cellular immortalization | | | | | |
| Development_Role of HDAC and | no | 4.91E−02 | 5/54 | mda | 1 |
| calcium/calmodulin-dependent kinase | | | | | |
| (CaMK) in control of skeletal myogenesis | | | | | |
| Development_S1P1 signaling pathway | no | 5.36E−03 | 6/44 | mda | 1 |
| Development_S1P2 and S1P3 receptors in | no | 8.23E−03 | 3/26 | tcga | 1 |
| cell proliferation and differentiation | | | | | |
| Development_S1P3 receptor signaling | no | 4.77E−03 | 6/43 | mda | 1 |
| pathway | | | | | |
| Development_Signaling of Beta-adrenergic | no | 4.25E−02 | 5/26 | tcc | 1 |
| receptors via Beta-arrestins | | | | | |
| Development_Slit-Robo signaling | no | 4.53E−03 | 5/30 | mda | 1 |
| Development_SSTR2 in regulation of cell | no | 1.00E−02 | 5/36 | mda | 1 |
| proliferation | | | | | |
| Development_TGF-beta-dependent | no | 7.43E−03 | 6/47 | mda | 1 |
| induction of EMT via MAPK | | | | | |
| Development_Thrombopoetin signaling via | no | 2.16E−02 | 3/22 | mcc | 1 |
| JAK-STAT pathway | | | | | |
| Development_Thrombopoietin-regulated | no | 5.87E−03 | 4/45 | tcga | 1 |
| cell processes | | | | | |
| Development_Thyroliberin signaling | no | 7.10E−03 | 7/61 | mda | 1 |
| Development_WNT signaling pathway. Part | no | 1.16E−02 | 5/19 | tcc | 1 |
| 1. Degradation of beta-catenin in the | | | | | |
| absence WNT signaling | | | | | |
| Development_WNT5A signaling | no | 2.70E−02 | 5/46 | mda | 1 |
| Glycolysis and gluconeogenesis p.3 | no | 2.73E−02 | 3/24 | mcc | 1 |
| Glycolysis and gluconeogenesis p.3/ | no | 2.73E−02 | 3/24 | mcc | 1 |
| Human version | | | | | |
| G-protein signaling_G-Protein beta/gamma | no | 7.84E−03 | 5/34 | mda | 1 |
| signaling cascades | | | | | |
| G-protein signaling_RAC1 in cellular | yes | 1.85E−04 | 10/35 | tcc | 1 |
| process | | | | | |
| G-protein signaling_Rap2A regulation | no | 2.34E−02 | 3/17 | mda | 1 |
| pathway | | | | | |
| G-protein signaling_Regulation of cAMP | no | 2.48E−02 | 5/45 | mda | 1 |
| levels by ACM | | | | | |
| G-protein signaling_RhoB regulation | yes | 7.60E−04 | 6/16 | tcc | 1 |
| pathway | | | | | |
| GTP metabolism | no | 1.44E−02 | 6/54 | mda | 1 |
| Immune response_CCR3 signaling in | yes | 1.69E−03 | 14/77 | tcc | 1 |
| eosinophils | | | | | |
| Immune response_IFN gamma signaling | no | 6.55E−03 | 10/54 | tcc | 1 |
| pathway | | | | | |
| Immune response_Sialic-acid receptors | yes | 7.78E−06 | 7/12 | tcc | 1 |
| (Siglecs) signaling | | | | | |
| Immune response_Antigen presentation by | no | 9.84E−03 | 4/12 | tcc | 1 |
| MHC class II | | | | | |
| Immune response_Antiviral actions of | yes | 3.93E−04 | 12/52 | tcc | 1 |
| Interferons | | | | | |
| Immune response_Bacterial infections in | no | 3.69E−03 | 10/50 | tcc | 1 |
| normal airways | | | | | |
| Immune response_BCR pathway | no | 1.89E−02 | 9/54 | tcc | 1 |
| Immune response_CCR5 signaling in | no | 2.00E−02 | 6/58 | mda | 1 |
| macrophages and T lymphocytes | | | | | |
| Immune response_CD137 signaling in | no | 1.12E−02 | 3/29 | tcga | 1 |
| immune cell | | | | | |
| Immune response_CD16 signaling in NK | no | 3.37E−02 | 10/69 | tcc | 1 |
| cells | | | | | |
| Immune response_Fc epsilon RI pathway | no | 7.48E−03 | 10/55 | tcc | 1 |
| Immune response_Fc gamma R-mediated | no | 7.76E−03 | 9/47 | tcc | 1 |
| phagocytosis in macrophages | | | | | |
| Immune response_Function of MEF2 in T | no | 1.00E−02 | 6/50 | mda | 1 |
| lymphocytes | | | | | |
| Immune response_Histamine H1 receptor | no | 3.17E−02 | 5/48 | mda | 1 |
| signaling in immune response | | | | | |
| Immune response_Histamine signaling in | no | 3.70E−02 | 5/50 | mda | 1 |
| dendritic cells | | | | | |
| Immune response_HMGB1/RAGE signaling | yes | 1.17E−04 | 13/53 | tcc | 1 |
| pathway | | | | | |
| Immune response_HMGB1/TLR signaling | yes | 1.13E−03 | 9/36 | tcc | 1 |
| pathway | | | | | |
| Immune response_ICOS pathway in T- | no | 6.71E−03 | 9/46 | tcc | 1 |
| helper cell | | | | | |
| Immune response_IFN alpha/beta signaling | yes | 4.25E−06 | 10/24 | tcc | 1 |
| pathway | | | | | |
| Immune response_IL-1 signaling pathway | no | 4.54E−02 | 7/44 | tcc | 1 |
| Immune response_IL-10 signaling pathway | no | 1.46E−02 | 4/26 | mda | 1 |
| Immune response_IL-7 signaling in B | no | 4.99E−03 | 4/43 | tcga | 1 |
| lymphocytes | | | | | |
| Immune response_IL-7 signaling in T | no | 3.17E−03 | 4/38 | tcga | 1 |
| lymphocytes | | | | | |
| Immune response_Immunological synapse | yes | 1.31E−03 | 12/59 | tcc | 1 |
| formation | | | | | |
| Immune response_Inhibitory action of | no | 4.02E−02 | 3/47 | tcga | 1 |
| Lipoxins on pro-inflammatory TNF-alpha | | | | | |
| signaling | | | | | |
| Immune response_Inhibitory action of | no | 4.29E−03 | 10/51 | tcc | 1 |
| lipoxins on superoxide production induced | | | | | |
| by IL-8 and Leukotriene B4 in neutrophils | | | | | |
| Immune response_Innate immune response | no | 1.64E−02 | 6/28 | tcc | 1 |
| to RNA viral infection | | | | | |
| Immune response_NFAT in immune | yes | 3.24E−04 | 12/51 | tcc | 1 |
| response | | | | | |
| Immune response_PIP3 signaling in B | no | 3.56E−03 | 9/42 | tcc | 1 |
| lymphocytes | | | | | |
| Immune response_Role of DAP12 receptors | no | 4.87E−02 | 8/54 | tcc | 1 |
| in NK cells | | | | | |
| Immune response_Role of HMGB1 in | no | 3.20E−03 | 7/27 | tcc | 1 |
| dendritic cell maturation and migration | | | | | |
| Immune response_Role of integrins in NK | no | 2.21E−02 | 7/38 | tcc | 1 |
| cells cytotoxicity | | | | | |
| Immune response_Role of the Membrane | no | 3.60E−02 | 4/34 | mda | 1 |
| attack complex in cell survival | | | | | |
| Immune response_T cell receptor signaling | no | 1.50E−02 | 9/52 | tcc | 1 |
| pathway | | | | | |
| Immune response_TCR and CD28 co- | no | 9.06E−03 | 8/40 | tcc | 1 |
| stimulation in activation of NF-kB | | | | | |
| Immune response_Th17 cell differentiation | no | 3.88E−03 | 8/35 | tcc | 1 |
| Immune response_TLR signaling pathways | no | 8.50E−03 | 10/56 | tcc | 1 |
| Inhibitory action of Lipoxins on Superoxide | no | 3.16E−03 | 10/49 | tcc | 1 |
| production in neutrophils | | | | | |
| Mechanism of action of CCR4 antagonists | no | 1.22E−02 | 7/34 | tcc | 1 |
| in asthma and atopic dermatitis (Variant 1) | | | | | |
| Membrane-bound ESR1: interaction with G- | no | 3.59E−03 | 7/54 | mda | 1 |
| proteins signaling | | | | | |
| Mucin expression in CF via IL-6, IL-17 | no | 4.00E−02 | 6/34 | tcc | 1 |
| signaling pathways | | | | | |
| Muscle contraction_ACM regulation of | no | 2.36E−02 | 9/56 | tcc | 1 |
| smooth muscle contraction | | | | | |
| Muscle contraction_GPCRs in the regulation | no | 1.16E−02 | 8/83 | mda | 1 |
| of smooth muscle tone | | | | | |
| Muscle contraction_Oxytocin signaling in | no | 6.49E−03 | 7/60 | mda | 1 |
| uterus and mammary gland | | | | | |
| Muscle contraction_Regulation of eNOS | no | 4.42E−03 | 7/56 | mda | 1 |
| activity in cardiomyocytes | | | | | |
| Muscle contraction_Regulation of eNOS | no | 9.20E−03 | 7/64 | mda | 1 |
| activity in endothelial cells | | | | | |
| Muscle contraction_Relaxin signaling | no | 8.23E−03 | 6/48 | mda | 1 |
| pathway | | | | | |
| Neurophysiological process_ACM | yes | 1.40E−03 | 7/46 | mda | 1 |
| regulation of nerve impulse | | | | | |
| Neurophysiological process_Dopamine D2 | no | 2.93E−02 | 5/47 | mda | 1 |
| receptor signaling in CNS | | | | | |
| Neurophysiological process_EphB receptors | no | 1.43E−02 | 7/35 | tcc | 1 |
| in dendritic spine morphogenesis and | | | | | |
| synaptogenesis | | | | | |
| Neurophysiological process_GABA-A | no | 1.38E−02 | 6/27 | tcc | 1 |
| receptor life cycle | | | | | |
| Neurophysiological process_Glutamate | no | 1.82E−02 | 8/45 | tcc | 1 |
| regulation of Dopamine D1A receptor | | | | | |
| signaling | | | | | |
| Neurophysiological process_Long-term | no | 9.10E−03 | 6/49 | mda | 1 |
| depression in cerebellum | | | | | |
| Neurophysiological process_Melatonin | no | 2.07E−02 | 5/43 | mda | 1 |
| signaling | | | | | |
| Neurophysiological process_Mu-type opioid | no | 2.39E−02 | 4/30 | mda | 1 |
| receptor-mediated analgesia | | | | | |
| Neurophysiological process_NMDA- | no | 9.39E−03 | 8/80 | mda | 1 |
| dependent postsynaptic long-term | | | | | |
| potentiation in CA1 hippocampal neurons | | | | | |
| NGF activation of NF-kB | no | 1.12E−02 | 3/29 | tcga | 1 |
| Nicotine signaling in glutamatergic neurons | yes | 1.18E−03 | 6/33 | mda | 1 |
| Normal and pathological TGF-beta- | no | 1.23E−02 | 4/33 | mcc | 1 |
| mediated regulation of cell proliferation | | | | | |
| O-glycan biosynthesis | no | 7.04E−03 | 11/63 | tcc | 1 |
| O-glycan biosynthesis/Human version | no | 7.04E−03 | 11/63 | tcc | 1 |
| Oxidative stress_Angiotensin II-induced | no | 1.43E−02 | 7/35 | tcc | 1 |
| production of ROS | | | | | |
| Polyamine metabolism | no | 2.42E−02 | 4/68 | tcga | 1 |
| Possible influence of low doses of Arsenite | no | 1.01E−02 | 3/28 | tcga | 1 |
| on glucose uptake in muscle | | | | | |
| Protein folding_Membrane trafficking and | yes | 5.17E−04 | 5/19 | mda | 1 |
| signal transduction of G-alpha (i) | | | | | |
| heterotrimeric G-protein | | | | | |
| Proteolysis_Putative SUMO-1 pathway | no | 2.13E−02 | 4/29 | mda | 1 |
| Putative pathways for stimulation of fat cell | no | 3.06E−02 | 6/32 | tcc | 1 |
| differentiation by Bisphenol A | | | | | |
| Regulation of CFTR activity (norm and CF) | yes | 1.25E−03 | 8/58 | mda | 1 |
| Regulation of lipid metabolism_Alpha-1 | no | 2.65E−02 | 4/70 | tcga | 1 |
| adrenergic receptors signaling via | | | | | |
| arachidonic acid | | | | | |
| Regulation of lipid metabolism_G-alpha(q) | no | 3.20E−02 | 9/59 | tcc | 1 |
| regulation of lipid metabolism | | | | | |
| Regulation of lipid metabolism_Regulation | no | 6.00E−03 | 6/45 | mda | 1 |
| of lipid metabolism by niacin and | | | | | |
| isoprenaline | | | | | |
| Regulation of lipid metabolism_Stimulation | no | 2.91E−02 | 4/72 | tcga | 1 |
| of Arachidonic acid production by ACM | | | | | |
| receptors | | | | | |
| Reproduction_GnRH signaling | no | 3.54E−03 | 7/72 | mcc | 1 |
| Serotonin-melatonin biosynthesis and | no | 4.93E−02 | 3/51 | tcga | 1 |
| metabolism | | | | | |
| Signal transduction_Calcium signaling | yes | 1.22E−03 | 7/45 | mda | 1 |
| Signal transduction_Erk Interactions: | yes | 1.39E−03 | 6/34 | mda | 1 |
| Inhibition of Erk | | | | | |
| Signal transduction_IP3 signaling | no | 9.10E−03 | 6/49 | mda | 1 |
| Stem cell marker (Nanog, Sox2, Oct4, | no | 1.81E−02 | 3/8 | tcc | 1 |
| CD133, Nestin) | | | | | |
| Transcription_ChREBP regulation pathway | no | 6.76E−03 | 4/21 | mda | 1 |
| Transcription_CREB pathway | no | 2.93E−02 | 5/47 | mda | 1 |
| Transcription_NF-kB signaling pathway | yes | 2.07E−03 | 9/39 | tcc | 1 |
| Transcription_Role of Akt in hypoxia | no | 5.98E−03 | 4/27 | mcc | 1 |
| induced HIF1 activation | | | | | |
| Transcription_Transcription regulation of | no | 3.04E−02 | 3/25 | mcc | 1 |
| aminoacid metabolism | | | | | |
| Transport_ACM3 in salivary glands | no | 4.24E−03 | 6/42 | mda | 1 |
| Transport_Aldosterone-mediated regulation | no | 2.39E−02 | 4/30 | mda | 1 |
| of ENaC sodium transport | | | | | |
| Transport_Alpha-2 adrenergic receptor | yes | 1.59E−03 | 7/47 | mda | 1 |
| regulation of ion channels | | | | | |
| Transport_Macropinocytosis regulation by | no | 8.46E−03 | 7/63 | mda | 1 |
| growth factors | | | | | |
| Tyrosine metabolism p.1 (dopamine) | no | 1.98E−02 | 4/64 | tcga | 1 |
| Untitled | no | 2.76E−02 | 1/1 | mcc | 1 |
| wtCFTR and deltaF508 traffic/Membrane | no | 3.60E−02 | 4/34 | mda | 1 |
| expression (norm and CF) | | | | | |

TABLE 7
Pearson's correlation for Integrin Drugs

| | | | | Bonferroni |
|---|---|---|---|---|
| NSC | | | | Adjusted p- |
| No. | Compound Name | Pearson Score | p-value | value |
| 676497 | TP4EK | 0.766727885 | 2.28E−12 | 5.24E−08 |
| 676495 | NA | 0.751476854 | 1.07E−11 | 2.46E−07 |
| 671526 | TOXIN .DELTA.53L | 0.736035292 | 4.61E−11 | 1.06E−06 |
| 688718 | NA | −0.700760613 | 6.44E−10 | 1.48E−05 |
| 723742 | Diethyl N[4-[(3-phenyl-5,7- | −0.706925314 | 1.14E−09 | 2.62E−05 |
| | diaminoquinoxalin-2-yl)amino]benzoyl]-L-glutamate | | | |
| 723740 | Diethyl N-[-[(3-phenyl-5,7- | −0.690810438 | 1.40E−09 | 3.22E−05 |
| | diaminoquinoxalin-2- | | | |
| | yl)aminomethyl]benzoyl]-L-gluatamate | | | |
| 645157 | 4,7-[Bis-N,N′-(3-amino-9-thioacetamido)- | −0.682148303 | 2.70E−09 | 6.21E−05 |
| | acridine]-biphenyl | | | |
| 716261 | NA | 0.698290184 | 3.09E−09 | 7.11E−05 |
| 680073 | NA | −0.674463414 | 4.72E−09 | 0.000108569 |
| 699428 | NA | −0.673855388 | 6.73E−09 | 0.000154803 |
| 35049 | NA | −0.667543843 | 7.72E−09 | 0.000177575 |
| 687978 | NA | −0.693298313 | 8.72E−09 | 0.000200577 |
| 712623 | NA | −0.687454524 | 9.37E−09 | 0.000215529 |
| 623436 | TGF.alpha.-PE40 | 0.721444283 | 1.06E−08 | 0.000243821 |
| 369318 | NA | −0.661991143 | 1.13E−08 | 0.000259923 |
| 704609 | NA | −0.67995242 | 1.14E−08 | 0.000262223 |
| 635157 | Dichlorobisoxinatotitanium(IV) | −0.722426059 | 1.45E−08 | 0.000333529 |
| 703315 | NA | −0.670789286 | 1.54E−08 | 0.000354231 |
| 633207 | NA | −0.709546693 | 1.64E−08 | 0.000377233 |
| 616511 | NA | 0.662658493 | 1.96E−08 | 0.000450839 |
| 625495 | 1-Piperidinecarbodithioic acid, antimony | −0.650579578 | 2.44E−08 | 0.000561249 |
| | complex | | | |
| 723001 | Diethyl-N[4-(3-thienylquinoxalyn-2- | 0.659986786 | 3.15E−08 | 0.000724563 |
| | yl)oxiphenylacetyl]-L-glutamate | | | |
| 677960 | 16.beta.-N-methylpiperazino-5-androstene- | −0.645051147 | 3.50E−08 | 0.00080507 |
| | 3.beta.,17.beta.-diol-diacetate | | | |
| 716729 | NA | −0.655806396 | 4.11E−08 | 0.000945382 |
| 677395 | 2-Azido-10-[(4- | −0.641851353 | 4.29E−08 | 0.000986786 |
| | dimethylamino)butyl]phenothiazine, oxalate | | | |
| | salt | | | |
| 625502 | 4-Morpholinecarbodithioic acid, antimony | −0.641295412 | 4.45E−08 | 0.001023589 |
| | complex | | | |
| 2186 | Thymophthalein, 1(3H)-Isobenzofuranone, | −0.639442901 | 5.00E−08 | 0.0011501 |
| | 3,3-bis[4-hydroxy-2-methyl-5-(1- | | | |
| | methylethyl)phenyl]- | | | |
| 351075 | 1H-Azepine-1-carbothioic acid, hexahydro-, | −0.648145415 | 5.02E−08 | 0.0011547 |
| | [1-(2-pyridinyl)ethylidene]hydrazide, N- | | | |
| | oxide | | | |
| 17474 | SKF 5019, Eskazine, Calmazine | −0.639354768 | 5.03E−08 | 0.001157001 |
| 13984 | NA | −0.639206645 | 5.07E−08 | 0.001166201 |
| 627050 | Dispiro[cyclopropane-1,2′(3′H)-naphthalene- | −0.639055416 | 5.12E−08 | 0.001177702 |
| | 3′,2″-imidazolidine], 1″,3″-dimethyl- | | | |
| 686324 | Indolizine, 1-methyl-3-[4-[2- | −0.636942362 | 5.85E−08 | 0.001345617 |
| | (dimethylamino)ethoxy]phenyl]-2-phenyl- | | | |
| 700422 | NA | −0.640908346 | 5.98E−08 | 0.00137552 |
| 11225 | Klot, Blutene, Toluidine Blue O | −0.636039696 | 6.19E−08 | 0.001423824 |
| 676879 | Phenothiazine, 2-azido-10-[4-(4-methyl-1- | −0.639940972 | 6.36E−08 | 0.001462927 |
| | piperazinyl)butyl]-, difumarate | | | |
| 701666 | Benzenamine, N-[4-(4-chlorophenyl)-3-(2- | −0.648677587 | 6.43E−08 | 0.001479029 |
| | propenyl)-2(3H)-thiazolylidene]-2-methoxy-, | | | |
| | hydrobromide, (2Z)- | | | |
| 657562 | 2-[(Z)-bromoiodomethylidene] | −0.634417368 | 6.84E−08 | 0.001573337 |
| | cyclohexanone | | | |
| 708089 | NA | −0.63408625 | 6.99E−08 | 0.00160784 |
| 34924 | NA | −0.631194088 | 8.35E−08 | 0.001920667 |
| 742850 | NA | −0.630058793 | 8.95E−08 | 0.002058679 |
| 715472 | NA | −0.633788471 | 9.28E−08 | 0.002134586 |
| 716535 | NA | −0.628790703 | 9.67E−08 | 0.002224293 |
| 641056 | NA | −0.675691328 | 1.00E−07 | 0.0023002 |
| 679749 | NA | −0.641398269 | 1.00E−07 | 0.0023002 |
| 676498 | TP4EK-K6 | 0.632034958 | 1.03E−07 | 0.002369206 |
| 682932 | NA | 0.640707558 | 1.05E−07 | 0.00241521 |
| 684411 | NA | −0.645241923 | 1.05E−07 | 0.00241521 |
| 685016 | NA | −0.635434747 | 1.10E−07 | 0.00253022 |
| 641220 | NA | −0.639578183 | 1.12E−07 | 0.002576224 |
| 687976 | NA | −0.648879965 | 1.12E−07 | 0.002576224 |
| 675006 | NA | −0.639227622 | 1.14E−07 | 0.002622228 |
| 631522 | NA | −0.634530774 | 1.16E−07 | 0.002668232 |
| 658215 | 1H,5H-Benzo[ij]quinolizine-5-one, 7-azido- | −0.629718727 | 1.19E−07 | 0.002737238 |
| | 2,3-dihydro-6-nitro- | | | |
| 660634 | 2-Chloro-3-(2-chloroethoxy)-naphthazarin | −0.643044568 | 1.20E−07 | 0.00276024 |
| 741338 | 12-Benzyl-5,12-dihydro- | 0.633441773 | 1.23E−07 | 0.002829246 |
| | indeno[2′,1′:4,5]pyrrolo[3,2-c]chinolin-6,7- | | | |
| | dione | | | |
| 692583 | NA | −0.641429714 | 1.32E−07 | 0.003036264 |
| 686368 | Quinazolin-4(3H)-one, 3-ethyl-2-[[[5- | 0.627785195 | 1.33E−07 | 0.003059266 |
| | (phenylamino)-1,3,4-thiadiazol-2- | | | |
| | yl]methyl]thio]- | | | |
| 715690 | NA | 0.630136941 | 1.50E−07 | 0.0034503 |
| 116532 | NA | −0.622772645 | 1.79E−07 | 0.004117358 |
| 691220 | NA | 0.630535419 | 1.91E−07 | 0.004393382 |
| 732517 | Dasatinib | 0.616761441 | 1.98E−07 | 0.004554396 |
| 711830 | NA | −0.639031012 | 1.99E−07 | 0.004577398 |
| 697882 | NA | −0.625076405 | 2.02E−07 | 0.004646404 |
| 665689 | NA | −0.61600903 | 2.07E−07 | 0.004761414 |
| 709922 | Landomycin E | −0.615886676 | 2.08E−07 | 0.004784416 |
| 695332 | NA | 0.657261403 | 2.16E−07 | 0.004968432 |
| 252188 | 2,5-Cyclohexadiene-1,4-dione, 2-chloro-5,6- | −0.619277844 | 2.19E−07 | 0.005037438 |
| | dimethoxy-3-(octylthio)- | | | |
| 716294 | NA | −0.636503239 | 2.30E−07 | 0.00529046 |
| 682300 | NA | −0.617465383 | 2.43E−07 | 0.005589486 |
| 635322 | NA | −0.664949195 | 2.54E−07 | 0.005842508 |
| 335791 | 3-Azabicyclo[3.2.2]nonane-3-carbothioic | −0.614728899 | 2.84E−07 | 0.006532568 |
| | acid, [1-(2-pyridinyl)butylidene]hydrazide | | | |
| 644583 | NA | −0.662436695 | 2.92E−07 | 0.006716584 |
| 688816 | NA | 0.613706891 | 3.01E−07 | 0.006923602 |
| 639386 | NA | −0.67850119 | 3.02E−07 | 0.006946604 |
| 715486 | NA | −0.61359876 | 3.03E−07 | 0.006969606 |
| 702397 | NA | 0.612845334 | 3.16E−07 | 0.007268632 |
| 635308 | NA | −0.671652795 | 3.22E−07 | 0.007406644 |
| 304379 | NA | −0.625773257 | 3.24E−07 | 0.007452648 |
| 644933 | NA | −0.650080298 | 3.24E−07 | 0.007452648 |
| 354671 | 1-Piperazinecarbothioic acid, 4-(2- | −0.606816872 | 3.49E−07 | 0.008027698 |
| | pyridinyl)-, [1-(2- | | | |
| | thiazolyl)ethylidene]hydrazide | | | |
| 710404 | NA | −0.606388072 | 3.58E−07 | 0.008234716 |
| 660632 | 2-Chloro-3-[2-(2-butoxyethoxy)ethoxy]- | −0.619351079 | 3.60E−07 | 0.00828072 |
| | naphthazarin | | | |
| 303612 | LM 209, Virginan, Mequitazine | −0.605774639 | 3.70E−07 | 0.00851074 |
| 246981 | NA | −0.608689581 | 3.99E−07 | 0.009177798 |
| 735179 | (1,1-dioxido-3-oxo-1,2-benzisothiazol- | −0.604344993 | 4.01E−07 | 0.009223802 |
| | 2(3H)-yl)methyl diethyldithiocarbamate | | | |
| 671409 | NA | 0.607992724 | 4.15E−07 | 0.00954583 |
| 666075 | 1,1-diiodo-2,2-dimethoxy-2-phenylethane | −0.607935343 | 4.16E−07 | 0.009568832 |
| 625501 | Antimony, chlorobis(1- | −0.603385633 | 4.23E−07 | 0.009729846 |
| | piperidinecarbodithioato-S,S′)- | | | |
| 684480 | 7H-Pyrido[3,2-d][1]benzazepin-6-one, 2-(3- | 0.603028503 | 4.32E−07 | 0.009936864 |
| | chlorophenyl)-5,6-dihydro-4-phenyl- | | | |

TABLE 8
Pearson's correlation for WNT2 drugs

| | | | | Bonferroni |
|---|---|---|---|---|
| NSC No. | Compound Name | Pearson Score | p-value | Adjusted p-value |
| 724325 | NA | −0.710613594 | 5.93E−10 | 1.36E−05 |
| 150412 | NA | 0.6828783 | 3.53E−09 | 8.12E−05 |
| 680313 | NA | −0.668529078 | 7.20E−09 | 0.000165614 |
| 711070 | NA | −0.67727365 | 7.24E−09 | 0.000166534 |
| 674493 | Hydrazinecarboxamide, N-(1-naphthyl)-2-[(4- | −0.661389005 | 1.18E−08 | 0.000271424 |
| | nitrophenyl)methylene]- | | | |
| 678057 | Pyridine-3-carbonitrile, 6-(4-chlorophenyl)-1- | −0.660202214 | 1.28E−08 | 0.000294426 |
| | (.beta.-D-glucopyranosyl)-1,2-dihydro-2- | | | |
| | thioxo-, 2′,3′,4′,6′-tetraacetate | | | |
| 630375 | 2H-1-Benzopyran-2-one, 4-(2-benzofuranyl)- | −0.658161133 | 2.64E−08 | 0.000607253 |
| | 7-methoxy- | | | |
| 702397 | NA | −0.651626077 | 3.03E−08 | 0.000696961 |
| 635157 | Dichlorobisoxinatotitanium(IV) | 0.709975874 | 3.29E−08 | 0.000756766 |
| 672768 | NA | −0.65232352 | 3.85E−08 | 0.000885577 |
| 135371 | NA | 0.647588118 | 3.93E−08 | 0.000903979 |
| 354670 | 3-Azabicyclo[3.2.2]nonane-3-carbothioic acid, | 0.642865361 | 4.02E−08 | 0.00092468 |
| | [1-(2-thiazolyl)ethylidene]hydrazide | | | |
| 682817 | 7,10:11,14-Dietheno-28H-23,27-nitrilo-22H- | −0.642149215 | 4.21E−08 | 0.000968384 |
| | dibenzo[b,p] | | | |
| | [1,18,5,14]dioxadiazacyclopentacosine | | | |
| 645392 | 2-Propen-1-one, 1-(4-chlorophenyl)-3-[4-[2- | −0.642046828 | 4.24E−08 | 0.000975285 |
| | oxo-2-(4-phenyl-1- | | | |
| | piperazinyl)ethoxy]phenyl]-, (E)- | | | |
| 670782 | NA | 0.640394693 | 4.71E−08 | 0.001083394 |
| 625542 | Methanone, phenyl-2-pyridyl-, 2- | 0.637130403 | 5.78E−08 | 0.001329516 |
| | pyridylhydrazone, nickel acetate complex | | | |
| 668836 | NA | −0.662104347 | 6.70E−08 | 0.001541134 |
| 650792 | 1,4,7,10-Tetrathia-13-azacyclopentadecane, | −0.632373275 | 7.77E−08 | 0.001787255 |
| | 13-[(4-methylphenyl)sulfonyl]- | | | |
| 351078 | Hydrazinecarbothioamide, N,N-dimethyl-2-[1- | 0.628686077 | 9.73E−08 | 0.002238095 |
| | (2-pyridinyl)-ethylidene]-, N-oxide | | | |
| 742036 | NA | −0.656281605 | 1.28E−07 | 0.002944256 |
| 657562 | 2-[(Z)-bromoiodomethylidene] cyclohexanone | 0.622000673 | 1.45E−07 | 0.00333529 |
| 647133 | NA | 0.66907426 | 1.48E−07 | 0.003404296 |
| 677640 | NA | −0.621411198 | 1.50E−07 | 0.0034503 |
| 682504 | NA | −0.620249301 | 1.61E−07 | 0.003703322 |
| 685848 | 4(3H)-Quinazolinone, 3-[[(2- | −0.623088892 | 1.76E−07 | 0.004048352 |
| | nitrophenyl)methylene]amino]-2-phenyl- | | | |
| 716535 | NA | 0.618478624 | 1.79E−07 | 0.004117358 |
| 745449 | NA | 0.617892232 | 1.85E−07 | 0.00425537 |
| 625543 | ANTINEOPLASTIC-625543 | 0.616754535 | 1.98E−07 | 0.004554396 |
| 682932 | NA | −0.629475374 | 2.03E−07 | 0.004669406 |
| 622613 | 3H-Naphtho[1,8-bc]furan-2-carboxylic acid, | −0.617922148 | 2.37E−07 | 0.005451474 |
| | 4,5-dihydro-6-nitro-, ethyl ester | | | |
| 166588 | METHYLUNDECYLPIPERIDINE, TRANS | 0.612415173 | 2.54E−07 | 0.005842508 |
| 321206 | NA | 0.609213968 | 3.05E−07 | 0.00701561 |
| 736442 | 7-fluoro-2-(thien-2-ilcarbonyl)-3- | 0.60831884 | 3.21E−07 | 0.007383642 |
| | trifluoromethylquioxaline 1,4-dioxide | | | |
| 715648 | NA | −0.607728018 | 3.32E−07 | 0.007636664 |
| 683922 | NA | 0.60713614 | 3.43E−07 | 0.007889686 |
| 637921 | 1H-Pyrazole-1-propanamide, 3,5-diphenyl-N- | −0.606346286 | 3.59E−07 | 0.008257718 |
| | (4-methoxyphenyl)-4-[(4-methylphenyl)azo]- | | | |
| | .beta.-oxo- | | | |
| 176632 | Stannane, trimethyl[(4- | 0.675314344 | 3.60E−07 | 0.00828072 |
| | morpholinylthioxomethyl)thio]- | | | |
| 691422 | acetonitrile, dimethoxyphenyl, pyrimidin | −0.609371891 | 3.84E−07 | 0.008832768 |
| 691415 | NA | −0.604707722 | 3.93E−07 | 0.009039786 |
| 711222 | NA | −0.604718705 | 3.93E−07 | 0.009039786 |
| 338304 | Iron, dichloro[hexahydro-1H-azepine-1- | 0.603615641 | 4.18E−07 | 0.009614836 |
| | carbothioic acid [1-(2- | | | |
| | pyridinyl)ethylidene]hydraziato] | | | |
| 667722 | NA | −0.634935881 | 4.29E−07 | 0.009867858 |

TABLE 9
Pearson's correlation for TGF-WNT drugs

| | | | | Bonferroni |
|---|---|---|---|---|
| NSC No. | Compound Name | Pearson Score | p-value | Adjusted p-value |
| 682932 | NA | 0.778356256 | 1.66E−12 | 3.82E−08 |
| 661232 | 2-(4-hydroxybenzylidene)-5-((phenyl- | −0.769299612 | 1.73E−12 | 3.98E−08 |
| | amino)methyl)cyclopentanone | | | |
| 635131 | NA | −0.806525613 | 4.54E−12 | 1.04E−07 |
| 645157 | 4,7-[Bis-N,N′-(3-amino-9-thioacetamido)-acridine]- | −0.753473538 | 5.74E−12 | 1.32E−07 |
| | biphenyl | | | |
| 354671 | 1-Piperazinecarbothioic acid, 4-(2-pyridinyl)-, [1-(2- | −0.752586626 | 6.27E−12 | 1.44E−07 |
| | thiazolyl)ethylidene]hydrazide | | | |
| 736442 | 7-fluoro-2-(thien-2-ilcarbonyl)-3- | −0.746277988 | 1.17E−11 | 2.69E−07 |
| | trifluoromethylquioxaline 1,4-dioxide | | | |
| 351075 | 1H-Azepine-1-carbothioic acid, hexahydro-, [1-(2- | −0.752883461 | 1.43E−11 | 3.29E−07 |
| | pyridinyl)ethylidene]hydrazide, N-oxide | | | |
| 670782 | NA | −0.741846529 | 1.79E−11 | 4.12E−07 |
| 351078 | Hydrazinecarbothioamide, N,N-dimethyl-2-[1-(2- | −0.740214447 | 2.09E−11 | 4.81E−07 |
| | pyridinyl)-ethylidene]-, N-oxide | | | |
| 717769 | NA | −0.737729565 | 2.64E−11 | 6.07E−07 |
| 354670 | 3-Azabicyclo[3.2.2]nonane-3-carbothioic acid, [1-(2- | −0.736446198 | 2.98E−11 | 6.85E−07 |
| | thiazolyl)ethylidene]hydrazide | | | |
| 735181 | (1,1-dioxido-3-oxo-1,2-benzisothiazol-2(3H)- | −0.739547945 | 3.34E−11 | 7.68E−07 |
| | yl)methyl 4-methylpiperazine-1-carbodithioate | | | |
| 680072 | Ochraceolide A | −0.733329843 | 3.97E−11 | 9.13E−07 |
| 635157 | Dichlorobisoxinatotitanium(IV) | −0.794330317 | 4.45E−11 | 1.02E−06 |
| 166588 | METHYLUNDECYLPIPERIDINE, TRANS | −0.729674697 | 5.54E−11 | 1.27E−06 |
| 689279 | NA | −0.74663529 | 5.97E−11 | 1.37E−06 |
| 618059 | 1-Penten-3-one, 5-(4-morpholinyl)-1-phenyl-, | −0.737077947 | 6.26E−11 | 1.44E−06 |
| | hydrochloride | | | |
| 135371 | NA | −0.732185189 | 6.53E−11 | 1.50E−06 |
| 691422 | acetonitrile, dimethoxyphenyl, pyrimidin | 0.730371627 | 7.68E−11 | 1.77E−06 |
| 639617 | NA | −0.722380828 | 1.06E−10 | 2.44E−06 |
| 625542 | Methanone, phenyl-2-pyridyl-, 2-pyridylhydrazone, | −0.722307568 | 1.07E−10 | 2.46E−06 |
| | nickel acetate complex | | | |
| 682866 | Ethanone, 1-[7-(4-chlorophenyl)-5,6-dihydro-9- | −0.724082351 | 1.33E−10 | 3.06E−06 |
| | methyl-7H-benzo[h]thiazolo[2,3-b]quinazolin-10-yl]- | | | |
| 716535 | NA | −0.719557758 | 1.35E−10 | 3.11E−06 |
| 630375 | 2H-1-Benzopyran-2-one, 4-(2-benzofuranyl)-7- | 0.725397007 | 1.74E−10 | 4.00E−06 |
| | methoxy- | | | |
| 745449 | NA | −0.716570478 | 1.75E−10 | 4.03E−06 |
| 35949 | NA | −0.716500964 | 1.76E−10 | 4.05E−06 |
| 657562 | 2-[(Z)-bromoiodomethylidene] cyclohexanone | −0.716273257 | 1.79E−10 | 4.12E−06 |
| 672768 | NA | 0.723956796 | 1.97E−10 | 4.53E−06 |
| 685485 | NA | −0.725536895 | 2.53E−10 | 5.82E−06 |
| 682990 | Withafastuosin D diacetate | −0.716487305 | 2.55E−10 | 5.87E−06 |
| 688718 | NA | −0.71101908 | 2.79E−10 | 6.42E−06 |
| 640927 | NA | −0.769114997 | 4.27E−10 | 9.82E−06 |
| 124784 | NA | −0.746146175 | 5.01E−10 | 1.15E−05 |
| 335791 | 3-Azabicyclo[3.2.2]nonane-3-carbothioic acid, [1-(2- | −0.706043967 | 5.99E−10 | 1.38E−05 |
| | pyridinyl)butylidene]hydrazide | | | |
| 620674 | NA | 0.764730078 | 6.15E−10 | 1.41E−05 |
| 319447 | NA | −0.705228379 | 6.39E−10 | 1.47E−05 |
| 646162 | NA | −0.742503567 | 6.73E−10 | 1.55E−05 |
| 711474 | NA | −0.726537639 | 7.36E−10 | 1.69E−05 |
| 622696 | Thioperoxydicarbonic diamide, tetramethyl- | −0.703386618 | 7.40E−10 | 1.70E−05 |
| 626881 | NA | −0.734501928 | 8.53E−10 | 1.96E−05 |
| 13984 | NA | −0.696932095 | 8.72E−10 | 2.01E−05 |
| 736443 | 7-fluoro-2-(2-furoyl)-3-trifluoromethylquioxaline 1,4- | −0.696803932 | 8.81E−10 | 2.03E−05 |
| | dioxide | | | |
| 645392 | 2-Propen-1-one, 1-(4-chlorophenyl)-3-[4-[2-oxo-2-(4- | 0.695091956 | 1.01E−09 | 2.32E−05 |
| | phenyl-1-piperazinyl)ethoxy]phenyl]-, (E)- | | | |
| 695320 | NA | 0.722078326 | 1.05E−09 | 2.42E−05 |
| 622579 | Carbamimidothioic acid, N,N-dimethyl-N′- | −0.693477682 | 1.14E−09 | 2.62E−05 |
| | [(phenylimino) (methylthio)methyl]-, phenylmethyl | | | |
| | ester, hydroiodide | | | |
| 672464 | NA | −0.692483163 | 1.23E−09 | 2.83E−05 |
| 630128 | Trichlorotris-3-(t-butyl)pyrazoleruthenium(III) | −0.699003864 | 1.47E−09 | 3.38E−05 |
| 716261 | NA | 0.708143378 | 1.48E−09 | 3.40E−05 |
| 639518 | Cyclopentanone, 2-[[4-(benzoyloxy)-3- | −0.689508702 | 1.55E−09 | 3.57E−05 |
| | methoxyphenyl] methylene]-5- | | | |
| | [(dimethylamino)methyl]-, hydrochloride | | | |
| 616362 | 2-Methoxycarbonyl-3,4-dichloro-5-nitrofuran | −0.689270154 | 1.58E−09 | 3.63E−05 |
| 707098 | NA | 0.711791456 | 1.60E−09 | 3.68E−05 |
| 73109 | NA | −0.693321966 | 1.62E−09 | 3.73E−05 |
| 724325 | NA | 0.697302962 | 1.68E−09 | 3.86E−05 |
| 656909 | NA | 0.710973829 | 1.70E−09 | 3.91E−05 |
| 637921 | 1H-Pyrazole-1-propanamide, 3,5-diphenyl-N-(4- | 0.686537316 | 1.94E−09 | 4.46E−05 |
| | methoxyphenyl)-4-[(4-methylphenyl)azo]-.beta.-oxo- | | | |
| 658873 | NA | −0.708992013 | 1.98E−09 | 4.55E−05 |
| 301457 | Cycloalkannin | −0.69032212 | 2.03E−09 | 4.67E−05 |
| 711070 | NA | 0.69448207 | 2.08E−09 | 4.78E−05 |
| 702397 | NA | 0.689732966 | 2.12E−09 | 4.88E−05 |
| 9291 | Naphthol blue, Benzo[a]phenoxazinium, 9- | −0.727580409 | 2.16E−09 | 4.97E−05 |
| | (dimethylamino)-, chloride | | | |
| 711222 | NA | 0.684305482 | 2.30E−09 | 5.29E−05 |
| 716431 | NA | −0.716425863 | 2.34E−09 | 5.38E−05 |
| 629738 | 1-Naphthalenecarboxamide,N,N′-1,8-(octanediyl)bis- | 0.697276026 | 2.37E−09 | 5.45E−05 |
| 645153 | 9(10H)-Acridinethione, bis[3-[1,1′-biphenyl-2,2′-diyl] | −0.683305498 | 2.47E−09 | 5.68E−05 |
| | (2-aminoacetyl)amino- | | | |
| 715335 | NA | −0.687461266 | 2.51E−09 | 5.77E−05 |
| 707828 | NA | −0.682752254 | 2.58E−09 | 5.93E−05 |
| 674493 | Hydrazinecarboxamide, N-(1-naphthyl)-2-[(4- | 0.682213563 | 2.68E−09 | 6.16E−05 |
| | nitrophenyl)methylene]- | | | |
| 645979 | NA | −0.690372774 | 2.82E−09 | 6.49E−05 |
| 88871 | NA | −0.679569766 | 3.26E−09 | 7.50E−05 |
| 641396 | 1H-Benzo[a]carbazole-1,4(11H)-dione, 8-methoxy-11- | −0.688269536 | 3.29E−09 | 7.57E−05 |
| | methyl- | | | |
| 635418 | NA | −0.721088004 | 3.50E−09 | 8.05E−05 |
| 316458 | Neplanocin A | −0.677770643 | 3.72E−09 | 8.56E−05 |
| 646161 | Propanethioamide, N-hydroxy-N-methyl- | −0.677446841 | 3.81E−09 | 8.76E−05 |
| 678057 | Pyridine-3-carbonitrile, 6-(4-chlorophenyl)-1-(.beta.- | 0.677218475 | 3.87E−09 | 8.90E−05 |
| | D-glucopyranosyl)-1,2-dihydro-2-thioxo-, 2′,3′,4′,6′- | | | |
| | tetraacetate | | | |
| 661442 | NA | −0.676640304 | 4.04E−09 | 9.29E−05 |
| 675208 | NA | −0.719082529 | 4.05E−09 | 9.32E−05 |
| 612955 | 1,5-Dihydroxy-1,5-di(pyridin-3-yl)pentan-3-one | −0.67650484 | 4.08E−09 | 9.38E−05 |
| 35446 | PROPIOPHENONE, 3-PHENYL-3-PIPERIDINO- | −0.676193635 | 4.17E−09 | 9.59E−05 |
| 668267 | 2H-1-Benzopyran-2-one, 3-chloro-7-[(tetrahydro-4- | −0.680572446 | 4.17E−09 | 9.59E−05 |
| | methylene-5-oxo-2-phenyl-2-furanyl)methoxy]-4- | | | |
| | methyl- | | | |
| 625543 | ANTINEOPLASTIC-625543 | −0.676095483 | 4.20E−09 | 9.66E−05 |
| 662383 | 2-Bromo-5,8-dihydroxy-3-methyl-1,4-naphthoquinone | −0.675908564 | 4.26E−09 | 9.80E−05 |
| 669598 | NA | −0.679808474 | 4.40E−09 | 0.000101209 |
| 671883 | NA | −0.675010335 | 4.54E−09 | 0.000104429 |
| 658366 | NA | −0.679140058 | 4.62E−09 | 0.000106269 |
| 668258 | NA | −0.678993295 | 4.67E−09 | 0.000107419 |
| 621888 | Cyclopentanone, 2-[(dimethylamino)methyl]-, | −0.678548761 | 4.82E−09 | 0.00011087 |
| | hydrochloride | | | |
| 657021 | NA | −0.711165794 | 4.97E−09 | 0.00011432 |
| 697862 | NA | −0.672735925 | 5.35E−09 | 0.000123061 |
| 600060 | Hydrazinecarbodithioic acid, [(6-methyl-2-pyridinyl) | −0.671941342 | 5.66E−09 | 0.000130191 |
| | ethylidene]-, methyl ester | | | |
| 695323 | NA | −0.704312399 | 5.67E−09 | 0.000130421 |
| 647133 | NA | −0.718634004 | 6.08E−09 | 0.000139852 |
| 645167 | NA | −0.713321612 | 6.13E−09 | 0.000141002 |
| 687976 | NA | −0.693252109 | 6.25E−09 | 0.000143763 |
| 670969 | NA | −0.674599101 | 6.39E−09 | 0.000146983 |
| 631888 | Chlorobisoximatobismuth(III)-dihydrochloride | −0.71218276 | 6.64E−09 | 0.000152733 |
| 658514 | GAB-GELDANAMYCIN | −0.669614632 | 6.67E−09 | 0.000153423 |
| 645151 | 3-Acridineamine, 9-[[(4-nitrophenyl)methyl]thio]- | −0.669574019 | 6.69E−09 | 0.000153883 |
| 717768 | NA | −0.669576976 | 6.69E−09 | 0.000153883 |
| 716522 | NA | −0.669562222 | 6.70E−09 | 0.000154113 |
| 630599 | NA | −0.717204481 | 6.73E−09 | 0.000154803 |
| 617145 | (2,2-Dimethyl)-1,3-propandiyl-bis(2,3- | −0.711673108 | 6.89E−09 | 0.000158484 |
| | dichloro)maleimide | | | |
| 639520 | Cyclohexanone, 2-[(2-methoxyphenyl)methylene]-5- | −0.668782424 | 7.08E−09 | 0.000162854 |
| | [(4-morpholinyl)methyl]-, hydrochloride | | | |
| 630684 | 8-Quinolinecarboxaldehyde, 2-(2,4-dinitrophenyl)-2- | 0.682078965 | 7.11E−09 | 0.000163544 |
| | methyl-hydrazone | | | |
| 34924 | NA | −0.668596594 | 7.17E−09 | 0.000164924 |
| 742857 | NA | −0.668150449 | 7.40E−09 | 0.000170215 |
| 690983 | NA | −0.685979248 | 7.48E−09 | 0.000172055 |
| 681105 | Acetic acid, [1,4,7,10-tetraazacyclododecane-1,7- | −0.671920346 | 7.72E−09 | 0.000177575 |
| | diyl]bis | | | |
| 680625 | NA | 0.704598201 | 7.91E−09 | 0.000181946 |
| 632899 | NA | 0.714240069 | 8.29E−09 | 0.000190687 |
| 660977 | 2-bromo-8-hydroxy-6-methyl-1,4-naphthoquinone | −0.670485996 | 8.53E−09 | 0.000196207 |
| 658886 | NA | −0.665742922 | 8.75E−09 | 0.000201268 |
| 338304 | Iron, dichloro[hexahydro-1H-azepine-1-carbothioic | −0.665206987 | 9.08E−09 | 0.000208858 |
| | acid [1-(2-pyridinyl)ethylidene]hydraziato] | | | |
| 675989 | 1,3-Dithiolo[3,4-d]pyrimidine-2-thione, 5,7-dichloro- | −0.664774761 | 9.36E−09 | 0.000215299 |
| 74663 | NA | −0.707096039 | 9.48E−09 | 0.000218059 |
| 625539 | Methanone, phenyl-2-pyridinyl-, 2- | −0.71226679 | 9.50E−09 | 0.000218519 |
| | pyridinylhydrazone,trichloroiron complex | | | |
| 661233 | NA | −0.668824679 | 9.57E−09 | 0.000220129 |
| 661238 | NA | −0.668798038 | 9.59E−09 | 0.000220589 |
| 639539 | NA | −0.717160971 | 9.78E−09 | 0.00022496 |
| 697663 | NA | 0.681115155 | 1.05E−08 | 0.000241521 |
| 680313 | NA | 0.663003348 | 1.06E−08 | 0.000243821 |
| 309883 | NA | −0.662152673 | 1.12E−08 | 0.000257622 |
| 658165 | NA | −0.694264745 | 1.14E−08 | 0.000262223 |
| 127763 | Propanamide, 2,3-dichloro-N-(9,10-dihydro-9,10- | −0.660875151 | 1.22E−08 | 0.000280624 |
| | dioxo-1-anthracenyl)- | | | |
| 636344 | NA | −0.708187447 | 1.26E−08 | 0.000289825 |
| 711611 | NA | −0.668749482 | 1.31E−08 | 0.000301326 |
| 68093 | NA | −0.701980767 | 1.35E−08 | 0.000310527 |
| 677938 | NA | −0.65936957 | 1.36E−08 | 0.000312827 |
| 670961 | NA | −0.663580425 | 1.37E−08 | 0.000315127 |
| 671888 | NA | −0.659264612 | 1.37E−08 | 0.000315127 |
| 632950 | NA | −0.70122392 | 1.42E−08 | 0.000326628 |
| 376266 | 1-Piperazinethiocarboxylic acid, 4-(2-propynyl)-2-[1- | −0.66296559 | 1.43E−08 | 0.000328929 |
| | (2-pyridinyl)ethylidene]hydrazide | | | |
| 722185 | 6-(2,4-Difluorophenylmethylideneamino)-3-(4- | 0.671604346 | 1.46E−08 | 0.000335829 |
| | fluorophenyl)thiazolo[4,5-d]pyrimidin-6(7H)-one- | | | |
| | 2(3H)-thione | | | |
| 641160 | NA | −0.711225345 | 1.47E−08 | 0.000338129 |
| 155595 | NA | −0.700586007 | 1.48E−08 | 0.00034043 |
| 305978 | Herbimycin Herbimycin A | −0.722078474 | 1.48E−08 | 0.00034043 |
| 716984 | NA | −0.657771963 | 1.51E−08 | 0.00034733 |
| 640391 | Cyclopentanone, 2,5-bis[(dimethylamino)methyl]-, cis-, | −0.661561238 | 1.57E−08 | 0.000361131 |
| | dihydrochloride | | | |
| 635448 | Copper, bromo[2-[1-(2-pyridinyl)ethylidene][N,N- | −0.66505518 | 1.67E−08 | 0.000384133 |
| | dimethyl-hydrazinecarbothioamidato-N,N,S]- | | | |
| 684411 | NA | −0.67402613 | 1.69E−08 | 0.000388734 |
| 695801 | 2,11-Diaza-5,8-dioxadodecane,1,12-bis(6-methoxy-2- | −0.655761764 | 1.73E−08 | 0.000397935 |
| | naphthalenyl)-, monohydrochloride | | | |
| 673611 | NA | −0.664518126 | 1.74E−08 | 0.000400235 |
| 182855 | Eriolangin | −0.655342699 | 1.78E−08 | 0.000409436 |
| 624508 | NA | −0.708143919 | 1.80E−08 | 0.000414036 |
| 650935 | 3,8-Dimethyl-1,2-naphthoquinone | −0.696949729 | 1.89E−08 | 0.000434738 |
| 645640 | NA | −0.702044157 | 1.90E−08 | 0.000437038 |
| 684985 | NA | 0.667370203 | 1.94E−08 | 0.000446239 |
| 715230 | NA | −0.658384108 | 1.94E−08 | 0.000446239 |
| 638287 | NA | −0.696132137 | 1.99E−08 | 0.00045774 |
| 658215 | 1H,5H-Benzo[ij]quinolizine-5-one, 7-azido-2,3- | −0.657957791 | 2.00E−08 | 0.00046004 |
| | dihydro-6-nitro- | | | |
| 658526 | NA | −0.657959487 | 2.00E−08 | 0.00046004 |
| 639519 | NA | −0.695800053 | 2.03E−08 | 0.000466941 |
| 711759 | NA | −0.666608765 | 2.04E−08 | 0.000469241 |
| 650748 | NA | −0.657335446 | 2.08E−08 | 0.000478442 |
| 369318 | NA | −0.652912664 | 2.09E−08 | 0.000480742 |
| 684983 | NA | 0.665871174 | 2.14E−08 | 0.000492243 |
| 668262 | NA | −0.660872508 | 2.21E−08 | 0.000508344 |
| 645145 | Benzeneamine, 4-[(9-acridinyl)thio]- | −0.651607005 | 2.28E−08 | 0.000524446 |
| 716172 | NA | −0.651477457 | 2.30E−08 | 0.000529046 |
| 641056 | NA | −0.698999248 | 2.32E−08 | 0.000533646 |
| 670328 | NA | −0.660012895 | 2.34E−08 | 0.000538247 |
| 234214 | 2,5-Cyclohexadiene-1,4-dione, 2,3-dimethoxy-5-(2- | −0.651087393 | 2.36E−08 | 0.000542847 |
| | naphthalenylthio)- | | | |
| 637396 | NA | −0.714931746 | 2.38E−08 | 0.000547448 |
| 621179 | Spiro[3H-indole-3,2′-oxirane]-2-one, 3′-(4- | −0.659301397 | 2.45E−08 | 0.000563549 |
| | chlorophenylcarbonyl)-1,2-dihydro | | | |
| 697932 | NA | −0.650458629 | 2.46E−08 | 0.000565849 |
| 654893 | NA | −0.668313908 | 2.47E−08 | 0.000568149 |
| 670787 | NA | −0.663498263 | 2.50E−08 | 0.00057505 |
| 38186 | Mercury, (p-dioxane-2,5- | −0.687521186 | 2.51E−08 | 0.00057735 |
| | diyldimethylene)bis[(octanoyloxy)- | | | |
| 702131 | NA | 0.658900577 | 2.52E−08 | 0.00057965 |
| 666667 | NA | −0.653058665 | 2.76E−08 | 0.000634855 |
| 660634 | 2-Chloro-3-(2-chloroethoxy)-naphthazarin | −0.666513015 | 2.78E−08 | 0.000639456 |
| 710404 | NA | −0.648394613 | 2.81E−08 | 0.000646356 |
| 96914 | Perfluorobenzophenone, Benzophenone, decafluoro | −0.648244928 | 2.84E−08 | 0.000653257 |
| 646159 | NA | −0.660736906 | 3.00E−08 | 0.00069006 |
| 683922 | NA | −0.647429956 | 3.00E−08 | 0.00069006 |
| 625350 | Benzenepropanoic acid, .beta.(benzoylamino)-.alpha.- | 0.647134169 | 3.06E−08 | 0.000703861 |
| | hydroxy-, (9,10-dihydro-9,10-dioxo-2- | | | |
| | anthracenyl)methyl ester (R*,R*) | | | |
| 630686 | NA | −0.705364933 | 3.09E−08 | 0.000710762 |
| 671399 | 4-Imidazolidinethione, 2-imino-1,3-diphenyl-5- | −0.651168329 | 3.12E−08 | 0.000717662 |
| | (phenylimino)- | | | |
| 717903 | NA | −0.64653219 | 3.18E−08 | 0.000731464 |
| 703770 | C35H43N5O | −0.659692666 | 3.21E−08 | 0.000738364 |
| 689278 | NA | −0.664139263 | 3.24E−08 | 0.000745265 |
| 687311 | Acridine, 9-[5-(ethylthio)-1,3,4-thiadiazol-2-yl]- | −0.646190113 | 3.25E−08 | 0.000747565 |
| 626875 | NA | −0.683431618 | 3.27E−08 | 0.000752165 |
| 695332 | NA | 0.688535748 | 3.27E−08 | 0.000752165 |
| 637397 | NA | −0.688485111 | 3.28E−08 | 0.000754466 |
| 710268 | NA | −0.650296004 | 3.30E−08 | 0.000759066 |
| 335789 | 3-Azabicyclo[3.2.1]nonane-3-carbothioic acid, [1-(6- | −0.650131035 | 3.33E−08 | 0.000765967 |
| | methyl-2-pyridinyl)ethylidene]hydrazide | | | |
| 699097 | NA | −0.654577866 | 3.33E−08 | 0.000765967 |
| 682817 | 7,10:11,14-Dietheno-28H-23,27-nitrilo-22H- | 0.645438569 | 3.41E−08 | 0.000784368 |
| | dibenzo[b,p] [l,18,5,14]dioxadiazacyclopentacosine | | | |
| | (1S,4R,5R,8R,12R,13S)-1,5-dimethyl-9-methylene- | | | |
| 724784 | 11,14,15,16- | −0.64968865 | 3.43E−08 | 0.000788969 |
| | tetraoxatetracyclo[10.3.1.04,13.08,13]hexadec-10- | | | |
| | yl]oxy}-3-hexenyl)oxy]-1,5,-dimethyl-9-methylene- | | | |
| | 11,14,15,16- | | | |
| | tetraoxatetracyclo[10.3.1.04,13.08,13]hexadecane | | | |
| 208733 | Ramentaceone, 7-Methyl juglon | −0.645205303 | 3.46E−08 | 0.000795869 |
| 145611 | Rifamycin, 3-[(4-methyl-1-piperazinyl)methyl]- | −0.644493898 | 3.62E−08 | 0.000832672 |
| 638279 | NA | −0.644241541 | 3.68E−08 | 0.000846474 |
| 616511 | NA | 0.652709332 | 3.76E−08 | 0.000864875 |
| 285166 | Oxin, Tumex, 8-Quinolinol | −0.648187201 | 3.78E−08 | 0.000869476 |
| 692587 | ethyl-8-(4-chlorophenyl)-4-methyl-2-oxo-6-(thiophen- | −0.652474948 | 3.81E−08 | 0.000876376 |
| | 2-yl)-4a,7-dihydro-2H-chromene-3-carboxylate | | | |
| 688816 | NA | 0.647712652 | 3.89E−08 | 0.000894778 |
| 648148 | NA | −0.643302083 | 3.91E−08 | 0.000899378 |
| 353896 | 1-Piperazinecarbothioic acid, 4-(2-pyridinyl)-, 2-[1-(1- | −0.647336089 | 3.99E−08 | 0.00091778 |
| | isoquinolinyl)ethyl]hydrazide | | | |
| 711592 | NA | −0.647288928 | 4.00E−08 | 0.00092008 |
| 648147 | NA | −0.642618951 | 4.09E−08 | 0.000940782 |
| 643134 | NA | −0.684866713 | 4.13E−08 | 0.000949983 |
| 710440 | NA | −0.665061886 | 4.13E−08 | 0.000949983 |
| 645147 | NA | −0.70052814 | 4.21E−08 | 0.000968384 |
| 305821 | NA | −0.655365182 | 4.23E−08 | 0.000972985 |
| 663290 | 2-chloro-3-N-(2′-(R)-hydroxymethylpyrrolidino)- | −0.641422442 | 4.41E−08 | 0.001014388 |
| | naphthazarine | | | |
| 321206 | NA | −0.641268468 | 4.45E−08 | 0.001023589 |
| 658872 | NA | −0.659045691 | 4.49E−08 | 0.00103279 |
| 710868 | NA | −0.640735602 | 4.61E−08 | 0.001060392 |
| 667706 | NA | −0.653714341 | 4.70E−08 | 0.001081094 |
| 668836 | NA | 0.667544405 | 4.78E−08 | 0.001099496 |
| 624158 | Benzenesulfonothioic acid, 4-methyl-,2-butene-1,4- | −0.648882092 | 4.79E−08 | 0.001101796 |
| | diyl ester, (Z)- | | | |
| 382000 | 2-Propen-1-one, 2-[(dimethylamino)methyl]-1-(2,4- | −0.639745758 | 4.90E−08 | 0.001127098 |
| | dimethyl phenyl)-, hydrochloride | | | |
| 658441 | 2-Amino-5,8-dihydroxy-1,4-naphthoquinone | −0.643721217 | 5.02E−08 | 0.0011547 |
| 670813 | NA | −0.638863346 | 5.18E−08 | 0.001191504 |
| 658143 | 2-(1-(4-(2-(2- | −0.643177834 | 5.19E−08 | 0.001193804 |
| | Hydroxyethoxy)ethyl)piperazino))naphthazarin | | | |
| 629874 | Benzenamine, 4-ethoxy-N-[(4-quinolinyl)methylene]- | −0.643106263 | 5.22E−08 | 0.001200704 |
| 639981 | NA | −0.643062432 | 5.23E−08 | 0.001203005 |
| 715648 | NA | 0.638615543 | 5.27E−08 | 0.001212205 |
| 696864 | NA | −0.638534059 | 5.29E−08 | 0.001216806 |
| 269149 | NOGARENE, U-52048 | −0.642077218 | 5.56E−08 | 0.001278911 |
| 690137 | NA | −0.690632487 | 5.57E−08 | 0.001281211 |
| 741338 | 12-Benzyl-5,12-dihydro-indeno[2′,1′:4,5]pyrrolo[3,2- | 0.646486028 | 5.57E−08 | 0.001281211 |
| | c]chinolin-6,7-dione | | | |
| 710780 | NA | −0.66496948 | 5.61E−08 | 0.001290412 |
| 645976 | Carbamic acid, (7,9-dichloro-2,8-dioxo-1- | −0.646343591 | 5.62E−08 | 0.001292712 |
| | oxaspiro[4.5]deca-6,9-dien-3-yl)-, 1,1-dimethylethyl | | | |
| | ester | | | |
| 663291 | 2-chloro-3-N-(2′-(S)-hydroxymethylpyrrolidino)- | −0.637344623 | 5.70E−08 | 0.001311114 |
| | naphthazarine | | | |
| 720564 | NA | 0.669571194 | 5.71E−08 | 0.001313414 |
| 228155 | NA | −0.637082487 | 5.80E−08 | 0.001334116 |
| 661734 | NA | −0.637014058 | 5.82E−08 | 0.001338716 |
| 118343 | RADICININ, Stemphylone | −0.694966578 | 5.96E−08 | 0.001370919 |
| 626110 | NA | −0.689489477 | 5.97E−08 | 0.001373219 |
| 664717 | NA | 0.649840156 | 5.98E−08 | 0.00137552 |
| 744999 | NA | −0.640362663 | 6.19E−08 | 0.001423824 |
| 683258 | NA | −0.640201281 | 6.25E−08 | 0.001437625 |
| 672121 | 2-Hydroxyethylthio-3-methylnaphthoquinone | −0.640149159 | 6.27E−08 | 0.001442225 |
| 684991 | NA | 0.673006751 | 6.29E−08 | 0.001446826 |
| 639517 | Cyclopentanone, 2-[(4-chlorophenyl)methylene]-5-[(4- | −0.635488873 | 6.40E−08 | 0.001472128 |
| | morpholinyl)methyl]-, hydrochloride | | | |
| 660637 | NA | −0.653282184 | 6.43E−08 | 0.001479029 |
| 689871 | NA | −0.657774765 | 6.51E−08 | 0.00149743 |
| 34821 | 2-Propen-1-one, 2-[(dimethylamino)methyl]-1-(2-nitro | −0.635020841 | 6.59E−08 | 0.001515832 |
| | phenyl)-, hydrochloride | | | |
| 615798 | NA | −0.68239814 | 6.66E−08 | 0.001531933 |
| 639542 | NA | −0.677194346 | 6.66E−08 | 0.001531933 |
| 639499 | NA | −0.682372669 | 6.67E−08 | 0.001534233 |
| 176632 | Stannane, trimethyl[(4-morpholinylthioxomethyl)thio]- | −0.703962025 | 6.86E−08 | 0.001577937 |
| 709970 | NA | −0.638604849 | 6.91E−08 | 0.001589438 |
| 723740 | Diethyl N-[-[(3-phenyl-5,7-diaminoquinoxalin-2- | −0.633951771 | 7.04E−08 | 0.001619341 |
| | yl)aminomethyl]benzoyl]-L-gluatamate | | | |
| 691220 | NA | 0.647134803 | 7.07E−08 | 0.001626241 |
| 335794 | -Piperazinecarbothioic acid, 4-(2-pyridinyl)-, [1-(2- | −0.638169284 | 7.09E−08 | 0.001630842 |
| | pyridinyl)butylidene]hydrazide | | | |
| 687526 | NA | −0.633790031 | 7.12E−08 | 0.001637742 |
| 680649 | Benzoic acid, 4-[2-(3,6-dioxo-1,4-cyclohexadienyl)- | −0.642447826 | 7.15E−08 | 0.001644643 |
| | ethyl]-,methyl ester | | | |
| 678490 | NA | −0.633670084 | 7.17E−08 | 0.001649243 |
| 694465 | NA | −0.660753598 | 7.28E−08 | 0.001674546 |
| 625495 | 1-Piperidinecarbodithioic acid, antimony complex | −0.633116158 | 7.42E−08 | 0.001706748 |
| 634784 | 4-Piperidinone, 1-[3-(dimethylamino)-1-oxopropyl]- | −0.641843548 | 7.42E−08 | 0.001706748 |
| | 3,5-bis(phenylmethylene)-, monohydrochloride | | | |
| 658365 | NA | −0.650885946 | 7.45E−08 | 0.001713649 |
| 680553 | 2-Quinoxalinecarboxylic acid, 3-[(4- | 0.632426704 | 7.74E−08 | 0.001780355 |
| | fluorophenyl)amino]-, ethyl ester | | | |
| 723552 | NA | −0.632391437 | 7.76E−08 | 0.001784955 |
| 723548 | NA | −0.631797495 | 8.04E−08 | 0.001849361 |
| 650745 | NA | −0.679258766 | 8.07E−08 | 0.001856261 |
| 625501 | Antimony, chlorobis(1-piperidinecarbodithioato-S,S′)- | −0.631326045 | 8.28E−08 | 0.001904566 |
| 660638 | NA | −0.644161955 | 8.49E−08 | 0.00195287 |
| 740084 | 4-Carboxyl-benzo[b]thieno[17,16-d]-3-O-methyl- | −0.634602557 | 8.83E−08 | 0.002031077 |
| | estra-1,3,5(10),16-tetraen-3-ol | | | |
| 681757 | NA | −0.638793028 | 8.95E−08 | 0.002058679 |
| 323241 | 3-Azabicyclo[3.2.2]nonane-3-carboselenoic acid, [1- | −0.638458248 | 9.13E−08 | 0.002100083 |
| | (2-pyridinyl)ethylidene]hydrazide | | | |
| 676429 | NA | −0.62970674 | 9.14E−08 | 0.002102383 |
| 622700 | Methanaminium, (2-oxo-1,3- | −0.629497914 | 9.26E−08 | 0.002129985 |
| | cyclohexanediyl)bis(methyl)bis [N,N,N-trimethyl-, | | | |
| | diiodide | | | |
| 715719 | NA | 0.647261212 | 9.29E−08 | 0.002136886 |
| 131238 | NA | −0.629334364 | 9.35E−08 | 0.002150687 |
| 681104 | 1,4,7,10-Tetraazacyclododecane-1,7- | −0.629239243 | 9.41E−08 | 0.002164488 |
| | bis(methanephosphonicacid) | | | |
| 683326 | NA | −0.633221885 | 9.60E−08 | 0.002208192 |
| 715436 | NA | −0.628794739 | 9.66E−08 | 0.002221993 |
| 647472 | NA | −0.676216898 | 9.69E−08 | 0.002228894 |
| 9358 | PADA, Pyridine-2-azodimethylaniline | −0.632986428 | 9.74E−08 | 0.002240395 |
| 607320 | NA | −0.628664501 | 9.74E−08 | 0.002240395 |
| 246981 | NA | −0.632416098 | 1.01E−07 | 0.002323202 |
| 173905 | Pentanamide, 2-(acetylamino)-N-[3-chloro-2-oxo-1- | −0.632082775 | 1.03E−07 | 0.002369206 |
| | (phenylmethyl)propyl]-4-methyl- | | | |
| 309909 | NIMBOLIDE | −0.632098693 | 1.03E−07 | 0.002369206 |
| 668885 | NA | 0.636389583 | 1.03E−07 | 0.002369206 |
| 661224 | NA | −0.627244847 | 1.06E−07 | 0.002438212 |
| 681271 | 1,3,6-Triphenyl-oxazolo(5,4-d)pyrimidin-2′,4(1H,3H)- | 0.627333988 | 1.06E−07 | 0.002438212 |
| | dion | | | |
| 650792 | 1,4,7,10-Tetrathia-13-azacyclopentadecane, 13-[(4- | 0.627185177 | 1.07E−07 | 0.002461214 |
| | methylphenyl)sulfonyl]- | | | |
| 705163 | NA | −0.627092367 | 1.07E−07 | 0.002461214 |
| 637399 | NA | −0.627006549 | 1.08E−07 | 0.002484216 |
| 640355 | NA | −0.635693758 | 1.08E−07 | 0.002484216 |
| 668265 | NA | −0.635694004 | 1.08E−07 | 0.002484216 |
| 678503 | 1-Cyclobuten-3-one, 4,4-dichloro-1-pentyl- | −0.626545825 | 1.11E−07 | 0.002553222 |
| 131233 | Cyclopentanone, 2,5-bis[(dimethylamino)methyl]-, | −0.634927797 | 1.13E−07 | 0.002599226 |
| | dihydrochloride | | | |
| 656599 | NA | −0.625789195 | 1.16E−07 | 0.002668232 |
| 641048 | 3,4′,4″,4″′-Tetrasulfonyl copper phthalocyanine, tetra | −0.629934123 | 1.17E−07 | 0.002691234 |
| | sodium salt | | | |
| 677168 | NA | −0.625682634 | 1.17E−07 | 0.002691234 |
| 620514 | 1,4-Naphthalenedione, 7-(benzoyloxy)-5-methoxy- | −0.625235185 | 1.20E−07 | 0.00276024 |
| 645740 | NA | 0.683316612 | 1.21E−07 | 0.002783242 |
| 717896 | NA | −0.625091031 | 1.21E−07 | 0.002783242 |
| 641395 | 1H-Benzo[a]carbazole-1,4(11H)-dione, 8-methoxy- | −0.628928325 | 1.24E−07 | 0.002852248 |
| 130789 | NA | −0.624363897 | 1.26E−07 | 0.002898252 |
| 654379 | ANTINEOPLASTIC-654379 | −0.624401714 | 1.26E−07 | 0.002898252 |
| 677937 | NA | −0.624385863 | 1.26E−07 | 0.002898252 |
| 630708 | Azacridoguanidine | −0.68237738 | 1.27E−07 | 0.002921254 |
| 629974 | 7H-1,2,4-Triazolo[3,4-b][1,3,4]thiadiazine, 3-(4- | −0.624033257 | 1.29E−07 | 0.002967258 |
| | chlorophenyl)-6-(5-nitro-2-furanyl)- | | | |
| 709468 | NA | −0.645997904 | 1.33E−07 | 0.003059266 |
| 637578 | N-[3-(2-Pyridyl)isoquinolin-1-yl]-2- | −0.623083451 | 1.36E−07 | 0.003128272 |
| | pyridinecarboxamidine | | | |
| 622460 | NA | −0.681190536 | 1.37E−07 | 0.003151274 |
| 637422 | NA | 0.665177697 | 1.37E−07 | 0.003151274 |
| 689185 | NA | −0.640731926 | 1.37E−07 | 0.003151274 |
| 106360 | NA | 0.640669699 | 1.38E−07 | 0.003174276 |
| 705162 | NA | −0.622909048 | 1.38E−07 | 0.003174276 |
| 678156 | NA | −0.622706786 | 1.39E−07 | 0.003197278 |
| 723001 | Diethyl-N[4-(3-thienylquinoxalyn-2- | 0.635529616 | 1.42E−07 | 0.003266284 |
| | yl)oxiphenylacetyl]-L-glutamate | | | |
| 639543 | Cyclopentanone, 2-[(4-chlorophenyl)aminomethyl]-5- | −0.62629817 | 1.45E−07 | 0.00333529 |
| | [(4-chlorophenyl)methylene]- | | | |
| 646160 | NA | −0.635088883 | 1.46E−07 | 0.003358292 |
| 625511 | NA | −0.663955843 | 1.47E−07 | 0.003381294 |
| 625496 | NA | −0.69107229 | 1.48E−07 | 0.003404296 |
| 638302 | NA | −0.663496442 | 1.51E−07 | 0.003473302 |
| 711861 | NA | −0.634532398 | 1.51E−07 | 0.003473302 |
| 684703 | 5,8-Quinolinedione, 2-chloro-6-methoxy-4-methyl-7- | −0.621137739 | 1.53E−07 | 0.003519306 |
| | propyl- | | | |
| 292206 | RUSTAIYAN A | −0.625160256 | 1.55E−07 | 0.00356531 |
| 668259 | NA | −0.625120569 | 1.56E−07 | 0.003588312 |
| 668335 | NA | −0.620852014 | 1.56E−07 | 0.003588312 |
| 691415 | NA | 0.620438655 | 1.59E−07 | 0.003657318 |
| 742801 | 3-amino-N-(4-butoxyphenyl)-1H-indazole-1- | −0.620330677 | 1.60E−07 | 0.00368032 |
| | carboxamide | | | |
| 684982 | NA | 0.63315698 | 1.64E−07 | 0.003772328 |
| 379546 | NA | −0.619836469 | 1.65E−07 | 0.00379533 |
| 626162 | Discorhabdin C•TFA | −0.619726061 | 1.66E−07 | 0.003818332 |
| 661440 | 5H-Benzocyclohepten-5-one, 6,7,8,9-tetrahydro-6- | −0.619691759 | 1.67E−07 | 0.003841334 |
| | [(dimethylamino)methyl]-, hydrochloride | | | |
| 701663 | NA | −0.628204582 | 1.68E−07 | 0.003864336 |
| 657747 | NA | −0.661425358 | 1.70E−07 | 0.00391034 |
| 659754 | NA | 0.628009274 | 1.70E−07 | 0.00391034 |
| 713309 | NA | −0.656113103 | 1.73E−07 | 0.003979346 |
| 670341 | NA | −0.631705072 | 1.78E−07 | 0.004094356 |
| 638241 | NA | −0.618419911 | 1.79E−07 | 0.004117358 |
| 717518 | NA | −0.618225576 | 1.81E−07 | 0.004163362 |
| 666388 | NA | −0.618004813 | 1.84E−07 | 0.004232368 |
| 707827 | NA | −0.622156899 | 1.85E−07 | 0.00425537 |
| 668261 | NA | −0.621698553 | 1.90E−07 | 0.00437038 |
| 716688 | NA | 0.630514378 | 1.91E−07 | 0.004393382 |
| 710386 | NA | −0.621128737 | 1.97E−07 | 0.004531394 |
| 711074 | NA | −0.62545713 | 1.97E−07 | 0.004531394 |
| 92937 | 1H-Benzo[a]carbazole-1,4(11H)-dione, 11-methyl- | −0.620925096 | 1.99E−07 | 0.004577398 |
| 685016 | NA | −0.625222241 | 2.00E−07 | 0.0046004 |
| 709438 | NA | −0.620521121 | 2.04E−07 | 0.004692408 |
| 619042 | Cyclohexanone, 2,6-bis[(dimethylamino)methyl]-, | −0.620080892 | 2.09E−07 | 0.004807418 |
| | dihydrochloride | | | |
| 669308 | NA | 0.628904571 | 2.10E−07 | 0.00483042 |
| 668264 | NA | −0.619602527 | 2.15E−07 | 0.00494543 |
| 310365 | Na | −0.615258346 | 2.16E−07 | 0.004968432 |
| 149286 | 1,4-Pentadien-3-one, 1,5-di-3-pyridyl- | −0.615162113 | 2.17E−07 | 0.004991434 |
| 94889 | Gardenin, Flavone, 5-hydroxy-3′,4′,5′,6,7,8- | 0.623612432 | 2.20E−07 | 0.00506044 |
| | hexamethoxy- | | | |
| 618770 | Piperidin-4-ol, N-ethyl-N-methyl-3-(1-oxo-3-phenyl- | −0.623569755 | 2.20E−07 | 0.00506044 |
| | 2-propen-1-yl)-4-(2-phenylethen-1-yl)-, (E,E)-, | | | |
| | bromide | | | |
| 709483 | NA | −0.64685872 | 2.21E−07 | 0.005083442 |
| 382001 | 2-Propen-1-one, 2-[(dimethylamino)methyl]-1-(2,5- | −0.618951658 | 2.23E−07 | 0.005129446 |
| | dimethyl phenyl)-, hydrochloride | | | |
| 618315 | 1,4-Naphthalenedione, 5-methoxy- | −0.627510546 | 2.27E−07 | 0.005221454 |
| 715226 | NA | −0.618650914 | 2.27E−07 | 0.005221454 |
| 684424 | Methyl 4-[2-[4-bromo-2,5- | −0.614113457 | 2.30E−07 | 0.00529046 |
| | dihydroxyphenyl]ethyl]benzoate | | | |
| 640466 | 15-Ethoxynimbocinol | −0.671985843 | 2.32E−07 | 0.005336464 |
| 620358 | Methyl 13-hydroxy-15-oxo-kaurenoate | −0.671890809 | 2.33E−07 | 0.005359466 |
| 736049 | N-[2-(4-methoxyphenyl)-4-oxo-1,3-thiazolidin-3-yl]- | 0.626940564 | 2.35E−07 | 0.00540547 |
| | N′-(2-methylimidazo[1,2-a]pyridin-3-yl)urea | | | |
| 620327 | Carbonimidodithioic acid, [5-(4-nitrophenyl)-1,3,4- | 0.617663697 | 2.40E−07 | 0.00552048 |
| | thiadiazol-2-yl]-, dimethyl ester | | | |
| 310342 | Carbamimidothioic acid, [3-(4-chlorophenyl)-1,2,4- | −0.621895705 | 2.42E−07 | 0.005566484 |
| | oxadiazol-5-yl]methyl ester, monohydrochloride | | | |
| 711830 | NA | −0.635491131 | 2.44E−07 | 0.005612488 |
| 714424 | NA | −0.621691132 | 2.45E−07 | 0.00563549 |
| 252844 | SHIKONIN, Tokyo Violet | −0.617302174 | 2.46E−07 | 0.005658492 |
| 668256 | NA | −0.617296362 | 2.46E−07 | 0.005658492 |
| 659288 | NA | −0.621378809 | 2.50E−07 | 0.0057505 |
| 711934 | NA | −0.617018974 | 2.50E−07 | 0.0057505 |
| 672041 | NA | −0.612352536 | 2.55E−07 | 0.00586551 |
| 712738 | NA | −0.63466292 | 2.55E−07 | 0.00586551 |
| 668325 | NA | −0.612238115 | 2.57E−07 | 0.005911514 |
| 682504 | NA | 0.612165578 | 2.58E−07 | 0.005934516 |
| 680551 | NA | 0.616154164 | 2.62E−07 | 0.006026524 |
| 690134 | NA | 0.611912293 | 2.62E−07 | 0.006026524 |
| 635449 | Copper, chloro[2-[1-(2-pyridinyl)ethylidene][N,N- | −0.61593769 | 2.65E−07 | 0.00609553 |
| | dipropyl-hydrazinecarbothioamidato-N,N,S]- | | | |
| 674068 | NA | −0.629093902 | 2.69E−07 | 0.006187538 |
| 710104 | NA | −0.624561292 | 2.69E−07 | 0.006187538 |
| 718306 | NA | 0.633722289 | 2.69E−07 | 0.006187538 |
| 636878 | 3-Methoxy-2-phenoxy-2-phenylimidazo[1,2- | −0.65325807 | 2.71E−07 | 0.006233542 |
| | b]pyridazine | | | |
| 324979 | Copper, chloro[hexahydro-1H-azepine-1-carbothioic | −0.619883076 | 2.72E−07 | 0.006256544 |
| | acid[1-(2-pyridinyl)ethylidene]hydrazidato]-, (SP-4- | | | |
| | 3)- | | | |
| 709882 | Cirensenoxide G, Pulsatilloside C | −0.611256814 | 2.72E−07 | 0.006256544 |
| 706192 | NA | −0.611187257 | 2.73E−07 | 0.006279546 |
| 715472 | NA | −0.615312348 | 2.75E−07 | 0.00632555 |
| 683260 | NA | −0.61526749 | 2.76E−07 | 0.006348552 |
| 715556 | NA | −0.624113833 | 2.76E−07 | 0.006348552 |
| 653624 | NA | −0.663261204 | 2.79E−07 | 0.006417558 |
| 659554 | 6-Bromo-3-bromomethyl-3,7-dichloro-7-methyl-1- | −0.628244852 | 2.82E−07 | 0.006486564 |
| | octene | | | |
| 664303 | Quinoline-2-ethanol, .alpha.,.alpha.- | −0.610594963 | 2.82E−07 | 0.006486564 |
| | bis(trifluoromethyl)-, acetate (ester) | | | |
| 692405 | NA | −0.619044885 | 2.85E−07 | 0.00655557 |
| 669503 | NA | −0.610360963 | 2.86E−07 | 0.006578572 |
| 709928 | NA | 0.623421018 | 2.87E−07 | 0.006601574 |
| 657030 | NA | −0.610202701 | 2.88E−07 | 0.006624576 |
| 704212 | NA | 0.618889672 | 2.88E−07 | 0.006624576 |
| 640192 | 6-Phenylthio-7H-benzocycloheptene-1,4,7-trione | −0.618558464 | 2.93E−07 | 0.006739586 |
| 677640 | NA | 0.609916098 | 2.93E−07 | 0.006739586 |
| 679092 | NA | 0.609732962 | 2.96E−07 | 0.006808592 |
| 706160 | NA | −0.641229625 | 3.03E−07 | 0.006969606 |
| 643726 | NA | −0.667098829 | 3.05E−07 | 0.00701561 |
| 661581 | 2-Azabicyclo[16.3.1]docosane, geldanamycin deriv. | −0.609182881 | 3.06E−07 | 0.007038612 |
| 328416 | Withaferin-A diacetate | −0.613290735 | 3.09E−07 | 0.007107618 |
| 686368 | Quinazolin-4(3H)-one, 3-ethyl-2-[[[5-(phenylamino)- | 0.613192938 | 3.10E−07 | 0.00713062 |
| | 1,3,4-thiadiazol-2-yl]methyl]thio]- | | | |
| 697223 | NA | −0.6408016 | 3.10E−07 | 0.00713062 |
| 687011 | stereoisomer of 672120 (MW = 262) | −0.617184002 | 3.17E−07 | 0.007291634 |
| 744075 | NA | −0.617186086 | 3.17E−07 | 0.007291634 |
| 36806 | NA | −0.608429405 | 3.19E−07 | 0.007337638 |
| 269121 | DALBERGIONE | −0.60840149 | 3.19E−07 | 0.007337638 |
| 620515 | 1,4-Naphthalenedione, 2-chloro-8-hydroxy-6- | −0.61252676 | 3.22E−07 | 0.007406644 |
| | methoxy-7-methyl- | | | |
| 3907 | Benzoic acid, 2-hydroxy-, compd. with 8-quinolinol | −0.608205293 | 3.23E−07 | 0.007429646 |
| | (1:1) | | | |
| 747168 | NA | −0.608190859 | 3.23E−07 | 0.007429646 |
| 645633 | NA | −0.660474668 | 3.26E−07 | 0.007498652 |
| 690747 | NA | −0.621016008 | 3.28E−07 | 0.007544656 |
| 71297 | Dihydrotomatidine | −0.616518472 | 3.29E−07 | 0.007567658 |
| 659553 | 2,3,6-Tribromo-7-chloro-3,7-dimethyl-1-octene | −0.616495519 | 3.29E−07 | 0.007567658 |
| 711811 | NA | −0.616452599 | 3.30E−07 | 0.00759066 |
| 704100 | NA | −0.607555312 | 3.35E−07 | 0.00770567 |
| 668263 | NA | −0.615548736 | 3.47E−07 | 0.007981694 |
| 641394 | 1H-Benzo[a]carbazole-1,4(11H)-dione, 11-phenyl- | −0.611142543 | 3.48E−07 | 0.008004696 |
| 703776 | NA | −0.606842408 | 3.49E−07 | 0.008027698 |
| 687110 | NA | −0.615350495 | 3.51E−07 | 0.008073702 |
| 634473 | NA | 0.648393156 | 3.55E−07 | 0.00816571 |
| 656433 | Pyrimidine-5-carboxylic acid, hexahydro-4-oxo-1,3- | −0.628797162 | 3.55E−07 | 0.00816571 |
| | diphenyl-6-[2-[2-(piperidin-1-yl)ethyl]thio]-2-thioxo-, | | | |
| | ethyl ester | | | |
| 709516 | NA | −0.610775393 | 3.55E−07 | 0.00816571 |
| 672042 | NA | −0.606500222 | 3.56E−07 | 0.008188712 |
| 648150 | NA | −0.606445169 | 3.57E−07 | 0.008211714 |
| 162062 | Bicyclo[2.2.1]heptan-2-one, 3-[2-chloro-1- | −0.610584265 | 3.59E−07 | 0.008257718 |
| | (chlorodifluoromethyl)-2,2-difluoroethylidene]- | | | |
| 622150 | Violacene-1 | −0.663971691 | 3.62E−07 | 0.008326724 |
| 712682 | NA | −0.62380367 | 3.62E−07 | 0.008326724 |
| 671363 | 2-Thiazolidinethione, 3-(4-fluorophenyl)-4,5- | −0.606104047 | 3.64E−07 | 0.008372728 |
| | bis(phenylimino)- | | | |
| 699428 | NA | −0.61037114 | 3.64E−07 | 0.008372728 |
| 715748 | NA | 0.610004249 | 3.71E−07 | 0.008533742 |
| 678125 | 1H-indazole, 3-methoxy-1-[(2- | 0.618682868 | 3.74E−07 | 0.008602748 |
| | methoxyphenyl)methyl]-5-nitro- | | | |
| 633207 | NA | −0.65782208 | 3.77E−07 | 0.008671754 |
| 638265 | NA | −0.647191416 | 3.80E−07 | 0.00874076 |
| 698148 | NA | −0.605309413 | 3.80E−07 | 0.00874076 |
| 659390 | NA | −0.605247653 | 3.81E−07 | 0.008763762 |
| 685918 | NA | −0.609540666 | 3.81E−07 | 0.008763762 |
| 713690 | NA | −0.64185064 | 3.85E−07 | 0.00885577 |
| 671379 | NA | 0.605056403 | 3.86E−07 | 0.008878772 |
| 302979 | Shikoccin, Isodon Shikokianus compound A | −0.604920158 | 3.88E−07 | 0.008924776 |
| 686130 | Acetamide, N-[6′-(diethylamino)-3-oxospiro- | −0.604880228 | 3.89E−07 | 0.008947778 |
| | [isobenzofuran-1(3H),9′-[9H]xanthen]-2′-yl]-N- | | | |
| | phenyl- | | | |
| 704565 | NA | −0.609113351 | 3.90E−07 | 0.00897078 |
| 693813 | NA | −0.608723565 | 3.99E−07 | 0.009177798 |
| 704970 | NA | −0.641020396 | 4.03E−07 | 0.009269806 |
| 711824 | NA | −0.612822741 | 4.04E−07 | 0.009292808 |
| 677268 | NA | −0.651006745 | 4.09E−07 | 0.009407818 |
| 3927 | Thiolutin, Acetopyrrothin | −0.603917571 | 4.11E−07 | 0.009453822 |
| 618560 | NA | 0.650868305 | 4.12E−07 | 0.009476824 |
| 712571 | Artesunate, Dihydroqinghaosusuccinate | −0.626057056 | 4.13E−07 | 0.009499826 |
| 625814 | NA | −0.656056228 | 4.15E−07 | 0.00954583 |
| 639387 | NA | −0.667005018 | 4.16E−07 | 0.009568832 |
| 625502 | 4-Morpholinecarbodithioic acid, antimony complex | −0.603480214 | 4.21E−07 | 0.009683842 |
| 626161 | 2-Hydroxy discorhabdin D | −0.672112363 | 4.29E−07 | 0.009867858 |

### Example 2

### Gene Expression Data Reveal Common Pathways that Characterize the Unifocal Nature of Ovarian Cancer

### Materials and Methods

Pelvic OVCA samples and matched, nonconfluent, extrapelvic implants were obtained from 30 patients who had provided written informed consent to the Moffitt Cancer Center Institutional Total Cancer Care (TCC) protocol, prior to undergoing primary cytoreductive surgery for advanced stage serous epithelial OVCA. The study was carried out with approval from the University of South Florida Institutional Review Board.

A pelvic sample was resected from the ovarian tissue, which, in the opinion of the surgeon, most likely represented the primary site in the pelvis. From each patient, a matched, nonconfluent extrapelvic implant was identified and collected. Samples were flash frozen in liquid nitrogen within 10 minutes of surgical resection and stored at −80° C. A histopathological review was performed to confirm the diagnosis, and samples were macrodissected to ensure greater than 70% tumor content. Total RNA and genomic DNA were extracted from each sample.

Normal ovarian surface epithelium (NOSE) samples were obtained from patients who had provided written informed consent to the TCC protocol and had undergone oophorectomy at the Moffitt Cancer Center for nonmalignant disease, not associated with the ovary. Immediately after surgical resection, the surface epithelium was gently scraped from the surface and immediately subjected to RNA isolation. To ensure sufficient quantities of RNA, NOSE RNA samples were pooled in groups of 3 or 4 to produce a minimum RNA quantity of 50 ng. As a result of such pooling, 49 normal ovaries were analyzed on 12 Affymetrix Gene-Chip assays (Santa Clara, Calif.).

Approximately 30 mg of tissue was used for each RNA and DNA extraction. Tissues were pulverized in BioPulverizer H tubes (Bio101) using a Mini-Beadbeater (Biospec Products, Bartlesville, Okla.). Total RNA was collected using the QIAGEN RNeasy minikit (Valencia, Calif.) according to the manufacturer's instructions. RNA quality was checked on an Agilent Bioanalyzer (Palo Alto, Calif.) to assess the quality of RNA via the 28S:18S ribosomal RNAs. Genomic DNA was isolated using the QIAGEN QIAamp® DNA minikit according to the manufacturer's instructions. For microarray analysis, 10 mg of total RNA was used to develop the targets for Affymetrix microarray analysis, and probes were prepared according to the manufacturer's instructions. Briefly, biotin-labeled complementary RNA was produced by in vitro transcription, fragmented, and hybridized to the customized human Affymetrix HuRSTA gene chips (HuRSTA-2a520709). Expression values were calculated using the robust multiarray average algorithm implemented in Bioconductor extensions to the R statistical programming environment.

A Student t test was used to identify differentially expressed genes in comparisons among NOSE, pelvic, and extrapelvic sample genomic data. For each comparison, the 12 NOSE samples were grouped together. Pelvic and extrapelvic genomic profiles were analyzed as groups (pelvic as one group, extrapelvic as another) and as individual pairs (comparisons of matched pelvic/extrapelvic pairs from the same patient). As such, the following comparisons were made: (1) grouped NOSE vs grouped pelvic implants, (2) grouped NOSE vs grouped extrapelvic implants, (3) grouped pelvic vs grouped extrapelvic implant, (4) grouped NOSE vs individual pelvic implants, (5) grouped NOSE vs individual extrapelvic implants, and (6) individual pelvic vs individual matched extrapelvic samples from the same patient. For each of the comparisons, differentially expressed genes were analyzed using MetaCore™ software (GeneGO, St Joseph, Mich.) to identify represented biological pathways.

Identified pathways were further evaluated for differential representation in 4 publically available gene expression datasets encompassing 389 patient samples including: (1) OVCA (n=12; 4 early- and 8 advanced-stage), GEO accession number GSE14407, U133Plus gene chip; (2) oral cancer (n=27; 22 primary lesions, 5 metastases), GEO accession GSE2280, U133A gene chip; (3) prostate cancer (n=271; 196 primary lesions, 75 metastases), GEO accession GSE6919, U95 gene chip; and (4) prostate cancer (n=79; 40 nonrecurrent, 39 recurrent lesions), GEO accession GSE25136, U133A gene chip (by Student t test, gene cutoff P<0.01).

Principal component analysis (PCA) was performed using Evince software. Logrank tests were used to test associations between pathway expression (using a median PCA score value cutoff) and overall survival within 9 publically available datasets comprising 1691 patient samples, including cancers of the ovary, which included 4 datasets (Australian dataset [n=218 GSE9891], 3 Moffitt Cancer Center (MCC) dataset [n=142], 4 MD Anderson dataset [n=53 GSE18520], and The Cancer Genome Atlas (TCGA) dataset [n=497]) as well as brain (n=182 GSE13041), 5 breast (n=187 GSE2990), colon (n=177 GSE17538), 6 lung (n=58 TCGA), and blood (leukemia, n=182 TCGA). All survival analyses were performed using the R program.

For sequence analysis of p53, exons 5-8 of p53 from primary lesions and distal metastases separated by noninvolved tissue were analyzed for primary sequence mutation patterns. Genomic DNA (100 ng) was used in PCR amplification reactions essentially as described previously (Leonard D G, et al. Clin Cancer Res 2002 8:973-85) using the following primers:

exon 5,
sense
(SEQ ID NO: 1)
5′-TTCCTCTTCCTACAGTACTC-3′,
antisense
(SEQ ID NO: 2)
5′-GCAACCAGCCCTGTCGTCTC-3′;
exon 6,
sense
(SEQ ID NO: 3)
5′-ACCATGAGCGCTGCTCAGAT-3′,
antisense
(SEQ ID NO: 4)
5′-AGTTGCAAACCAGACGTCAG-3′;
exon 7,
sense
(SEQ ID NO: 5)
5′-GTGTTGTCTCCTAGGTTCGC-3′,
antisense
(SEQ ID NO: 6)
5′-CAAGTGGCTCCTGACCTGGA-3′;
and
exon 8,
sense
(SEQ ID NO: 7)
5′-CCTATCCTGAGTAGTGGTAA-3′,
antisense
(SEQ ID NO: 8)
5′-TGAATCTGAGGCATAACTGC-3′.

Amplifications were performed using an Eppendorf Mastercycler® thermocycler in 50 mL reaction volumes (100 ng genomic DNA, 1 U Taq DNA polymerase [Invitrogen, Carlsbad, Calif.], 1.5 mM MgCl2, 0.2 mM deoxynucleotide triphosphates, and 0.2 mM primer mix) by standard protocols. Briefly, samples were held at 95° C. for 10 minutes followed by 30 cycles of the following: 95° C. for 50 seconds, annealing temperature at 56° C. or 60° C., depending on the primers, for 90 seconds, and an elongation step at 72° C. for 90 seconds. After cycling, samples were held at 72° C. for 10 minutes and cooled to 4° C. PCR products were purified using the Purelink® PCR purification kit (QIAGEN) and evaluated using 4% agarose gels. Sequencing was performed on an Applied Biosystem's AB3130 genetic analysis system using BigDye® 3.1 dye terminator chemistry (Applera, Applied Biosystems, Foster City, Calif.) according to the manufacturer's instructions. Comparative sequence analysis of p53 exons was performed using Lasergene® 8 software (DNAStar, Madison, Wis.).

The effects of pathway inhibition on OVCA cell metastatic properties were investigated using the in vitro scratch assay. HeyA8 OVCA cells were maintained in RPMI 1640 medium (Invitrogen) supplemented with 10% fetal bovine serum (FBS; Fisher Scientific, Pittsburgh, Pa.), 1% sodiumpyruvate, 1% penicillin/streptomycin (Cellgro, Manassas, Va.), and 1% nonessential amino acids (HyClone, Hudson, N.H.). Monolayers, 75-80% confluent, were cultured in serum-free media for 4 hours and then mechanically disrupted to create a wound using a 1 mL pipette tip. Culture plates were washed twice with serum-free media to remove floating cells and then incubated with media containing 10% FBS and either vehicle (dimethylsulfoxide [DMSO]) or drug. The DMSO concentration was maintained below 0.5% so as not to influence cell growth or migration. The underside of the culture plate by the wound area was marked with a Sharpie for reference, and wounds were imaged by phase-contrast microscopy on days 0, 1, and 2.

Results

Comparison of Overall Expression Patterns

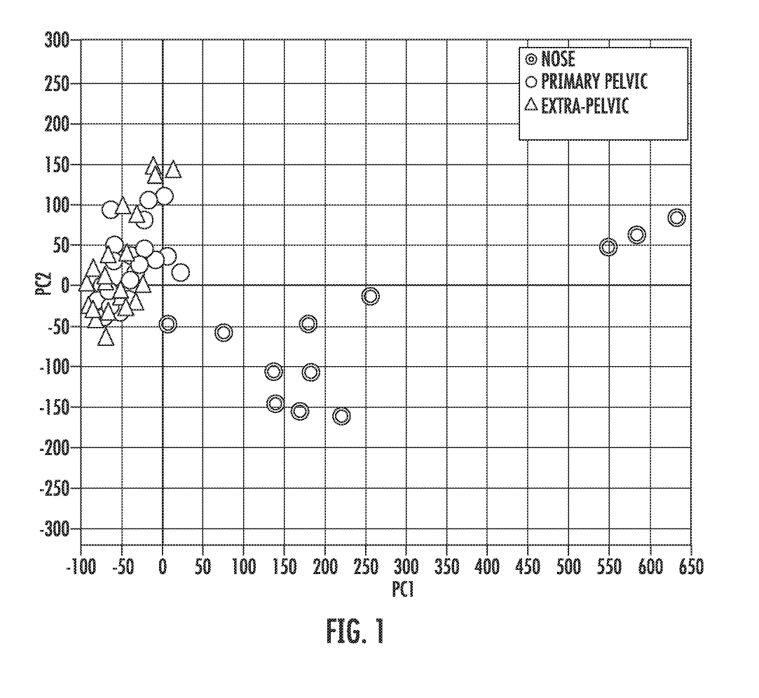

PCA modeling was used to assess the overall similarities in gene expression among NOSE, pelvic, and extrapelvic samples. PCA generates a set of vectors (termed first principal component [PC1], second principal component [PC2], etc) that summarize the overall genome-wide expression patterns for a sample. Each principal component provides a summary measure for genes that share certain expression characteristics. Comparing PCA values enables a global assessment of how similar or different samples are at a genome-wide level. The 2 first principal components for all samples are shown in FIG. 1. PC1, which explained 35.4% of the variation, separated most of the NOSE samples from the primary pelvic and the extrapelvic samples.

Comparison of Pathway Expression in NOSE, Pelvic, and Extrapelvic OVCAs

Grouped comparisons of NOSE, pelvic, and extrapelvic genomic data was performed. At a significance of P<0.01 (Bonferroni adjusted), 970 probe sets representing 71 signaling pathways (P<0.05) were identified when the grouped NOSE expression data were compared with the grouped primary pelvic sample data, and 1075 probe sets representing 143 signaling pathways were identified when the grouped NOSE expression data were compared with the grouped extrapelvic implant expression data (Table 15). Importantly, the 60 of 71 signaling pathways (85%) present in primary pelvic samples were also represented in extrapelvic implants. At this level of significance, no probe sets were found to be differentially expressed between the grouped primary pelvic and extrapelvic samples.

When the grouped NOSE dataset was analyzed against the individual pelvic primary samples (n=30) and the individual extrapelvic implants (n=30), an average of 7392 and 7772 probe sets, respectively, demonstrated differential expression (greater than 2-fold). In contrast, an average of 1463 probe sets was differentially expressed between individual pelvic and matched extrapelvic implants from the same patient. Consistently, these data suggest significant similarity between the primary pelvic and matched extrapelvic implants (Table 10).

TABLE 10
Number of probe sets with greater than 2-fold change in expression

| | Normal ovary vs | Normal ovary vs | Pelvic primary vs |
|---|---|---|---|
| Sample | pelvic primary | extrapelvic implant | extrapelvic implant |
| 1 | 6339 | 8137 | 2413 |
| 2 | 6562 | 7483 | 2813 |
| 3 | 6873 | 6608 | 3464 |
| 4 | 7049 | 7069 | 1032 |
| 5 | 8012 | 6834 | 1710 |
| 6 | 8052 | 7304 | 2446 |
| 7 | 8364 | 7951 | 335 |
| 8 | 6645 | 6886 | 6220 |
| 9 | 7229 | 7343 | 86 |
| 10 | 8469 | 7497 | 2048 |
| 11 | 8069 | 7980 | 2151 |
| 12 | 8321 | 8192 | 596 |
| 13 | 7944 | 7867 | 683 |
| 14 | 8080 | 8836 | 1135 |
| 15 | 7157 | 8225 | 1120 |
| 16 | 7249 | 7105 | 874 |
| 17 | 7171 | 7682 | 600 |
| 18 | 7424 | 7907 | 660 |
| 19 | 7754 | 8244 | 545 |
| 20 | 8342 | 8130 | 980 |
| 21 | 6790 | 8024 | 138 |
| 22 | 7341 | 7620 | 2020 |
| 23 | 6876 | 8007 | 925 |
| 24 | 6728 | 8127 | 3449 |
| 25 | 8144 | 7833 | 600 |
| 26 | 7717 | 7888 | 545 |
| 27 | 7539 | 6968 | 1630 |
| 28 | 6965 | 7629 | 620 |
| 29 | 6793 | 9087 | 850 |
| 30 | 5749 | 8706 | 1213 |
| 31 | 6304 | 6878 | 4084 |
| Mean | 7356 | 7743 | 1548 |

Mutational Analysis of p53

Exons 5-8 of the p53 gene were examined in primary pelvic and matched extrapelvic implants (Table 11). A total of 13 nucleotide mutations were found in 11 of 30 primary pelvic samples. A mutation in exon 5 was found in 1 primary pelvic, whereas 3 primary pelvic lesions had a mutation in exon 6, 7 pelvic lesions had a mutation in exon 7, and 2 pelvic lesions had a mutation in exon 8. The majority of identified mutations were missense (9 of 13); however, 1 sample showed a frame shift mutation resulting from a deletion in codon 151 of exon 5, 1 sample showed a nonsense mutation in codon 294 of exon 8, and 2 samples displayed silent mutations. In every case, the p53 mutation identified in the primary pelvic was also present in the matched extrapelvic implant.

TABLE 11
Primary sequence mutations in p53 exons 5-8

| | | | p53 mutation in primary | | | |
|---|---|---|---|---|---|---|
| | | | ovarian cancer | | | |
| | | | Primary | | | Amino acid |
| Histological type | Grade | Stage | site | Exon | Codon | change |
| Serous adenocarcinoma | High | 3C | Rt ovary | WT | WT | WT |
| Serous adenocarcinoma | High | 4 | Rt ovary | 6 | 220, | Tyr to Cys |
| | | | | | TAT to TGT | |
| | | | | 7 | 225, | Val to Val |
| | | | | | GTT to GTG | |
| Serous adenocarcinoma | High | 3C | Lt ovary | WT | WT | WT |
| Serous adenocarcinoma | High | 3C | Rt ovary | 8 | 294, | Glu to STOP |
| | | | | | GAG to TAG | |
| Serous adenocarcinoma | High | 3C | Lt ovary | WT | WT | WT |
| Adenocarcinoma with | High | 4 | Lt ovary | WT | WT | WT |
| papillary features | | | | | | |
| Adenocarcinoma with | High | 3C | Lt ovary | 7 | 248, | Arg to Gln |
| papillary features | | | | | CGG to CAG | |
| Serous adenocarcinoma | High | 3C | Rt ovary | 7 | 248, | Arg to Gln |
| | | | | | CGG to CAG | |
| Serous adenocarcinoma | High | 4 | Rt ovary | WT | WT | WT |
| Adenocarcinoma | High | 3C | Rt ovary | WT | WT | WT |
| Adenocarcinoma with | Not | 3C | Lt ovary | WT | WT | WT |
| papillary features | given | | | | | |
| Serous adenocarcinoma | High | 3C | Lt ovary | WT | WT | WT |
| Adenocarcinoma with | High | 2B | Rt ovary | 6 | 220, | Tyr to Cys |
| papillary features | | | | | TAT to TGT | |
| Clear cell carcinoma | High | 3C | Lt ovary | WT | WT | WT |
| Adenocarcinoma with | High | 3C | Lt ovary | 7 | 245, | Gly to Asp |
| papillary features | | | | | GGC to GAC | |
| Adenocarcinoma with | High | 3C | Rt ovary | 7 | 248, | Arg to Gln |
| papillary features | | | | | CGG to CAG | |
| Adenocarcinoma | High | 3C | Lt ovary | WT | WT | WT |
| Serous adenocarcinoma | High | 3C | Rt ovary | WT | WT | WT |
| Serous adenocarcinoma | High | 3C | Rt ovary | WT | WT | WT |
| Serous adenocarcinoma | High | 4 | Rt ovary | WT | WT | WT |
| Adenocarcinoma | High | 2C | Rt ovary | WT | WT | WT |
| Adenocarcinoma | High | 3C | Rt ovary | WT | WT | WT |
| Adenocarcinoma with | High | 4 | Rt ovary | WT | WT | WT |
| papillary features | | | | | | |
| Serous adenocarcinoma | High | 3C | Rt ovary | 7 | 234, | Tyr to Cys |
| | | | | | TAC to TGC | |
| Serous adenocarcinoma | High | 3C | Rt, Lt ovary | WT | WT | WT |
| Adenocarcinoma | High | 3C | Rt ovary | 5 | 151, | Pro to frame |
| | | | | | CCC to \check{ }CC | shift |
| Adenocarcinoma | High | 3B | Rt, Lt ovary | WT | WT | WT |
| Serous adenocarcinoma | Moderate | 3C | Rt ovary | WT | WT | WT |
| Serous adenocarcinoma | High | 3C | Rt, Lt ovary | 8 | 282, | Asp to Trp |
| | | | | | CGG to TGG | |
| Clear cell carcinoma | High | 3C | Lt ovary | 6 | 213, | Arg to Arg |
| | | | | | CGA to CGG | |
| | | | | 7 | 245, | Gly to Asp |
| | | | | | GGC to GAC | |
| | | | p53 mutation in | | | |
| | | | extrapelvic implants | | | |
| | | | Extrapelvic | | | Amino acid |
| Histological type | Grade | Stage | site | Exon | Codon | change |
| Serous adenocarcinoma | High | 3C | Omentum | WT | WT | WT |
| Serous adenocarcinoma | High | 4 | | 6 | 220, | Tyr to Cys |
| | | | | | TAT to TGT | |
| | | | | 7 | 225, | Val to Val |
| | | | | | GTT to GTG | |
| Serous adenocarcinoma | High | 3C | Omentum | WT | WT | WT |
| Serous adenocarcinoma | High | 3C | Soft tissue, | 8 | 294, | Glu to STOP |
| | | | pelvis | | GAG to TAG | |
| Serous adenocarcinoma | High | 3C | Omentum | WT | WT | WT |
| Adenocarcinoma with | High | 4 | Omentum | WT | WT | WT |
| papillary features | | | | | | |
| Adenocarcinoma with | High | 3C | Omentum | 7 | 248, | Arg to Gln |
| papillary features | | | | | CGG to CAG | |
| Serous adenocarcinoma | High | 3C | Omentum | 7 | 248, | Arg to Gln |
| | | | | | CGG to CAG | |
| Serous adenocarcinoma | High | 4 | Colon | WT | WT | WT |
| Adenocarcinoma | High | 3C | Omentum | WT | WT | WT |
| Adenocarcinoma with | Not | 3C | Omentum | WT | WT | WT |
| papillary features | given | | | | | |
| Serous adenocarcinoma | High | 3C | Omentum | WT | WT | WT |
| Adenocarcinoma with | High | 2B | Cul-de-sac | 6 | 220, | Tyr to Cys |
| papillary features | | | | | TAT to TGT | |
| Clear cell carcinoma | High | 3C | Omentum | WT | WT | WT |
| Adenocarcinoma with | High | 3C | Omentum | 7 | 245, | Gly to Asp |
| papillary features | | | | | GGC to GAC | |
| Adenocarcinoma with | High | 3C | Omentum | 7 | 248, | Arg to Gln |
| papillary features | | | | | CGG to CAG | |
| Adenocarcinoma | High | 3C | Colon | WT | WT | WT |
| Serous adenocarcinoma | High | 3C | Omentum | WT | WT | WT |
| Serous adenocarcinoma | High | 3C | Omentum | WT | WT | WT |
| Serous adenocarcinoma | High | 4 | Omentum | WT | WT | WT |
| Adenocarcinoma | High | 2C | Omentum | WT | WT | WT |
| Adenocarcinoma | High | 3C | Omentum | WT | WT | WT |
| Adenocarcinoma with | High | 4 | Omentum | WT | WT | WT |
| papillary features | | | | | | |
| Serous adenocarcinoma | High | 3C | Omentum | 7 | 234, | Tyr to Cys |
| | | | | | TAC to TGC | |
| Serous adenocarcinoma | High | 3C | Omentum | WT | WT | WT |
| Adenocarcinoma | High | 3C | Omentum | 5 | 151, | Pro to frame |
| | | | | | CCC to \check{ }CC | shift |
| Adenocarcinoma | High | 3B | Omentum | WT | WT | WT |
| Serous adenocarcinoma | Moderate | 3C | Soft tissue | WT | WT | WT |
| | | | (periaortic) | | | |
| Serous adenocarcinoma | High | 3C | Omentum | 8 | 282, | Asp to Trp |
| | | | | | CGG to TGG | |
| Clear cell carcinoma | High | 3C | Omentum | 6 | 213, | Arg to Arg |
| | | | | | CGA to CGG | |
| | | | | 7 | 245, | Gly to Asp |
| | | | | | GGC to GAC | |

Pathways Associated with Metastasis Influence Clinical Outcome

Experiments were conducted to identify pathways present in extrapelvic samples that were not present in pelvic samples (termed candidate metastasis pathways [CMPs]). 2 statistical approaches were adopted: comparisons of data grouped together and individual patient-matched samples. Five CMPs demonstrated differential expression using both approaches; that is, they were present in extrapelvic samples but not in pelvic samples when data were compared both in grouped analyses (81 total pathways; Table 12) and in 15 or more of 30 (50%) of the patients for whom individual comparisons were made between matched pelvic and extrapelvic samples (24 pathways total; Table 13).

TABLE 12
Grouped analysis: pathways unique to grouped NOSE vs grouped extrapelvic implants

| | | FDR less | |
|---|---|---|---|
| | Pathway name | than 0.05? | P value |
| 1 | Immune response, immunological synapse formation | Yes | 9.08E−05 |
| 2 | Apoptosis and survival, role of IAP proteins in apoptosis | Yes | 3.69E−04 |
| 3 | Oxidative stress, angiotensin II-induced production of ROS | Yes | 7.31E−04 |
| 4 | Development, mu-type opioid receptor signaling via beta-arrestin | Yes | 8.11E−04 |
| 5 | Development, activation of ERK by kappa-type opioid receptor | Yes | 8.54E−04 |
| 6 | Immune response, histamine signaling in dendritic cells | Yes | 9.43E−04 |
| 7 | Glutathione metabolism/rodent version | No | 3.01E−02 |
| 8 | Signal transduction, JNK pathway | Yes | 1.96E−03 |
| 9 | Immune response, delta-type opioid receptor signaling in T cells | Yes | 1.99E−03 |
| 10 | Immune response, NF-AT signaling and leukocyte interactions | No | 3.15E−03 |
| 11 | Immune response, IL-15 signaling | No | 4.02E−03 |
| 12 | Chemotaxis, inhibitory action of lipoxins on IL-8- and leukotriene B4- | No | 5.31E−03 |
| | induced neutrophil migration | | |
| 13 | Immune response, PGE2 common pathways | No | 5.84E−03 |
| 14 | Immune response, IFN alpha/beta signaling pathway | No | 6.44E−03 |
| 15 | Apoptosis and survival, apoptotic activin A signaling | No | 7.47E−03 |
| 16 | Cytoskeleton remodeling, TGF, WNT and cytoskeletal remodeling | No | 8.71E−03 |
| 17 | Inhibitory action of lipoxins on neutrophil migration | No | 9.13E−03 |
| 18 | Immune response, CCR5 signaling in macrophages and T lymphocytes | No | 9.92E−03 |
| 19 | Immune response, neurotensin-induced activation of IL-8 in | No | 1.02E−02 |
| | colonocytes | | |
| 20 | Neurophysiological process, HTR1A receptor signaling in neuronal | No | 1.02E−02 |
| | cells | | |
| 21 | Regulation of lipid metabolism, G-alpha(q) regulation of lipid | No | 1.08E−02 |
| | metabolism | | |
| 22 | Apoptosis and survival, FAS signaling cascades | No | 1.12E−02 |
| 23 | Development, angiotensin signaling via PYK2 | No | 1.12E−02 |
| 24 | G-protein signaling, RhoB regulation pathway | No | 1.31E−02 |
| 25 | Development, ligand-independent activation of ESR1 and ESR2 | No | 1.36E−02 |
| 26 | Immune response, PGE2 signaling in immune response | No | 1.36E−02 |
| 27 | Development, gastrin in cell growth and proliferation | No | 1.36E−02 |
| 28 | Cell adhesion, chemokines, and adhesion | No | 1.41E−02 |
| 29 | Development, G-CSF-induced myeloid differentiation | No | 1.43E−02 |
| 30 | Development, G proteins mediated regulation MAPK-ERK signaling | No | 1.48E−02 |
| 31 | Transcription, transcription factor Tubby signaling pathways | No | 1.56E−02 |
| 32 | Development, beta-adrenergic receptors regulation of ERK | No | 1.62E−02 |
| 33 | Immune response, Fc gamma R-mediated phagocytosis in macrophages | No | 1.62E−02 |
| 34 | Cell adhesion, integrin-mediated cell adhesion, and migration | No | 1.76E−02 |
| 35 | Signal transduction, ERK1/2 signaling pathway | No | 1.79E−02 |
| 36 | Development, A3 receptor signaling | No | 1.91E−02 |
| 37 | Development, G-CSF signaling | No | 1.91E−02 |
| 38 | Development, angiotensin activation of ERK | No | 1.98E−02 |
| 39 | Apoptosis and survival, caspase cascade | No | 1.98E−02 |
| 40 | Cell adhesion, IL-8-dependent cell migration and adhesion | No | 1.98E−02 |
| 41 | Neurophysiological process, corticoliberin signaling via CRHR1 | No | 2.07E−02 |
| 42 | Protein folding, membrane trafficking, and signal transduction of G- | No | 2.11E−02 |
| | alpha (i) heterotrimeric G protein | | |
| 43 | G protein signaling, G protein beta/gamma signaling cascades | No | 2.19E−02 |
| 44 | Immune response, role of the membrane attack complex in cell survival | No | 2.19E−02 |
| 45 | G protein signaling, G protein alpha-q signaling cascades | No | 2.19E−02 |
| 46 | Signal transduction, activation of PKC via G protein coupled receptor | No | 2.41E−02 |
| 47 | Development, FGF family signaling | No | 2.41E−02 |
| 48 | G protein signaling, proinsulin C-peptide signaling | No | 2.41E−02 |
| 49 | Immune response, antiviral actions of interferons | No | 2.41E−02 |
| 50 | Development, EPO-induced Jak-STAT pathway | No | 2.42E−02 |
| 51 | Immune response, inflammasome in inflammatory response | No | 2.42E−02 |
| 52 | Immune response, oncostatin M signaling via MAPK in mouse cells | No | 2.42E−02 |
| 53 | G protein signaling, S1P2 receptor signaling | No | 2.42E−02 |
| 54 | Cell cycle, influence of Ras and Rho proteins on G1/S transition | No | 2.60E−02 |
| 55 | Immune response, IL-9 signaling pathway | No | 2.65E−02 |
| 56 | G protein signaling, Rac2 regulation pathway | No | 2.65E−02 |
| 57 | Immune response, TLR signaling pathways | No | 2.79E−02 |
| 58 | Immune response, oncostatin M signaling via MAPK in human cells | No | 2.90E−02 |
| 59 | Development, S1P4 receptor signaling pathway | No | 3.13E−02 |
| 60 | Immune response, MIF-mediated glucocorticoid regulation | No | 3.13E−02 |
| 61 | Immune response, role of integrins in NK cells cytotoxicity | No | 3.16E−02 |
| 62 | Immune response, human NKG2D signaling | No | 3.16E−02 |
| 63 | Cell adhesion, integrin inside-out signaling | No | 3.20E−02 |
| 64 | G protein signaling, regulation of p38 and JNK signaling mediated by G | No | 3.44E−02 |
| | proteins | | |
| 65 | Apoptosis and survival, ceramide signaling pathway | No | 3.73E−02 |
| 66 | Immune response, Th1 and Th2 cell differentiation | No | 3.73E−02 |
| 67 | Development, dopamine D2 receptor transactivation of EGFR | No | 3.93E−02 |
| 68 | Development, VEGF family signaling | No | 4.04E−02 |
| 69 | Neurophysiological process, NMDA-dependent postsynaptic long-term | No | 4.15E−02 |
| | potentiation in CA1 hippocampal neurons | | |
| 70 | Serotonin modulation of dopamine release in nicotine addiction | No | 4.35E−02 |
| 71 | Apoptosis and survival, lymphotoxin-beta receptor signaling | No | 4.35E−02 |
| 72 | Immune response, murine NKG2D signaling | No | 4.35E−02 |
| 73 | Development, angiotensin signaling via beta-arrestin | No | 4.37E−02 |
| 74 | Development, alpha-2 adrenergic receptor activation of ERK | No | 4.67E−02 |
| 75 | Development, ACM2 and ACM4 activation of ERK | No | 4.68E−02 |
| 76 | Signal transduction, AKT signaling | No | 4.68E−02 |
| 77 | Immune response, IL-7 signaling in B lymphocytes | No | 4.68E−02 |
| 78 | Development, S1P3 receptor signaling pathway | No | 4.68E−02 |
| 79 | Signal transduction, AKT signaling | No | 4.68E−02 |
| 80 | Immune response, HTR2A-induced activation of cPLA2 | No | 4.68E−02 |
| 81 | G protein signaling, Ras family GTPases in kinase cascades (scheme) | No | 4.83E−02 |

ACM, muscarinic acetylcholine receptor; CCR, chemokine receptor; cPLA, cytosolic phospholipase A; CRHR, corticotropin releasing hormone receptor; EGFR, epithelial growth factor receptor; EPO, erythropoietin; ERK, extracellularly regulated kinase; ESR1, estrogen receptor-[alpha] gene; ESR2, estrogen receptor-[beta] gene; FAS, fatty acid synthase; FDR, false discovery rate; FGF, fibroblast growth factor; G-CSF, granulocyte colony-stimulating factor; GTP, guanosine triphosphate; HTR, hydroxytryptane receptor; IAP, integrin-associated protein; IL, interleukin; IFN, interferon; Jak, Janus kinase; JNK, c-Jun N-terminal kinase; MAPK, mitogen-activated protein kinase; MIF, migration inhibitor factor; NF-AT, nuclear factor of activated T cells; NK, natural killer; NMDA, N-methyl-Daspartate; NOSE, normal ovarian surface epithelium; PG, prostaglandin; PKC, protein kinase C; PYK, proline-rich tyrosine kinase; ROS, reactive oxygen species; S1P, sphingosine 1-phosphate; STAT, signal transducer and activator of transcription; VEGF, vascular endothelial growth factor.

TABLE 13
Individual primary pelvic (n = 30) vs extrapelvic implant (n = 30)

| | | Common to |
|---|---|---|
| | Pathway name | number pairs |
| 1 | Cell adhesion, ECM remodeling | 27 |
| 2 | CXC chemokine receptor family | 25 |
| 3 | Cell adhesion, cell matrix glycoconjugates | 23 |
| 4 | Cell adhesion, chemokines and adhesion | 23 |
| 5 | Development, regulation of EMT | 23 |
| 6 | Development, Hedgehog, and PTH signaling pathways | 20 |
| | in bone and cartilage development | |
| 7 | Role of diethylhexyl phthalate and tributyltin in | 20 |
| | fat cell differentiation | |
| 8 | Development, beta-adrenergic receptors signaling | 18 |
| | via cAMP | |
| 9 | Immune response, IL-17 signaling pathways | 18 |
| 10 | Protein folding, membrane trafficking, and signal | 18 |
| | transduction of G-alpha (i) heterotrimeric G protein | |
| 11 | Cardiac hypertrophy, NF-AT signaling in cardiac | 17 |
| | hypertrophy | |
| 12 | Cell adhesion, plasmin signaling | 17 |
| 13 | Development, TGF-betaedependent induction of EMT | 17 |
| | via SMADs | |
| 14 | Development, WNT signaling pathway, part 2 | 17 |
| 15 | Immune response, histamine H1 receptor signaling | 17 |
| | in immune response | |
| 16 | Cytoskeleton remodeling, TGF, WNT, and | 16 |
| | cytoskeletal remodeling | |
| 17 | Development, role of activin A in cell differentiation | 16 |
| | and proliferation | |
| 18 | Development, TGF-betaedependent induction of EMT | 16 |
| | via MAPK | |
| 19 | Immune response, HMGB1/RAGE signaling pathway | 16 |
| 20 | PGE2 pathways in cancer | 16 |
| 21 | Chemotaxis, leukocyte chemotaxis | 15 |
| 22 | Immune response, histamine signaling in dendritic | 15 |
| | cells | |
| 23 | Immune response, MIF-mediated glucocorticoid | 15 |
| | regulation | |
| 24 | Immune response, TLR signaling pathways | 15 |

Pathways are common to more than 15 paired samples. cAMP, cyclic adenosine diphosphate; ECM, extracellular matrix; EMT, epithelial-to-mesenchymal transition; HMGB, high mobility group protein B; IL, interleukin; MAPK, mitogen-activated protein kinase; MIF, migration inhibitor factor; NF-AT, nuclear factor of activated T cells; PG, prostaglandin; PTH, parathyroid hormone; RAGE, receptor for advanced glycation end products; SMAD, phosphorylated mothers against decapentaplegic.

These 5 CMPs included the following: (1) chemokines and cell adhesion (chemokines/cell adhesion pathway), (2) transforming growth factor (TGF)-beta and cytoskeletal remodeling (TGF-WNT/cytoskeleton remodeling pathway), (3) histamine signaling in dendritic cells and immune response (histamine signaling/immune response pathway), (4) Toll-like receptor (TLR) signaling pathways and immune response (TLR pathway), and (5) protein folding, membrane trafficking, and signal transduction of G-alpha (i) heterotrimeric G-protein (G-alpha pathway).

To further explore the validity of these 5 CMPs, each were evaluated in 4 publically available external gene expression datasets from primary or early-stage cancers vs metastatic/advanced or recurrent cancer. Pathways associated with metastatic, advanced-stage, or recurrent disease included the following: (1) TGF-WNT/cytoskeleton remodeling pathway (P<0.0001) and chemokines/cell adhesion pathway (P<0.001) for ovarian cancer (GSE14407); (2) TGF-WNT/cytoskeleton remodeling (P<0.001) for oral cavity (GSE2280); and (3) TGF-WNT/cytoskeleton remodeling (GSE6919; P<0.001), chemokines/cell adhesion (GSE6919; P<0.001), histamine signaling/immune response (GSE6919; P=0.016), TGF-WNT/cytoskeleton remodeling (GSE6919; P<0.001), and chemokines/cell adhesion (GSE6919; P<0.001) for prostate cancer. Based on their representation in the external datasets, TGF-WNT/cytoskeleton remodeling, chemokines/cell adhesion, and histamine signaling/immune response pathways were defined as metastasis pathways from the initial list of 5 CMPs.

To further explore the clinical relevance of the 3 metastasis pathways, associations (log-rank P values) were evaluated between pathway expression (quantified by PCA modeling) and overall survival in 1691 patients from a series of 9 external clinicogenomic datasets. Genes included in the PC1 signature scores for the TGF-WNT/cytoskeleton remodeling, chemokines/cell adhesion, and histamine signaling/immune response pathways are listed in Table 14.

TABLE 14
Genes used for PCA modeling from the TGF-WNT/cytoskeleton
remodeling, chemokines/cell adhesion, and histamine
signaling/immune response pathways.

| | | | | | Histamine- |
|---|---|---|---|---|---|
| TGF-WNT | | | Chemokines | | Dendritic |
| ACTA1 | LRP5 | TSC2 | ACTA1 | HRAS | ADCY1 |
| ACTA2 | MAP2K1 | VAV1 | ACTA2 | IL8 | ADCY2 |
| ACTB | MAP2K2 | VCL | ACTB | ILK | ADCY3 |
| ACTC1 | MAP2K3 | VEGFA | ACTC1 | ITGA11 | ADCY4 |
| ACTG1 | MAP3K11 | VTN | ACTG1 | ITGA3 | ADCY5 |
| ACTG2 | MAP3K7 | WASL | ACTG2 | ITGA6 | ADCY6 |
| ACTN1 | MAPK1 | WIF1 | ACTN1 | ITGA8 | ADCY7 |
| ACTN2 | MAPK11 | WNT1 | ACTN2 | ITGAV | ADCY8 |
| ACTN3 | MAPK12 | WNT10A | ACTN3 | ITGB1 | ADCY9 |
| ACTN4 | MAPK13 | WNT10B | ACTN4 | ITGB4 | CCL2 |
| ACTR2 | MAPK14 | WNT11 | ACTR2 | JUN | CCL5 |
| ACTR3 | MAPK3 | WNT16 | ACTR3 | KDR | CD86 |
| ACTR3B | MDM2 | WNT2 | ACTR3B | LAMA1 | CREB1 |
| AKT1 | MKNK1 | WNT2B | AKT1 | LAMA4 | CREM |
| AKT2 | MMP13 | WNT3 | AKT2 | LAMB1 | MAPK3 |
| AKT3 | MMP7 | WNT3A | AKT3 | LAMC1 | MAPK1 |
| ARPC1A | MTOR | WNT4 | ARPC1A | LEF1 | GNAI1 |
| ARPC1B | MYC | WNT5A | ARPC1B | LIMK1 | GNAI2 |
| ARPC2 | MYL1 | WNT5B | ARPC2 | LIMK2 | GNAI3 |
| ARPC3 | MYL12A | WNT6 | ARPC3 | MAP2K1 | GNAO1 |
| ARPC4 | MYL12B | WNT7A | ARPC4 | MAP2K2 | GNAZ |
| ARPC5 | MYL2 | WNT7B | ARPC5 | MAPK1 | GNA11 |
| AXIN1 | MYL3 | WNT8A | BCAR1 | MAPK3 | GNAQ |
| AXIN2 | MYL4 | WNT8B | BRAF | MMP1 | GNAS |
| BCAR1 | MYL5 | WNT9A | CAV1 | MMP13 | GNB1 |
| CASP9 | MYL6 | WNT9B | CAV2 | MMP2 | GNB2 |
| CAV1 | MYL6B | XIAP | CCL2 | MSN | GNB3 |
| CCND1 | MYL7 | ZFYVE9 | CCR1 | MYC | GNB4 |
| CDC42 | MYL9 | | CD44 | NFKB1 | GNB5 |
| CDKN1A | MYLK | | CD47 | NFKB2 | GNG10 |
| CDKN2B | MYLK2 | | CDC42 | PAK1 | GNG11 |
| CFL1 | MYLK3 | | CFL1 | PIK3CA | GNG12 |
| CFL2 | MYLPF | | CFL2 | PIK3CB | GNG13 |
| CHUK | NCL | | COL1A1 | PIK3CD | GNG2 |
| COL4A1 | NLK | | COL1A2 | PIK3CG | GNG3 |
| COL4A2 | PAK1 | | COL4A1 | PIK3R1 | GNG4 |
| COL4A3 | PIK3CA | | COL4A2 | PIK3R2 | GNG5 |
| COL4A4 | PIK3CB | | COL4A3 | PIK3R3 | GNG7 |
| COL4A5 | PIK3CD | | COL4A4 | PIK3R5 | GNG8 |
| COL4A6 | PIK3R1 | | COL4A5 | PIP5K1C | GNGT1 |
| CRK | PIK3R2 | | COL4A6 | PLAT | GNGT2 |
| CSNK2A1 | PIK3R3 | | CRK | PLAU | HRH1 |
| CSNK2A2 | PLAT | | CTNNB1 | PLAUR | HRH2 |
| CSNK2B | PLAU | | CXCL1 | PLG | HRH3 |
| CTNNB1 | PLAUR | | CXCL5 | PTEN | HRH4 |
| DOCK1 | PLG | | CXCL6 | PTK2 | IL1B |
| DSTN | PPARD | | CXCR1 | PXN | IL10 |
| DVL1 | PPP1CB | | CXCR2 | RAC1 | IL12A |
| DVL2 | PPP1R12A | | DBN1 | RAF1 | IL12B |
| DVL3 | PTK2 | | DOCK1 | RAP1A | IL23A |
| EIF4E | PXN | | FLNA | RAP1GAP | IL6 |
| EIF4EBP1 | RAC1 | | FLOT2 | REL | IL8 |
| FN1 | RAF1 | | FN1 | RELA | ITPR1 |
| FOXO3 | RHEB | | GNAI1 | RELB | ITPR2 |
| FRAT1 | RHOA | | GNAI2 | RHOA | ITPR3 |
| FZD1 | ROCK1 | | GNAI3 | ROCK1 | IRF8 |
| FZD10 | ROCK2 | | GNAO1 | ROCK2 | MAP2K1 |
| FZD2 | RPS6KA5 | | GNAZ | SDC2 | MAP2K2 |
| FZD3 | SERPINE1 | | GNB1 | SERPINE1 | CCL3 |
| FZD4 | SERPING1 | | GNB2 | SERPINE2 | CCL4 |
| FZD5 | SHC1 | | GNB3 | SHC1 | NFATC2 |
| FZD6 | SMAD2 | | GNB4 | SOS1 | NFATC1 |
| FZD7 | SMAD3 | | GNB5 | SOS2 | PRKACA |
| FZD8 | SOS1 | | GNG10 | SRC | PRKACB |
| FZD9 | SOS2 | | GNG11 | TCF7 | PRKACG |
| GRB2 | SP1 | | GNG12 | TCF7L1 | PRKAR1A |
| GSK3B | SRC | | GNG13 | TCF7L2 | PRKAR1B |
| HRAS | TAB1 | | GNG2 | THBS1 | PRKAR2A |
| ILK | TCF7 | | GNG3 | TLN1 | PRKAR2B |
| JUN | TCF7L1 | | GNG4 | TLN2 | PRKCA |
| KDR | TCF7L2 | | GNG5 | TRIO | PLCB1 |
| LAMA1 | TGFB1 | | GNG7 | VAV1 | PLCB2 |
| LAMB1 | TGFBR1 | | GNG8 | VCL | PLCB3 |
| LAMC1 | TGFBR2 | | GNGT1 | VEGFA | PLCB4 |
| LEF1 | TLN1 | | GNGT2 | VTN | RELA |
| LIMK1 | TLN2 | | GRB2 | WASL | TNF |
| LIMK2 | TP53 | | GSK3B | ZYX | RAF1 |

TABLE 15
Grouped NOSE expression data compared with
grouped extrapelvic implant expression data

| probe set id | geneName | | direction |
|---|---|---|---|
| merck2-NM_001013631_x_at | HNRNPCL1 | | down |
| merck-CR600442_x_at | HMGB1 | | down |
| merck-ENST00000361494_x_at | hCG_22804 | | down |
| merck2-BC051276_a_at | SFRS3 | | down |
| merck2-AK223241_at | 7-Sep | | down |
| merck-BC007887_at | PGM5P2 | | down |
| merck-BC013923_a_at | SOX2 | | down |
| merck-ENST00000342143_a_at | SFRS3 | | down |
| merck2-BP213746_at | TMEM165 | | down |
| merck-NM_005594_s_at | NACA | | down |
| merck2-ENST00000253490_at | FAM153B | | down |
| merck-XM_930195_x_at | hCG_18290 | | down |
| merck2-AJ890082_at | HSP90AA1 | | down |
| merck-NM_013269_x_at | CLEC2D | | down |
| merck-ENST00000273666_at | STXBP5L | | down |
| merck2-AA025385_x_at | RPL23 | | down |
| merck2-DA736876_at | FXYD6 | | down |
| merck2-AJ890082_x_at | HSP90AA1 | | down |
| merck2-DB236550_at | EEF1A1 | | down |
| merck-L18960_s_at | EIF1AX | | down |
| merck-BC085006_x_at | EMID2 | | down |
| merck-XM_941738_x_at | hCG_1992539 | | down |
| merck2-NM_005602.3_at | CLDN11 | | down |
| merck-NM_001004738_at | OR5L1 | | down |
| merck-NM_001427_at | EN2 | | down |
| merck-NM_174889_at | NDUFAF2 | | down |
| merck-BC022082_at | C8orf68 | | down |
| merck-ENST00000358870_s_at | ANKRD20B | | down |
| merck2-NM_001077358_at | PDE11A | | down |
| merck2-NM_001090027_x_at | hCG_18290 | | down |
| merck-XM_930633_x_at | hCG_39912 | | down |
| merck-BG501012_at | NUDT22 | | down |
| merck-ENST00000318825_s_at | AAK1 | | down |
| merck-NM_031157_x_at | HNRNPA1 | | down |
| merck-NM_020697_s_at | KCNS2 | | down |
| merck-AF305825_at | GLYAT | | down |
| merck-DB201122_at | STK33 | | down |
| merck-NM_016188_at | ACTL6B | | down |
| merck2-BM468600_at | PCNP | | down |
| merck-DR002919_at | C3orf58 | | down |
| merck-X96656_s_at | SNORD57 | | down |
| merck-XM_934781_x_at | hCG_2004593 | | down |
| merck-AJ315536_at | LY6G6D | | down |
| merck-NM_001017963_s_at | HSP90AA1 | | down |
| merck-hsa-mir-199a-2_at | MIRN199A2 | | down |
| merck-NM_022658_at | HOXC8 | | down |
| merck2-NM_133464_at | ZNF483 | | down |
| merck2-AA722645_at | SOX2 | | down |
| merck-ENST00000304700_x_at | RPL9 | | down |
| merck-AK025453_a_at | PROX1 | | down |
| merck-NM_138290_a_at | RUNDC3B | | down |
| merck-AK122845_a_at | GABRG1 | | down |
| merck-ENST00000382988_at | RP11-408E5.4 | | down |
| merck-BC027917_s_at | DEFA3 | | down |
| merck2-BI115886_at | HSPG2 | | down |
| merck-AI391567_at | HIC1 | | down |
| merck-NM_177980_s_at | CDH26 | | down |
| merck-AF170294_x_at | PTMAP7 | | down |
| merck2-N29174_at | DIMT1L | | down |
| merck-H67948_s_at | ZNF335 | | down |
| merck2-CR626168_at | RWDD4A | | down |
| merck2-NM_199425_at | VSX1 | | down |
| merck-AK094250_at | WIPF3 | | down |
| merck-ENST00000334363_s_at | TXNRD2 | | down |
| merck-NM_032144_s_at | RAB6C | | down |
| merck-NM_001018069_at | SERBP1 | | down |
| merck-AL133024_a_at | MYT1L | | down |
| merck-DA812943_at | ING1 | | down |
| merck-BC096084_a_at | BMP6 | | down |
| merck-NM_080746_at | RPL10L | | down |
| merck-ENST00000362017_at | C1orf68 | | down |
| merck-BC101970_s_at | SERF1B | | down |
| merck2-CB054424_at | C1QL1 | | down |
| merck2-NM_152460_at | C17orf77 | | down |
| merck-NM_053002_at | MED12L | | down |
| merck2-AI968309_at | ANKRD55 | | down |
| merck2-NM_025013_x_at | ZC3H7B | | down |
| merck-ENST00000373592_at | ECEL1P2 | | down |
| merck-BC035157_s_at | ATRNL1 | | down |
| merck-AB002438_at | SEMA6A | | down |
| merck2-AK002147_at | COMMD10 | | down |
| merck-NM_000870_at | HTR4 | | down |
| merck-ENST00000367877_at | FMO9P | | down |
| merck2-DB066901_at | NUDT4 | | down |
| merck-NM_005556_s_at | KRT7 | | up |
| merck2-BC018764_at | KIAA1217 | | up |
| merck-NM_032323_at | TMEM79 | | up |
| merck-NM_139204_s_at | EPS8L1 | | up |
| merck2-NM_032405_at | TMPRSS3 | | up |
| merck-NM_032405_at | TMPRSS3 | | up |
| merck2-BM975589_at | KIAA1217 | | up |
| merck2-AI582818_at | SYT17 | | up |
| merck2-ENST00000376317_at | PRICKLE3 | | up |
| merck-NM_024690_at | MUC16 | | up |
| merck-NM_006103_at | WFDC2 | | up |
| merck-NM_014398_at | LAMP3 | | up |
| merck-NM_003044_at | SLC6A12 | | up |
| merck2-CX871277_a_at | QRICH1 | | up |
| merck-NM_014265_at | ADAM28 | | up |
| merck-DA804924_a_at | PTPN1 | | up |
| merck-NM_020805_at | KLHL14 | | up |
| merck-NM_021136_at | RTN1 | | up |
| merck-NM_024626_at | VTCN1 | | up |
| merck-NM_017821_at | RHBDL2 | | up |
| merck2-AK027845_at | ZNF682 | | up |
| merck-NM_004947_at | DOCK3 | | up |
| merck-NM_002423_at | MMP7 | | up |
| merck2-AK075533_at | C1QTNF3 | | up |
| merck-NM_001031615_at | ALDH3B2 | | up |
| merck2-DQ893132_at | MMP7 | | up |
| merck-NM_130446_at | KLHL6 | | up |
| merck-NM_018088_x_at | FAM90A1 | | up |
| merck-NM_177964_at | LYPD6B | | up |
| merck-ENST00000285013_a_at | SLFN13 | | up |
| merck2-NM_032405_a_at | TMPRSS3 | | up |
| merck-NM_006586_at | CNPY3 | | up |
| merck-BC001060_a_at | PAX8 | | up |
| merck-NM_153255_at | MCM9 | | up |
| merck-NM_144505_s_at | KLK8 | | up |
| merck-NM_138804_at | C2orf65 | | up |
| merck-NM_002534_a_at | OAS1 | | up |
| merck-NM_014474_at | SMPDL3B | | up |
| merck2-NM_144507_a_at | KLK8 | | up |
| merck-NM_005447_at | RASSF9 | | up |
| merck-BC050704_s_at | DCDC2 | | up |
| merck-NM_019043_at | APBB1IP | | up |
| merck-ENST00000382056_a_at | C1QTNF3 | | up |
| merck-NM_001013622_at | FAM53A | | up |
| merck-NM_004112_at | FGF11 | | up |
| merck-NM_153338_at | GGT6 | | up |
| merck-NM_005560_s_at | LAMA5 | | up |
| merck-NM_002885_at | RAP1GAP | | up |
| merck-NM_000804_at | FOLR3 | | up |
| merck2-AI695443_at | LPCAT3 | | up |
| merck-CD359695_a_at | ATRN | | up |
| merck-NM_172341_at | PSENEN | | up |
| merck2-AL570385_at | ELL | | up |
| merck-NM_172374_at | IL4I1 | | up |
| merck-NM_001692_at | ATP6V1B1 | | up |
| merck2-NM_198586_at | NHLRC1 | | up |
| merck-NM_000493_at | COL10A1 | | up |
| merck-AK055763_a_at | RASSF4 | | up |
| merck-NM_003480_at | MFAP5 | | up |
| merck-NM_013992_at | PAX8 | | up |
| merck2-AF109683_a_at | LAIR1 | | up |
| merck2-AL531282_at | NUCB1 | | up |
| merck-NM_000616_at | CD4 | | up |
| merck-NM_199161_s_at | SAA1 | | up |
| merck-NM_013404_at | MSLN | | up |
| merck2-NM_031460_at | KCNK17 | | up |
| merck-AW016260_s_at | SLC2A9 | | up |
| merck-NM_005046_s_at | KLK7 | | up |
| merck-NM_033635_at | SCAND2 | | up |
| merck-U52696_a_at | ATF6B | | up |
| merck-NM_001852_at | COL9A2 | | up |
| merck-NM_152517_s_at | TTC30B | | up |
| merck2-BQ188534_at | MTF1 | | up |
| merck-DB058745_a_at | SMARCA4 | | up |
| merck2-NM_172208_at | TAPBP | | up |
| merck-NM_016725_s_at | FOLR1 | | up |
| merck2-AI813450_at | CDH6 | | up |
| merck-AK056597_s_at | OTUD4 | | up |
| merck2-BU676864_at | KIAA0226 | | up |
| merck2-NM_001009568_at | SMPDL3B | | up |
| merck-NM_024508_at | ZBED2 | | up |
| merck-NM_198586_at | NHLRC1 | | up |
| merck-NM_174959_s_at | SVOPL | | up |
| merck-NM_001024941_at | TRIM17 | | up |
| merck-NM_005940_s_at | MMP11 | | up |
| merck2-NM_024022_at | TMPRSS3 | | up |
| merck-CR602026_a_at | ZNRF1 | | up |
| merck-NM_000540_at | RYR1 | | up |
| merck-AB051390_a_at | SPON1 | | up |
| merck2-NM_013372_at | GREM1 | | up |
| merck-NM_001005336_s_at | DNM1 | | up |
| merck-NM_005668_at | ST8SIA4 | | up |
| merck2-XM_209144_a_at | LYPD5 | | up |
| merck-NM_006509_at | RELB | | up |
| merck-NM_000379_s_at | XDH | | up |
| merck2-AK095290_at | CP | | up |
| merck-NM_022162_at | NOD2 | | up |
| merck-NM_017450_at | BAIAP2 | | up |
| merck2-NM_005060_at | RORC | | up |
| merck-NM_032383_at | HPS3 | | up |
| merck2-NM_024592_at | SRD5A3 | | up |
| merck2-F10838_at | PRR4 | | up |
| merck2-BQ217998_a_at | ANKLE2 | | up |
| merck-CB529328_s_at | GBP4 | | up |
| merck-NM_206818_s_at | OSCAR | | up |
| merck2-AK125566_at | FAM53A | | up |
| merck2-AL534327_at | BCAM | | up |
| merck-NM_052813_s_at | CARD9 | | up |
| merck2-AK025905_at | SOX17 | | up |
| merck-BC049195_a_at | ELL | | up |
| merck-NM_032534_at | KRBA1 | | up |
| merck2-BU608654_at | ATP6V1B1 | | up |
| merck2-DA404651_at | ZNF490 | | up |
| merck2-XM_092778_at | TTLL9 | | up |
| merck-NM_005951_x_at | MT1H | | up |
| merck-NM_000941_at | POR | | up |
| merck-NM_003041_at | SLC5A2 | | up |
| merck-DA736753_a_at | BAT2D1 | | up |
| merck-NM_031310_at | PLVAP | | up |
| merck-XM_945048_s_at | C1orf186 | | up |
| merck2-NM_014395_at | DAPP1 | | up |
| merck2-NM_005409_at | CXCL11 | | up |
| merck-NM_001039477_s_at | C1orf38 | | up |
| merck2-BE676460_at | C11orf80 | | up |
| merck-NM_001878_at | CRABP2 | | up |
| merck-ENST00000373692_a_at | PTGS1 | | up |
| merck2-BC029840_at | PTGS1 | | up |
| merck-NM_080669_a_at | SLC46A1 | | up |
| merck-AB209742_at | PARP9 | | up |
| merck2-DA944610_at | ACOX1 | | up |
| merck2-U04343_at | CD86 | | up |
| merck-NM_020370_at | GPR84 | | up |
| merck-BC003072_at | RET | | up |
| merck2-CR983377_at | ZFR | | up |
| merck2-DA944610_x_at | ACOX1 | | up |
| merck-BX365476_s_at | TMPRSS3 | | up |
| merck-NM_000734_at | CD247 | | up |
| merck2-AK223068_at | SECTM1 | | up |
| merck-NM_000424_at | KRT5 | | up |
| merck-ENST00000354705_a_at | PTPRF | | up |
| merck-NM_144657_at | HDX | | up |
| merck-AK056035_a_at | SMG7 | | up |
| merck-CA776036_s_at | EWSR1 | | up |
| merck-BC000801_at | CFLAR | | up |
| merck2-M19922_at | FBP1 | | up |
| merck-NM_024501_at | HOXD1 | | up |
| merck-NM_024817_at | THSD4 | | up |
| merck-NM_001018072_at | BTBD11 | | up |
| merck-NM_001572_at | IRF7 | | up |
| merck-NM_001012642_at | GRAMD2 | | up |
| merck-NM_004712_at | HGS | | up |
| merck2-NM_016816_at | OAS1 | | up |
| merck-NM_001039659_s_at | IL18BP | | up |
| merck-NM_022054_at | KCNK13 | | up |
| merck-DB370515_s_at | ADD2 | | up |
| merck-NM_004950_at | EPYC | | up |
| merck-AL832920_a_at | KIAA1618 | | up |
| merck-NM_000096_s_at | CP | | up |
| merck-NM_201630_at | LRRN2 | | up |
| merck-AK056725_s_at | ACVRL1 | | up |
| merck2-NM_017670_at | OTUB1 | | up |
| merck-NM_015645_at | C1QTNF5 | | up |
| merck-NM_173660_at | DOK7 | | up |
| merck-NM_024572_s_at | GALNT14 | | up |
| merck-NM_001517_s_at | GTF2H4 | | up |
| merck-NM_173831_s_at | ZNF707 | | up |
| merck-NM_145313_at | RASGEF1A | | up |
| merck-NM_004204_at | PIGQ | | up |
| merck-BX416440_a_at | CLSTN1 | | up |
| merck2-NM_182573_at | LYPD5 | | up |
| merck-NM_001017403_at | LGR6 | | up |
| merck-NM_016523_at | KLRF1 | | up |
| merck-NR_002598_x_at | SNORD87 | | up |
| merck-BC110351_a_at | KCNAB2 | | up |
| merck-NM_152455_a_at | ZSCAN29 | | up |
| merck-NM_016932_at | SIX2 | | up |
| merck-ENST00000297255_a_at | SLC2A4RG | | up |
| merck-AX746945_at | ZFP62 | | up |
| merck-BC025758_a_at | C2orf60 | | up |
| merck-NM_001025598_at | ARHGAP30 | | up |
| merck-NM_001040195_at | AGTRAP | | up |
| merck-NM_002341_a_at | LTB | | up |
| merck2-X89426_at | ESM1 | | up |
| merck-NM_002336_a_at | LRP6 | | up |
| merck-NM_022750_s_at | PARP12 | | up |
| merck-R16349_a_at | ZNF229 | | up |
| merck-AK095741_a_at | GREM1 | | up |
| merck2-BC013183_at | HLA-DOA | | up |
| merck-NM_144654_s_at | C9orf116 | | up |
| merck-NM_002416_at | CXCL9 | | up |
| merck-NM_005409_at | CXCL11 | | up |
| merck2-NM_000483_at | APOC2 | | up |
| merck2-BM749573_at | NUCKS1 | | up |
| merck2-AK074669_at | SLAMF8 | | up |
| merck-ENST00000379821_a_at | ST8SIA4 | | up |
| merck-NM_004669_s_at | CLIC3 | | up |
| merck-NM_002155_a_at | HSPA6 | | up |
| merck-AK222903_a_at | EPS8L2 | | up |
| merck-NM_031430_at | RILP | | up |
| merck-NM_017923_a_at | | 1-Mar | up |
| merck-NM_015964_at | TPPP3 | | up |
| merck-NM_020791_at | TAOK1 | | up |
| merck-NM_015687_at | FILIP1 | | up |
| merck-BY794952_s_at | TBCCD1 | | up |
| merck-NM_024898_s_at | DENND1C | | up |
| merck-NM_017777_at | MKS1 | | up |
| merck2-L32185_at | SLC11A1 | | up |
| merck-BC000585_s_at | SLCO3A1 | | up |
| merck2-BM922028_at | NLRC5 | | up |
| merck2-CB321657_at | CP | | up |
| merck-AI911220_s_at | SNTB2 | | up |
| merck-NM_001037333_at | CYFIP2 | | up |
| merck-AF013249_a_at | LAIR1 | | up |
| merck2-AF137334_at | ADAM28 | | up |
| merck-NM_153380_at | ZNF41 | | up |
| merck-NM_001040118_at | ARAP1 | | up |
| merck-ENST00000379284_at | GFOD1 | | up |
| merck-BM549103_a_at | RUFY1 | | up |
| merck-AA588208_x_at | FAM91A2 | | up |
| merck-NM_002996_at | CX3CL1 | | up |
| merck-NM_020386_at | HRASLS | | up |
| merck2-BC016799_at | WDR52 | | up |
| merck-AK127015_at | ZNF682 | | up |
| merck-X99662_x_at | SH3GLP3 | | up |
| merck-NM_001040002_s_at | MEOX1 | | up |
| merck-NM_022367_at | SEMA4A | | up |
| merck-NM_001038707_at | CDC42SE1 | | up |
| merck-CR984784_s_at | LPAR5 | | up |
| merck-NM_152586_s_at | USP54 | | up |
| merck-NM_022047_at | DEF6 | | up |
| merck2-AK090924_at | COL8A2 | | up |
| merck-NM_007079_at | PTP4A3 | | up |
| merck-NM_031913_at | FAM62C | | up |
| merck-AF533017_a_at | DUSP18 | | up |
| merck-XM_374817_s_at | FAM22B | | up |
| merck-AY346375_a_at | ZNF562 | | up |
| merck2-AA378704_x_at | THRAP3 | | up |
| merck2-U07225_at | P2RY2 | | up |
| merck-AK023772_s_at | THSD4 | | up |
| merck-NM_002661_at | PLCG2 | | up |
| merck-NM_030630_s_at | C17orf28 | | up |
| merck-NM_178033_at | CYP4X1 | | up |
| merck-NM_030758_at | OSBP2 | | up |
| merck-AL832845_at | LRRC55 | | up |
| merck-NM_005581_at | BCAM | | up |
| merck-NM_001007253_s_at | ERV3 | | up |
| merck-CV815243_at | KIAA1217 | | up |
| merck-NM_032836_at | FIZ1 | | up |
| merck-AK074030_a_at | RNF213 | | up |
| merck-T86498_a_at | ZNF490 | | up |
| merck-NM_173557_at | RNF152 | | up |
| merck-NM_022454_at | SOX17 | | up |
| merck2-BI597924_at | C13orf15 | | up |
| merck-NM_030818_s_at | CCDC130 | | up |
| merck-NM_152658_s_at | THAP8 | | up |
| merck2-AA902118_at | ICA1 | | up |
| merck-BC063568_a_at | UPK1B | | up |
| merck-NM_152709_at | STOX1 | | up |
| merck-NM_032819_at | ZNF341 | | up |
| merck-NM_001007544_at | C1orf186 | | up |
| merck-NM_001567_s_at | INPPL1 | | up |
| merck2-ENST00000329309_x_at | PSPH | | up |
| merck-NM_023072_at | ZSWIM4 | | up |
| merck-XM_044166_at | MEX3A | | up |
| merck2-BC009489_a_at | | 9-Mar | up |
| merck2-BQ441731_at | C10orf57 | | up |
| merck-NM_002121_a_at | HLA-DPB1 | | up |
| merck-NM_002740_s_at | PRKCI | | up |
| merck2-ENST00000373857_at | PTAFR | | up |
| merck-AK056667_a_at | NSD1 | | up |
| merck-BC018000_a_at | PUS7L | | up |
| merck-NM_000121_a_at | EPOR | | up |
| merck-NM_018990_at | SASH3 | | up |
| merck-AK123810_at | LCA5L | | up |
| merck2-AK056742_at | WNT2 | | up |
| merck-NM_000889_at | ITGB7 | | up |
| merck-AK090439_s_at | NLRC5 | | up |
| merck-NM_030974_at | SHARPIN | | up |
| merck2-BQ441731_x_at | C10orf57 | | up |
| merck-NM_153256_at | C10orf47 | | up |
| merck-ENST00000024061_at | SLC45A4 | | up |
| merck-AV727105_a_at | CD47 | | up |
| merck-NM_002673_at | PLXNB1 | | up |
| merck-NM_012252_at | TFEC | | up |
| merck2-AK023066_a_at | CNNM2 | | up |
| merck2-BQ934363_at | AKAP13 | | up |
| merck-NM_002030_s_at | FPR3 | | up |
| merck-NM_021163_at | RBAK | | up |
| merck-NM_006795_at | EHD1 | | up |
| merck-NM_000246_a_at | CIITA | | up |
| merck2-AY358143_at | THSD4 | | up |
| merck-NM_001242_at | CD27 | | up |
| merck-NM_004072_at | CMKLR1 | | up |
| merck-NM_031303_at | KATNAL2 | | up |
| merck2-ENST00000377918_at | PCDH17 | | up |
| merck-NM_017514_at | PLXNA3 | | up |
| merck-NM_173527_at | REM2 | | up |
| merck-BC071862_at | JRK | | up |
| merck-CD367611_x_at | CFLAR | | up |
| merck2-NM_133169_a_at | OSCAR | | up |
| merck-NM_018009_at | TAPBPL | | up |
| merck-BC049838_a_at | PDCD11 | | up |
| merck-DA711453_s_at | BRD9 | | up |
| merck-NM_001002235_s_at | SERPINA1 | | up |
| merck-BC056142_at | NFE2L3 | | up |
| merck2-BM975589_a_at | KIAA1217 | | up |
| merck-NM_152600_at | ZNF579 | | up |
| merck-NM_001665_at | RHOG | | up |
| merck-BQ061913_a_at | UBE3B | | up |
| merck2-AF318331_a_at | EPS8L2 | | up |
| merck-BG699859_s_at | RHOF | | up |
| merck-NM_003978_at | PSTPIP1 | | up |
| merck2-BU601868_at | C2orf60 | | up |
| merck2-CD642566_at | NKTR | | up |
| merck2-AI332306_at | MEX3D | | up |
| merck2-NM_000698_at | ALOX5 | | up |
| merck-NM_000206_at | IL2RG | | up |
| merck-NM_000063_a_at | C2 | | up |
| merck2-AW438675_at | UQCRC2 | | up |
| merck-NM_021195_at | CLDN6 | | up |
| merck-ENST00000375217_a_at | UBR4 | | up |
| merck-NM_022455_at | NSD1 | | up |
| merck-NM_001008409_s_at | TTLL9 | | up |
| merck-CR620615_s_at | ZNF276 | | up |
| merck2-NM_000424_at | KRT5 | | up |
| merck-AF186252_a_at | SULT1C2 | | up |
| merck-NM_020205_a_at | OTUD7B | | up |
| merck-BX537522_at | ENTPD1 | | up |
| merck-ENST00000261758_at | MESDC2 | | up |
| merck-NM_017949_s_at | CUEDC1 | | up |
| merck-NM_006747_at | SIPA1 | | up |
| merck2-BF062856_at | PCGF3 | | up |
| merck2-NM_001031801_at | LIMK2 | | up |
| merck-NM_145013_at | C11orf45 | | up |
| merck-AK223243_a_at | SDC4 | | up |
| merck-NM_004378_at | CRABP1 | | up |
| merck-L25259_s_at | CD86 | | up |
| merck-BC034949_a_at | EMR2 | | up |
| merck-NM_022369_s_at | STRA6 | | up |
| merck-NM_138499_s_at | PWWP2B | | up |
| merck-NM_001014986_s_at | FOLH1 | | up |
| merck2-AW131251_at | HSPA6 | | up |
| merck-BC065717_a_at | VTCN1 | | up |
| merck-NM_001039382_at | C8orf77 | | up |
| merck-NM_173530_at | ZNF610 | | up |
| merck-AB208946_a_at | ALOX5 | | up |
| merck-AL832285_s_at | GBP5 | | up |
| merck-AA489463_a_at | SLIT2 | | up |
| merck-NM_003727_at | DNAH17 | | up |
| merck-NM_181484_s_at | ZGPAT | | up |
| merck-NM_022107_a_at | GPSM3 | | up |
| merck-NM_020832_at | ZNF687 | | up |
| merck-NM_207354_at | ANKRD13D | | up |
| merck-NM_001039575_s_at | NSUN5B | | up |
| merck2-NM_002535_at | OAS2 | | up |
| merck-NM_015507_at | EGFL6 | | up |
| merck2-AA278673_at | TLR7 | | up |
| merck2-BX647274_at | CDK3 | | up |
| merck-BM545167_s_at | GNMT | | up |
| merck-NM_001125_at | ADPRH | | up |
| merck2-N98426_x_at | C1orf56 | | up |
| merck2-AI949164_at | EPB41L4A | | up |
| merck-ENST00000256367_at | TTC9 | | up |
| merck2-BF220289_at | GRN | | up |
| merck2-NM_005554_at | KRT6A | | up |
| merck-ENST00000185206_a_at | CLIC5 | | up |
| merck2-DR980584_x_at | C9orf129 | | up |
| merck2-BC104753_at | NFATC1 | | up |
| merck-NM_004220_s_at | ZNF213 | | up |
| merck2-BC009721_at | CLEC16A | | up |
| merck2-BG741360_at | KIAA0317 | | up |
| merck-NM_032265_at | ZMYND15 | | up |
| merck-NM_002120_at | HLA-DOB | | up |
| merck-CN429612_a_at | AMOT | | up |
| merck2-NM_016931_at | NOX4 | | up |
| merck2-NM_206818_a_at | OSCAR | | up |
| merck-AK094136_a_at | ZNF827 | | up |
| merck2-BC043612_at | ZSCAN29 | | up |
| merck-NM_033015_s_at | FASTK | | up |
| merck-BC065279_a_at | IWS1 | | up |
| merck-NM_000095_s_at | COMP | | up |
| merck2-BC034321_at | ALDH5A1 | | up |
| merck-NM_005612_s_at | REST | | up |
| merck-NM_001248_at | ENTPD3 | | up |
| merck-BC032361_a_at | KIAA0040 | | up |
| merck-CR974666_a_at | C4orf8 | | up |
| merck2-DA167870_at | ST8SIA4 | | up |
| merck2-AI654093_a_at | FUT8 | | up |
| merck-BM980789_s_at | LAMC2 | | up |
| merck2-NM_001080496_at | RGP1 | | up |
| merck-NM_001033046_at | C17orf62 | | up |
| merck-NM_004715_at | CTDP1 | | up |
| merck2-BX117586_at | YPEL1 | | up |
| merck-ENST00000344771_at | SRCAP | | up |
| merck-BC064360_a_at | FBXL11 | | up |
| merck2-DB166146_at | LRRFIP1 | | up |
| merck-NM_001001575_s_at | PDE9A | | up |
| merck-ENST00000343933_at | CORO2A | | up |
| merck-NM_022141_at | PARVG | | up |
| merck-NM_003120_at | SPI1 | | up |
| merck-NM_025080_s_at | ASRGL1 | | up |
| merck-NM_000952_at | PTAFR | | up |
| merck-BC008046_at | FBXO46 | | up |
| merck-NM_004032_at | DDO | | up |
| merck-NM_006419_at | CXCL13 | | up |
| merck-NM_004783_at | TAOK2 | | up |
| merck2-NM_001001290_at | SLC2A9 | | up |
| merck-NM_017594_at | DIRAS2 | | up |
| merck2-NM_021089_at | ZNF8 | | up |
| merck-NM_020649_at | CBX8 | | up |
| merck-NM_001120_at | MFSD10 | | up |
| merck-NM_016558_s_at | SCAND1 | | up |
| merck-NM_001776_s_at | ENTPD1 | | up |
| merck-NM_203304_at | MEX3D | | up |
| merck-NM_032107_s_at | L3MBTL | | up |
| merck-NM_014385_at | SIGLEC7 | | up |
| merck-NM_012335_at | MYO1F | | up |
| merck-NM_006635_s_at | ZNF460 | | up |
| merck-NM_006553_at | SLMO1 | | up |
| merck2-BE676460_x_at | C11orf80 | | up |
| merck-AU151088_s_at | CDH6 | | up |
| merck2-BX647968_at | ENPP5 | | up |
| merck-N78414_a_at | PCDH17 | | up |
| merck-BC048303_a_at | YPEL1 | | up |
| merck-NM_032792_at | ZBTB45 | | up |
| merck2-BC018532_at | FAM129A | | up |
| merck2-NM_006615_at | CAPN9 | | up |
| merck2-NM_022572_a_at | PNKD | | up |
| merck-NM_001040003_s_at | NCF1 | | up |
| merck2-BU158667_a_at | TTC7A | | up |
| merck-NM_016428_at | ABI3 | | up |
| merck2-BC051719_a_at | B3GALT6 | | up |
| merck2-X74818_at | AHNAK | | up |
| merck-NM_005341_at | ZBTB48 | | up |
| merck-NM_006725_at | CD6 | | up |
| merck2-Z29328_a_at | UBE2H | | up |
| merck-NM_080591_s_at | PTGS1 | | up |
| merck-BC047782_at | CDK3 | | up |
| merck-AK127884_s_at | ZBTB7B | | up |
| merck-NM_005337_at | NCKAP1L | | up |
| merck-NM_014002_at | IKBKE | | up |
| merck-AL560976_at | TMEM127 | | up |
| merck-BC046218_a_at | TNRC6B | | up |
| merck-NM_006019_s_at | TCIRG1 | | up |
| merck-NM_004416_at | DTX1 | | up |
| merck-NM_015202_at | KIAA0556 | | up |
| merck-ENST00000245530_at | PADI2 | | up |
| merck2-NM_020914_at | RNF213 | | up |
| merck-NM_020461_s_at | TUBGCP6 | | up |
| merck-BC013572_a_at | KRAS | | up |
| merck-NM_018489_a_at | ASH1L | | up |
| merck-AK022734_a_at | KIAA0319L | | up |
| merck-NM_006574_at | CSPG5 | | up |
| merck-ENST00000269336_at | CCDC40 | | up |
| merck-NM_001008701_at | LPHN1 | | up |
| merck-NM_207392_at | KRTDAP | | up |
| merck-NM_024781_at | CCDC102B | | up |
| merck-NM_005044_at | PRKX | | up |
| merck-NM_024893_at | C20orf39 | | up |
| merck2-AK074082_at | RGL3 | | up |
| merck-NM_000569_at | FCGR3A | | up |
| merck-NM_005048_at | PTH2R | | up |
| merck2-NM_015967_at | PTPN22 | | up |
| merck-NM_004321_at | KIF1A | | up |
| merck-AY523970_s_at | TAP1 | | up |
| merck-NM_003764_at | STX11 | | up |
| merck-BU853952_s_at | C19orf2 | | up |
| merck-NM_019100_at | DMAP1 | | up |
| merck2-BC018764_a_at | KIAA1217 | | up |
| merck-AV734165_a_at | RLF | | up |
| merck-NM_022358_at | KCNK15 | | up |
| merck-NM_024070_at | PVRIG | | up |
| merck-BC064906_a_at | KIF1A | | up |
| merck-NM_001023561_at | ZNF749 | | up |
| merck-NM_024042_at | METRN | | up |
| merck-NM_001033678_s_at | TRPT1 | | up |
| merck2-AI638649_at | GALNT12 | | up |
| merck-NM_138330_x_at | ZNF675 | | up |
| merck-AK056696_s_at | ZNF606 | | up |
| merck2-BC017758_at | CYP4B1 | | up |
| merck-BX640973_at | SLC45A3 | | up |
| merck-NM_003862_at | FGF18 | | up |
| merck-ENST00000354353_at | KCNMA1 | | up |
| merck2-AK094636_at | ABCB8 | | up |
| merck2-DB109470_at | NKTR | | up |
| merck-G65633_at | TMEM178 | | up |
| merck-M74447_a_at | TAP2 | | up |
| merck2-ENST00000357769_a_at | THSD4 | | up |
| merck-NM_031924_at | RSPH3 | | up |
| merck2-AY346375_x_at | ZNF562 | | up |
| merck-BC037558_s_at | EPS15L1 | | up |
| merck-AL697853_a_at | CDH6 | | up |
| merck-NM_181724_at | TMEM119 | | up |
| merck-BP224564_a_at | YY1 | | up |
| merck2-AA379112_at | SLAMF8 | | up |
| merck-NM_001004323_at | C7orf61 | | up |
| merck-AK128366_a_at | MGAT4A | | up |
| merck-NM_024706_s_at | ZNF668 | | up |
| merck-NM_001061_at | TEXAS1 | | up |
| merck-ENST00000314566_a_at | AMFR | | up |
| merck-NM_014699_at | ZNF646 | | up |
| merck2-BC065270_a_at | APOC2 | | up |
| merck-NM_014421_at | DKK2 | | up |
| merck2-NM_018438_at | FBXO6 | | up |
| merck-NM_015327_at | SMG5 | | up |
| merck2-AL157446_at | PDPK1 | | up |
| merck-NM_021070_at | LTBP3 | | up |
| merck-BE350121_s_at | CPXM1 | | up |
| merck-ENST00000315425_at | TMEM185B | | up |
| merck-NM_001003940_s_at | BMF | | up |
| merck-NM_000779_at | CYP4B1 | | up |
| merck-NM_003789_at | TRADD | | up |
| merck-BC012924_a_at | DAPP1 | | up |
| merck2-DQ894918_at | TRIM38 | | up |
| merck-AK023131_at | XPR1 | | up |
| merck2-CA308455_at | HLA-DPA1 | | up |
| merck-AK092738_at | PSMB9 | | up |
| merck2-CA423142_a_at | MLLT4 | | up |
| merck2-AY090771_at | NADK | | up |
| merck-NM_001035223_s_at | RGL3 | | up |
| merck-NM_002180_s_at | IGHMBP2 | | up |
| merck-BC020195_s_at | CCDC123 | | up |
| merck-NM_007261_at | CD300A | | up |
| merck-NM_174912_at | FAAH2 | | up |
| merck2-AI933294_at | NDUFV3 | | up |
| merck-NM_023078_at | PYCRL | | up |
| merck2-AB004574_at | DNASE2 | | up |
| merck2-NM_001002235_at | SERPINA1 | | up |
| merck2-CA306000_s_at | GBP1 | | up |
| merck-ENST00000376863_a_at | CLDN10 | | up |
| merck2-BC098388_at | SLIT3 | | up |
| merck-NM_175924_at | ILDR1 | | up |
| merck-NM_198963_at | DHX57 | | up |
| merck2-AF239923_at | RHOF | | up |
| merck-NM_020766_at | PCDH19 | | up |
| merck2-BC030293_at | RHBDD1 | | up |
| merck2-NM_004145_at | MYO9B | | up |
| merck-NM_003782_a_at | B3GALT4 | | up |
| merck2-NM_017565_at | FAM20A | | up |
| merck-NM_021143_at | ZNF20 | | up |
| merck-AK096371_at | TADA2L | | up |
| merck-BX640620_x_at | IGHM | | up |
| merck2-AM182326_at | WDR45L | | up |
| merck-NM_018259_a_at | TTC17 | | up |
| merck-BF222904_a_at | CTTNBP2NL | | up |
| merck-ENST00000356331_s_at | SH3BP2 | | up |
| merck-NM_145307_at | RTKN2 | | up |
| merck2-CD518083_at | PLEKHB1 | | up |
| merck-NM_025257_a_at | SLC44A4 | | up |
| merck2-AK125659_a_at | TLR2 | | up |
| merck-NM_005101_at | ISG15 | | up |
| merck-NM_198282_at | TMEM173 | | up |
| merck-AM055744_at | SNORA45 | | up |
| merck-NM_144686_at | TMC4 | | up |
| merck-NM_020857_at | VPS18 | | up |
| merck2-AI554920_x_at | KRAS | | up |
| merck2-BC033795_at | TTC30B | | up |
| merck2-ENST00000367021_at | IRF6 | | up |
| merck2-DQ893538_at | CCNK | | up |
| merck-BC036797_a_at | ADRBK2 | | up |
| merck-NM_000101_a_at | CYBA | | up |
| merck2-BC130484_at | GUCY1A2 | | up |
| merck2-NM_130771_a_at | OSCAR | | up |
| merck-NM_024083_at | ASPSCR1 | | up |
| merck-NM_012308_at | FBXL11 | | up |
| merck-AK098833_s_at | MIAT | | up |
| merck-NM_002151_at | HPN | | up |
| merck-NM_017582_at | UBE2Q1 | | up |
| merck2-BC126219_at | SAFB | | up |
| merck-AK074341_a_at | RAB11FIP4 | | up |
| merck-NM_021089_at | ZNF8 | | up |
| merck2-NM_014734_at | KIAA0247 | | up |
| merck-NM_014371_s_at | AKAP8L | | up |
| merck-NM_003880_s_at | WISP3 | | up |
| merck-BX103595_at | ITPR2 | | up |
| merck-AA131524_at | SLAMF1 | | up |
| merck-NM_052942_a_at | GBP5 | | up |
| merck-NM_171998_at | RAB39B | | up |
| merck-NM_005148_at | UNC119 | | up |
| merck-NM_000733_at | CD3E | | up |
| merck-BM973820_s_at | SCO2 | | up |
| merck-BM512211_a_at | MSR1 | | up |
| merck2-AK222711_a_at | SMAP1 | | up |
| merck-NM_005135_at | SLC12A6 | | up |
| merck2-DT217746_at | ASRGL1 | | up |
| merck2-BX647344_at | AVIL | | up |
| merck2-AI554920_at | KRAS | | up |
| merck-NM_138413_s_at | C10orf65 | | up |
| merck-NM_002145_at | HOXB2 | | up |
| merck-CB851948_a_at | WDR52 | | up |
| merck-G36759_at | GREM1 | | up |
| merck-NM_000577_s_at | IL1RN | | up |
| merck2-AF088037_at | ARHGEF19 | | up |
| merck2-AF275269_at | NANOS1 | | up |
| merck-BC047016_a_at | FCHSD1 | | up |
| merck-NM_199121_s_at | VWA1 | | up |
| merck-G36510_at | ZNF606 | | up |
| merck-CR610337_at | WNT2 | | up |
| merck-BX362459_a_at | EFHD2 | | up |
| merck-NM_138278_at | BNIPL | | up |
| merck-BC033756_a_at | TLR2 | | up |
| merck-NM_013441_a_at | RCAN3 | | up |
| merck-AI871635_at | PTAFR | | up |
| merck2-NM_015623_a_at | TANC2 | | up |
| merck-BC026930_a_at | TRIM38 | | up |
| merck-NM_004259_s_at | RECQL5 | | up |
| merck-NM_003162_at | STRN | | up |
| merck-NM_177999_at | ASB6 | | up |
| merck-NM_207336_s_at | ZNF467 | | up |
| merck-NM_005244_at | EYA2 | | up |
| merck-NM_006228_at | PNOC | | up |
| merck-NM_152321_at | ERP27 | | up |
| merck2-BM674826_a_at | PAK1 | | up |
| merck2-BF940370_x_at | YY1 | | up |
| merck-NM_001089_at | ABCA3 | | up |
| merck-NM_001004309_at | ZNF774 | | up |
| merck-ENST00000357997_a_at | ANKLE2 | | up |
| merck2-AB265810_at | RNF31 | | up |
| merck-NM_012320_at | PLA2G15 | | up |
| merck2-CB851649_at | EFCAB2 | | up |
| merck2-NM_001100812_a_at | CXCL16 | | up |
| merck-NM_003355_at | UCP2 | | up |
| merck2-DA908268_at | NUB1 | | up |
| merck-NM_002284_at | KRT86 | | up |
| merck-NM_018421_s_at | TBC1D2 | | up |
| merck2-BG680883_at | LAMC2 | | up |
| merck-BC047950_a_at | TTC9 | | up |
| merck-NM_199173_s_at | BGLAP | | up |
| merck-U65533_a_at | UPF1 | | up |
| merck-BC035724_a_at | NAB1 | | up |
| merck-NM_021251_s_at | CAPN10 | | up |
| merck2-BX647929_at | ZNF786 | | up |
| merck-NM_017586_at | C9orf7 | | up |
| merck-NM_021168_at | RAB40C | | up |
| merck2-BC070107_at | SLC12A6 | | up |
| merck2-AA148931_at | FAM124A | | up |
| merck-NM_021990_s_at | GABRE | | up |
| merck2-BM793951_a_at | TTC39A | | up |
| merck-NM_015356_at | SCRIB | | up |
| merck-AK023842_a_at | BAZ2A | | up |
| merck-NM_002111_at | HTT | | up |
| merck-NM_177533_s_at | NUDT14 | | up |
| merck2-BI823414_at | SLC45A4 | | up |
| merck-AY005981_at | | 6-Sep | up |
| merck-NM_138957_at | MAPK1 | | up |
| merck-NM_031498_at | GNGT2 | | up |
| merck-NM_177422_at | EIF2C3 | | up |
| merck2-NM_000487_at | ARSA | | up |
| merck-NM_000483_at | APOC2 | | up |
| merck-NM_005181_at | CA3 | | up |
| merck-NM_032809_s_at | FAM73B | | up |
| merck-NM_004424_at | E4F1 | | up |
| merck-NM_018196_a_at | TMLHE | | up |
| merck2-NM_020630_at | RET | | up |
| merck-NM_024944_s_at | CHODL | | up |
| merck-NM_001191_at | BCL2L1 | | up |
| merck-BE736140_a_at | FBXO18 | | up |
| merck2-AF091091_at | PGLS | | up |
| merck-NM_016524_at | SYT17 | | up |
| merck-NM_001040070_x_at | IGHG1 | | up |
| merck-ENST00000359488_x_at | IGKC | | up |
| merck2-BX439965_at | CARM1 | | up |
| merck2-EL947810_at | DHRS4 | | up |
| merck-NM_024771_at | NAT11 | | up |
| merck-NM_017488_at | ADD2 | | up |
| merck-NM_000578_at | SLC11A1 | | up |
| merck2-CD703280_at | IGKC | | up |
| merck-NM_153345_at | TMEM139 | | up |
| merck-ENST00000335350_at | UNC5B | | up |
| merck-NM_005942_s_at | MOCS1 | | up |
| merck-NM_020410_s_at | ATP13A1 | | up |
| merck2-DA593521_at | DSP | | up |
| merck-NM_004131_at | GZMB | | up |
| merck-NM_000152_at | GAA | | up |
| merck2-NM_005811_at | GDF11 | | up |
| merck-CR597929_a_at | ARFIP2 | | up |
| merck-NM_012240_at | SIRT4 | | up |
| merck2-AI016654_at | TTC9 | | up |
| merck-BI195427_a_at | TP53I3 | | up |
| merck-NM_015488_s_at | PNKD | | up |
| merck-AB014515_a_at | N4BP1 | | up |
| merck2-BC019883_at | CLEC2D | | up |
| merck2-NM_198445_at | RINL | | up |
| merck2-NM_001230_at | CASP10 | | up |
| merck-NM_001112_at | ADARB1 | | up |
| merck-NM_178865_at | SERINC2 | | up |
| merck-NM_020753_s_at | CASKIN2 | | up |
| merck-NM_000594_a_at | TNF | | up |
| merck2-AL049464_at | THSD4 | | up |
| merck-NM_005202_s_at | COL8A2 | | up |
| merck-NM_024493_s_at | ZKSCAN3 | | up |
| merck-NM_000507_at | FBP1 | | up |
| merck-NM_017935_at | BANK1 | | up |
| merck2-NM_000101_at | CYBA | | up |
| merck-NM_015916_at | CALHM2 | | up |
| merck-NM_014146_s_at | LAT2 | | up |
| merck-NM_014347_at | ZNF324 | | up |
| merck-NM_003391_a_at | WNT2 | | up |
| merck-CR622847_a_at | C10orf57 | | up |
| merck2-DA497750_x_at | ZNF33A | | up |
| merck-AW770542_a_at | EIF5B | | up |
| merck2-BX327781_at | MPP7 | | up |
| merck-NM_012152_at | LPAR3 | | up |
| merck-ENST00000317318_a_at | RFX7 | | up |
| merck-AK127358_a_at | RNF213 | | up |
| merck2-AK126729_at | NDRG4 | | up |
| merck-NM_052988_s_at | CDK10 | | up |
| merck2-BG616989_a_at | SERPINA1 | | up |
| merck2-AK125566_x_at | FAM53A | | up |
| merck-NM_033196_a_at | ZNF682 | | up |
| merck-AF068836_a_at | CYTIP | | up |
| merck-AF132599_a_at | KLF13 | | up |
| merck-NM_024554_at | PGBD5 | | up |
| merck2-BG826377_a_at | PREX1 | | up |
| merck2-AL834491_at | FAM59A | | up |
| merck-NM_007046_at | EMILIN1 | | up |
| merck2-BC075858_at | PLEKHG2 | | up |
| merck-NM_080862_at | SPSB4 | | up |
| merck-NM_005630_at | SLCO2A1 | | up |
| merck-ENST00000367555_at | NPL | | up |
| merck2-CR601707_at | AQP5 | | up |
| merck-AF019226_at | RAB3D | | up |
| merck-NM_203434_s_at | IER5L | | up |
| merck-NM_004946_at | DOCK2 | | up |
| merck-NM_015478_at | L3MBTL | | up |
| merck-NM_030895_at | ZNF696 | | up |
| merck-NM_001025604_s_at | ARRDC2 | | up |
| merck2-BX456521_x_at | IKZF2 | | up |
| merck-NM_032532_at | FNDC1 | | up |
| merck-NM_144631_s_at | ZNF513 | | up |
| merck-AF124491_a_at | GIT2 | | up |
| merck-AB208925_s_at | PCDHA4 | | up |
| merck-NM_181050_at | AXIN1 | | up |
| merck-NM_153341_at | RNF19B | | up |
| merck-BM562015_a_at | TBXAS1 | | up |
| merck-NM_001565_at | CXCL10 | | up |
| merck2-AI380393_at | MMS19 | | up |
| merck-NM_033238_at | PML | | up |
| merck-AK094195_a_at | MAP3K12 | | up |
| merck-BX364147_a_at | NADK | | up |
| merck-NM_182647_at | OPRL1 | | up |
| merck-BC035599_at | C2CD3 | | up |
| merck2-AF118887_at | VAV3 | | up |
| merck-NM_003965_s_at | CCRL2 | | up |
| merck2-AK057931_at | RSPH3 | | up |
| merck2-AL133043_at | DCDC2 | | up |
| merck-NM_016151_s_at | TAOK2 | | up |
| merck2-NM_080657_at | RSAD2 | | up |
| merck-NM_005132_at | REC8 | | up |
| merck2-AI431558_x_at | MFI2 | | up |
| merck-BC023558_a_at | SPOCK2 | | up |
| merck-NM_000639_at | FASLG | | up |
| merck2-BQ893829_at | NAGLU | | up |
| merck2-XM_374898_at | PCNXL3 | | up |
| merck-NM_014405_at | CACNG4 | | up |
| merck-AK098385_s_at | RTN4 | | up |
| merck-CR936744_at | HOMER2 | | up |
| merck-BC039860_at | CHD6 | | up |
| merck-NM_024650_at | C11orf80 | | up |
| merck-AF061935_a_at | VPRBP | | up |
| merck2-AL832190_at | COG2 | | up |
| merck2-BI519527_at | IKZF1 | | up |
| merck2-AL515469_s_at | NANS | | up |
| merck-BC065197_at | PUS10 | | up |
| merck2-BC041388_at | ZNF553 | | up |
| merck-NM_03205 l_s_at | PATZ1 | | up |
| merck2-ENST00000368925_at | DDO | | up |
| merck-NM_005892_at | FMNL1 | | up |
| merck-NM_016830_s_at | VAMP1 | | up |
| merck-BU542820_at | GALNT6 | | up |
| merck-CR992676_s_at | ZC3H11A | | up |
| merck-BC050321_a_at | TBC1D1 | | up |
| merck-NM_001039468_s_at | MARK2 | | up |
| merck2-AI971668_a_at | SMAD6 | | up |
| merck-NM_030792_s_at | GDPD5 | | up |
| merck2-BU622650_a_at | BHLHB3 | | up |
| merck-NM_005949_s_at | MT1F | | up |
| merck2-ENST00000366969_at | VASH2 | | up |
| merck-NM_152225_s_at | PPEF1 | | up |
| merck-NM_152511_at | DUSP18 | | up |
| merck-NM_080605_at | B3GALT6 | | up |
| merck2-XM_001133198_x_at | FCGR1A | | up |
| merck-NM_001610_at | ACP2 | | up |
| merck-NM_032782_at | HAVCR2 | | up |
| merck-NM_001004431_at | METRNL | | up |
| merck-AF143684_s_at | MYO9B | | up |
| merck-X96660_s_at | RAB26 | | up |
| merck-NM_024909_a_at | C6orf134 | | up |
| merck-NM_018245_at | OGDHL | | up |
| merck2-BM561748_at | GZMB | | up |
| merck2-ENST00000360922_at | C1orf56 | | up |
| merck-ENST00000361686_at | ST6GAL2 | | up |
| merck-ENST00000355436_at | ZNF252 | | up |
| merck-NM_012427_at | KLK5 | | up |
| merck-BC009714_a_at | RAB39B | | up |
| merck-NM_003834_at | RGS11 | | up |
| merck-NM_002986_s_at | CCL11 | | up |
| merck-BQ420304_a_at | SETD1B | | up |
| merck-NM_015925_at | LSR | | up |
| merck2-AL136709_at | ABI3 | | up |
| merck-NM_178181_a_at | CDCP1 | | up |
| merck-BC094869_x_at | hCG_20426 | | up |
| merck-NM_021209_s_at | NLRC4 | | up |
| merck-NM_019601_at | SUSD2 | | up |
| merck-AX747748_s_at | IGHA1 | | up |
| merck2-AU120661_at | ARHGEF3 | | up |
| merck-NM_003986_at | BBOX1 | | up |
| merck-ENST00000310260_a_at | VANGL1 | | up |
| merck-NM_145214_at | TRIM11 | | up |
| merck-NM_006768_at | BRAP | | up |
| merck2-NM_018986_at | SH3TC1 | | up |
| merck-NM_015568_at | PPP1R16B | | up |
| merck-NM_017636_s_at | TRPM4 | | up |
| merck-AB209400_at | UQCC | | up |
| merck-NM_012396_at | PHLDA3 | | up |
| merck-NM_014807_s_at | C2CD2L | | up |
| merck-NM_207362_at | C2orf55 | | up |
| merck-BC028212_at | PIK3R5 | | up |
| merck-BC033255_x_at | IL8RBP | | up |
| merck-NM_032034_at | SLC4A11 | | up |
| merck-AW072050_a_at | MYO9B | | up |
| merck-BC034402_a_at | RBM47 | | up |
| merck-BC020867_at | SLC6A13 | | up |
| merck2-R42193_a_at | NDRG4 | | up |
| merck-NM_022744_at | C16orf58 | | up |
| merck-X96653_s_at | SNORD54 | | up |
| merck-NM_015039_at | NMNAT2 | | up |
| merck-NM_013447_at | EMR2 | | up |
| merck2-XM_001128702_at | SGPP2 | | up |
| merck-NM_023930_at | KCTD14 | | up |
| merck-NM_006277_s_at | ITSN2 | | up |
| merck-NM_018936_at | PCDHB2 | | up |
| merck-NM_002407_at | SCGB2A1 | | up |
| merck-NM_016929_at | CLIC5 | | up |
| merck2-BC084547_at | NCKAP1L | | up |
| merck-AK097258_s_at | DOK3 | | up |
| merck-ENST00000325348_s_at | C8orf30A | | up |
| merck-NM_005978_at | S100A2 | | up |
| merck-NM_145000_at | RANBP3L | | up |
| merck-NM_001782_at | CD72 | | up |
| merck2-CB055265_at | CD81 | | up |
| merck2-NM_002917_at | RFNG | | up |
| merck2-BX647769_at | ANKRD36 | | up |
| merck-NM_005950_s_at | MT1G | | up |
| merck-NM_018226_at | RNPEPL1 | | up |
| merck-BC070352_x_at | IGLV3-21 | | up |
| merck2-BU564645_at | STAG2 | | up |
| merck-NM_152386_a_at | SGPP2 | | up |
| merck-NR_002736_s_at | RAB26 | | up |
| merck2-CR976782_at | AHNAK | | up |
| merck2-BC009851_at | IGHM | | up |
| merck2-NM_033130_at | SIGLEC10 | | up |
| merck-NM_003914_at | CCNA1 | | up |
| merck-AK095776_a_at | THRB | | up |
| merck-NM_005562_at | LAMC2 | | up |
| merck2-NM_198490_at | RAB43 | | up |
| merck-NM_031244_at | SIRT5 | | up |
| merck-AK023855_at | PAX8 | | up |
| merck-XM_936535_at | NDOR1 | | up |
| merck-NM_024947_at | PHC3 | | up |
| merck-ENST00000260257_at | FDXACB1 | | up |
| merck-NM_015481_s_at | ZNF385A | | up |
| merck-NM_080616_a_at | C20orf112 | | up |
| merck-ENST00000375678_s_at | C20orf112 | | up |
| merck2-W94916_at | CTDSPL | | up |
| merck2-BF914623_at | CFLAR | | up |
| merck-NM_016356_at | DCDC2 | | up |
| merck2-NM_182756_at | SPDYA | | up |
| merck-NM_005241_a_at | EVI1 | | up |
| merck-CN335383_a_at | TBC1D1 | | up |
| merck2-DC428989_at | HNRNPK | | up |
| merck2-NM_212479_at | ZMYND11 | | up |
| merck2-ENST00000376573_at | PIP4K2A | | up |
| merck-NM_032207_at | C19orf44 | | up |
| merck-NM_007121_at | NR1H2 | | up |
| merck-NM_020944_at | GBA2 | | up |
| merck-ENST00000372765_a_at | CAMK2G | | up |
| merck2-BC002829_at | S100A2 | | up |
| merck-NM_002769_s_at | PRSS1 | | up |
| merck-NM_001040424_at | PRDM15 | | up |
| merck-AF390894_a_at | SLAMF7 | | up |
| merck-BC013107_at | WDR42A | | up |
| merck2-DB293898_a_at | BAZ2A | | up |
| merck-ENST00000361975_a_at | SETD2 | | up |
| merck2-BM838001_at | RAB8A | | up |
| merck-NM_004409_s_at | DMPK | | up |
| merck-NM_001683_a_at | ATP2B2 | | up |
| merck-AK097071_s_at | IGHM | | up |
| merck-NM_021228_at | SCAF1 | | up |
| merck2-BX648451_at | KIAA1217 | | up |
| merck-BCl11487_a_at | TTC7A | | up |
| merck-BC029891_a_at | TFEC | | up |
| merck-NM_015852_at | ZNF117 | | up |
| merck-NM_017865_s_at | ZNF692 | | up |
| merck-BC014211_x_at | TCEA2 | | up |
| merck-G30809_at | ARF5 | | up |
| merck2-BU634330_at | NCK1 | | up |
| merck-NM_152604_s_at | ZNF383 | | up |
| merck-BG677853_a_at | LAMC2 | | up |
| merck-NM_133178_at | PTPRU | | up |
| merck-NM_153022_s_at | C12orf59 | | up |
| merck-NM_014270_at | SLC7A9 | | up |
| merck-BP195474_a_at | SPOCK2 | | up |
| merck-NM_005512_at | LRRC32 | | up |
| merck2-CN429342_at | RERE | | up |
| merck2-DQ892684_at | ITGB2 | | up |
| merck-NM_005248_s_at | FGR | | up |
| merck-NM_019110_s_at | ZKSCAN4 | | up |
| merck-NM_007188_at | ABCB8 | | up |
| merck-AF043143_s_at | IL1RN | | up |
| merck-NM_019092_s_at | FAM63B | | up |
| merck-NM_007181_at | MAP4K1 | | up |
| merck-ENST00000367602_at | QSOX1 | | up |
| merck2-AJ012501_at | STX11 | | up |
| merck-ENST00000375799_at | PLEKHM2 | | up |
| merck-NM_148966_at | TNFRSF25 | | up |
| merck-NM_014211_at | GABRP | | up |
| merck-NM_006147_at | IRF6 | | up |
| merck2-NM_015474_at | SAMHD1 | | up |
| merck-NM_000647_s_at | CCR2 | | up |
| merck2-NM_002020_at | FLT4 | | up |
| merck-ENST00000377746_at | SLC45A4 | | up |
| merck2-AK025676_a_at | RNF213 | | up |
| merck2-BY795924_at | AKAP8L | | up |
| merck-NM_182557_s_at | BCL9L | | up |
| merck-NM_032663_a_at | USP30 | | up |
| merck-NM_033204_at | ZNF101 | | up |
| merck-NM_001009941_a_at | ANKRD16 | | up |
| merck2-AY312431_at | SGMS1 | | up |
| merck-ENST00000313975_s_at | CSNK1G2 | | up |
| merck2-AI918932_s_at | ENTPD1 | | up |
| merck-NM_001001430_s_at | TNNT2 | | up |
| merck-CD672190_a_at | PLCE1 | | up |
| merck-NM_007162_s_at | TFEB | | up |
| merck2-NM_015488_a_at | PNKD | | up |
| merck-AK027045_at | ZBTB3 | | up |
| merck-AK095013_at | SLC8A1 | | up |
| merck2-NM_172231_x_at | SF4 | | up |
| merck-NM_001488_s_at | TADA2L | | up |
| merck-NR_002437_s_at | SNORD54 | | up |
| merck-NM_017576_at | KIF27 | | up |
| merck-L43092_x_at | IGLV3-19 | | up |
| merck2-DA660473_at | BIRC2 | | up |
| merck-NM_152609_s_at | C1orf71 | | up |
| merck-AK127693_s_at | PLCB1 | | up |
| merck-NM_024886_at | C10orf95 | | up |
| merck-NM_004362_at | CLGN | | up |
| merck2-NM_001045556_at | SLA | | up |
| merck-CR591922_a_at | FCGR1A | | up |
| merck-BC002976_s_at | CYB561 | | up |
| merck-AI218739_at | CCDC123 | | up |
| merck-NM_018950_x_at | HLA-F | | up |
| merck2-BC009418_at | CHODL | | up |
| merck-NM_018423_at | STYK1 | | up |
| merck-BC050449_a_at | ARFGEF2 | | up |
| merck-NM_138352_a_at | SAMD1 | | up |
| merck-NM_000216_at | KAL1 | | up |
| merck2-DQ892100_a_at | CLGN | | up |
| merck-AY260572_a_at | FLVCR2 | | up |
| merck2-NM_023930_at | KCTD14 | | up |
| merck-NM_022147_at | RTP4 | | up |
| merck-NM_024015_at | HOXB4 | | up |
| merck2-AB208798_at | PSD4 | | up |
| merck-NM_001454_at | FOXJ1 | | up |
| merck-DA674734_a_at | VCL | | up |
| merck2-EL734573_a_at | TRAF3IP1 | | up |
| merck-NM_016464_at | TMEM138 | | up |
| merck2-NM_018179_at | ATF7IP | | up |
| merck-NM_022872_at | IFI6 | | up |
| merck-ENST00000299927_a_at | ZNF592 | | up |
| merck-NM_015650_a_at | TRAF3IP1 | | up |
| merck-AK090648_x_at | ZNF273 | | up |
| merck-NM_003064_at | SLPI | | up |
| merck2-AL541942_x_at | NOTCH3 | | up |
| merck-NM_001040031_at | CD37 | | up |
| merck2-NM_014687_at | KIAA0226 | | up |
| merck-NM_018089_at | ANKZF1 | | up |
| merck-NM_033104_a_at | STON2 | | up |
| merck-NM_005258_at | GCHFR | | up |
| merck-NM_004838_at | HOMER3 | | up |
| merck-NM_019085_at | FBXL19 | | up |
| merck2-DA731322_at | RBAK | | up |
| merck-NM_025231_at | ZSCAN16 | | up |
| merck-NM_017434_at | DUOX1 | | up |
| merck-NM_002251_at | KCNS1 | | up |
| merck2-ENST00000358605_at | REST | | up |
| merck-CR602154_s_at | RNASEH2C | | up |
| merck-NM_001024593_at | ZMYND17 | | up |
| merck-NM_001017981_at | RNF215 | | up |
| merck-NM_003042_at | SLC6A1 | | up |
| merck-U37283_s_at | MFAP5 | | up |

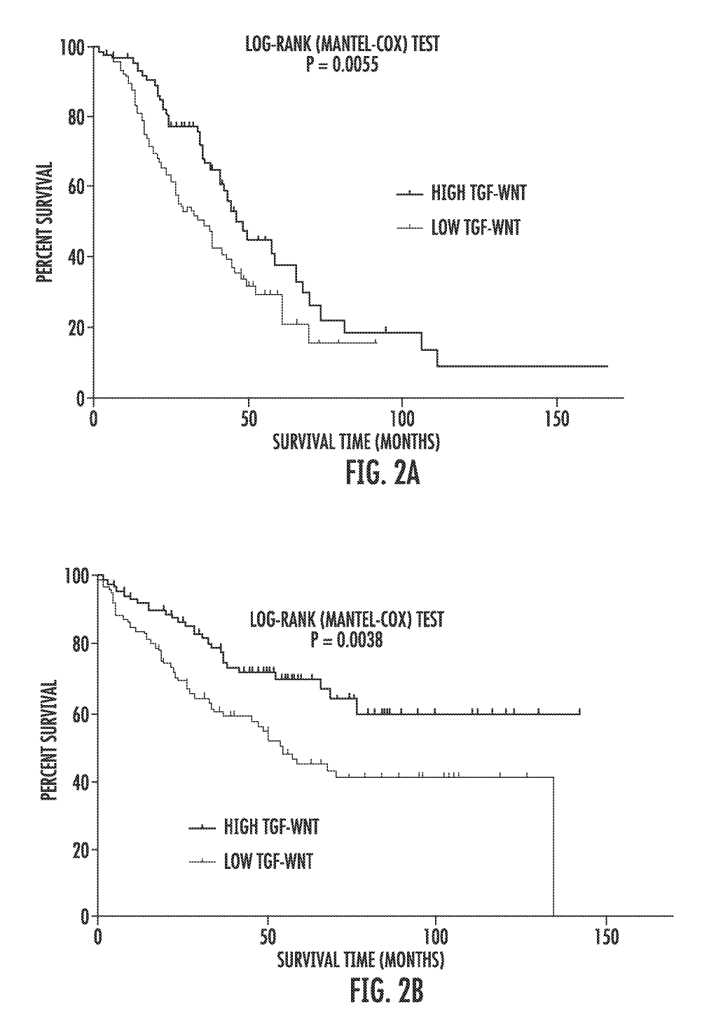

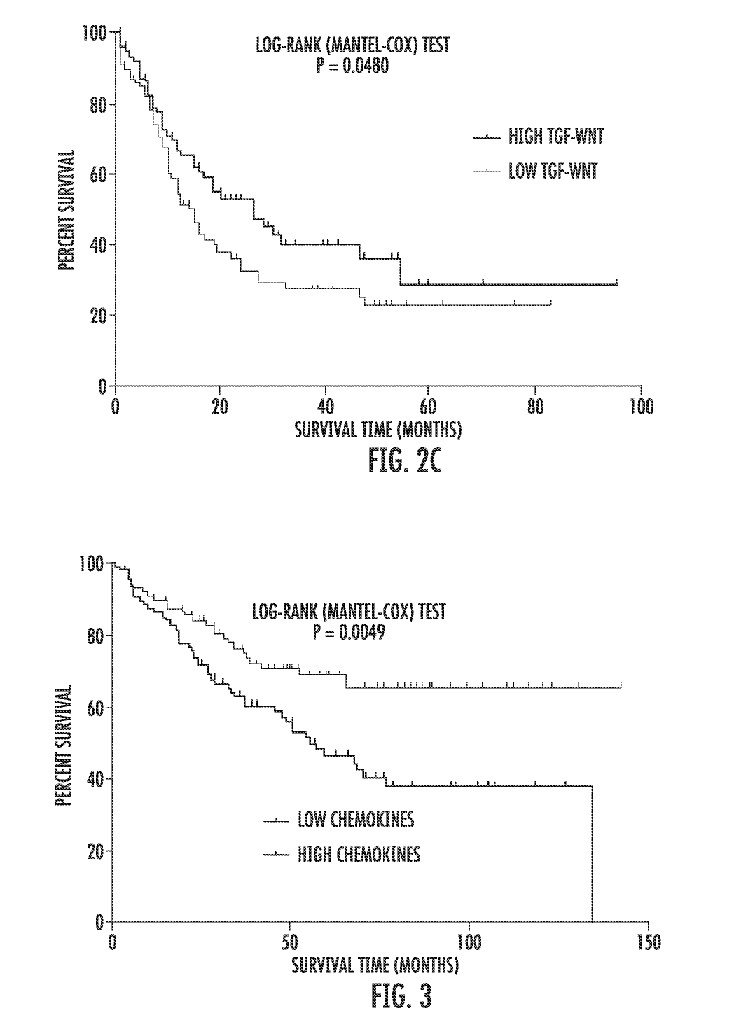

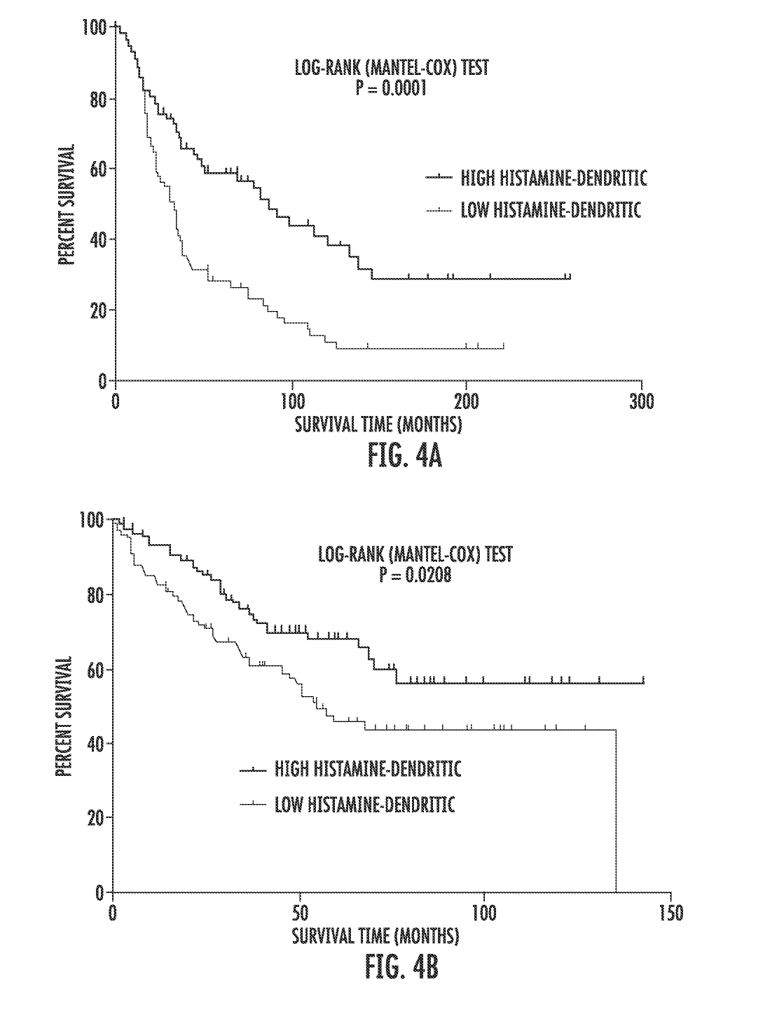

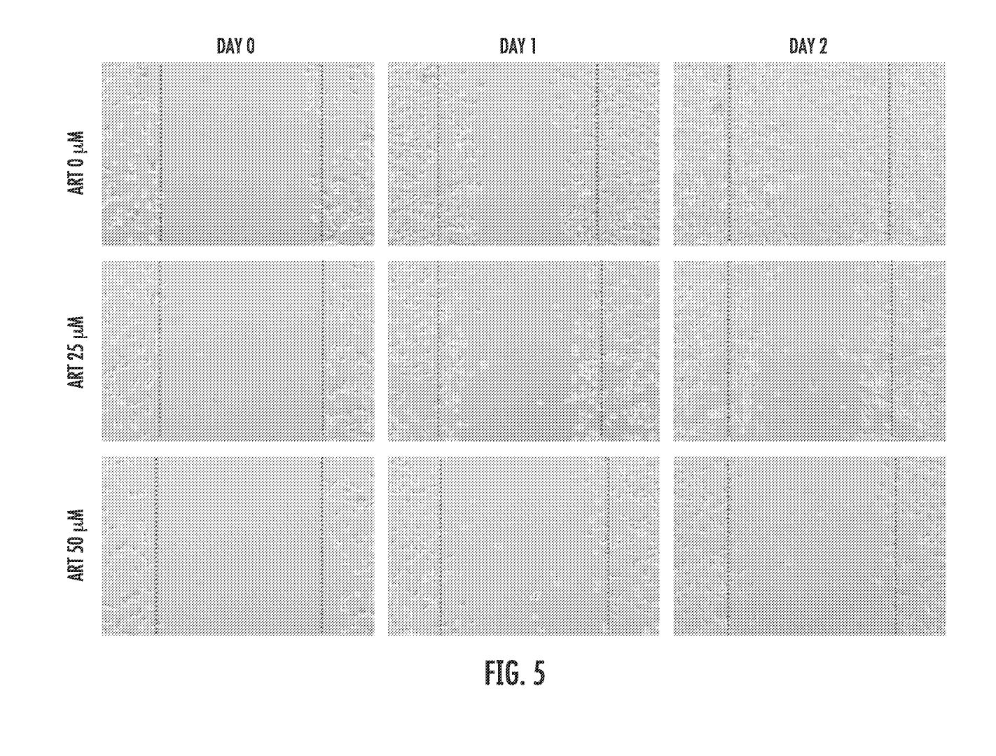

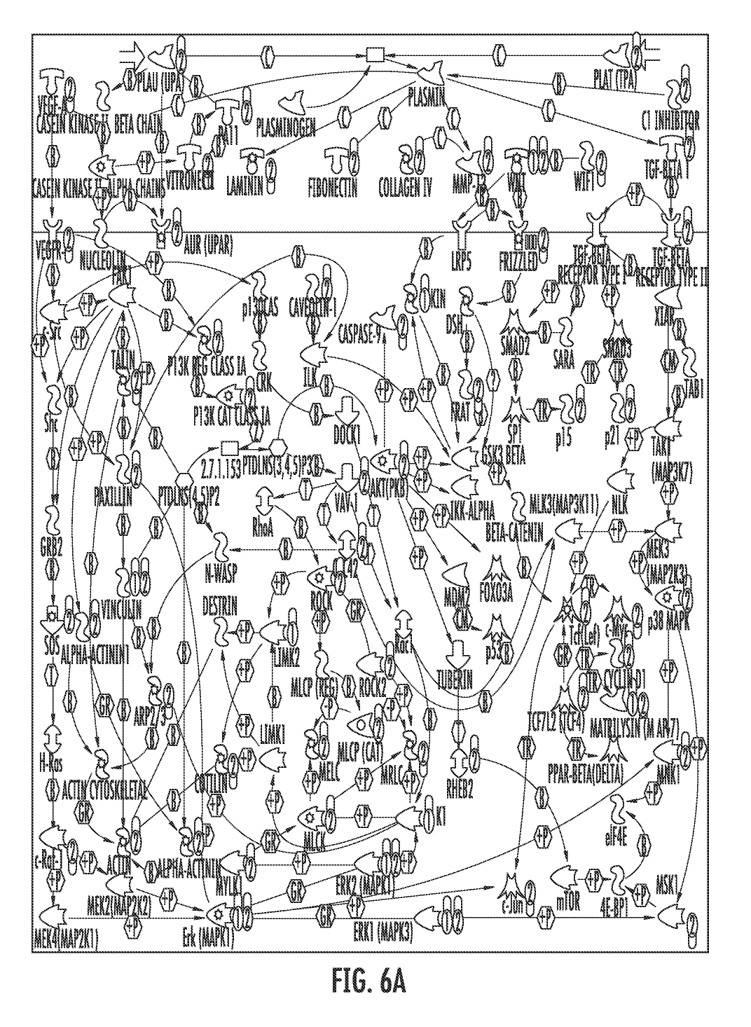

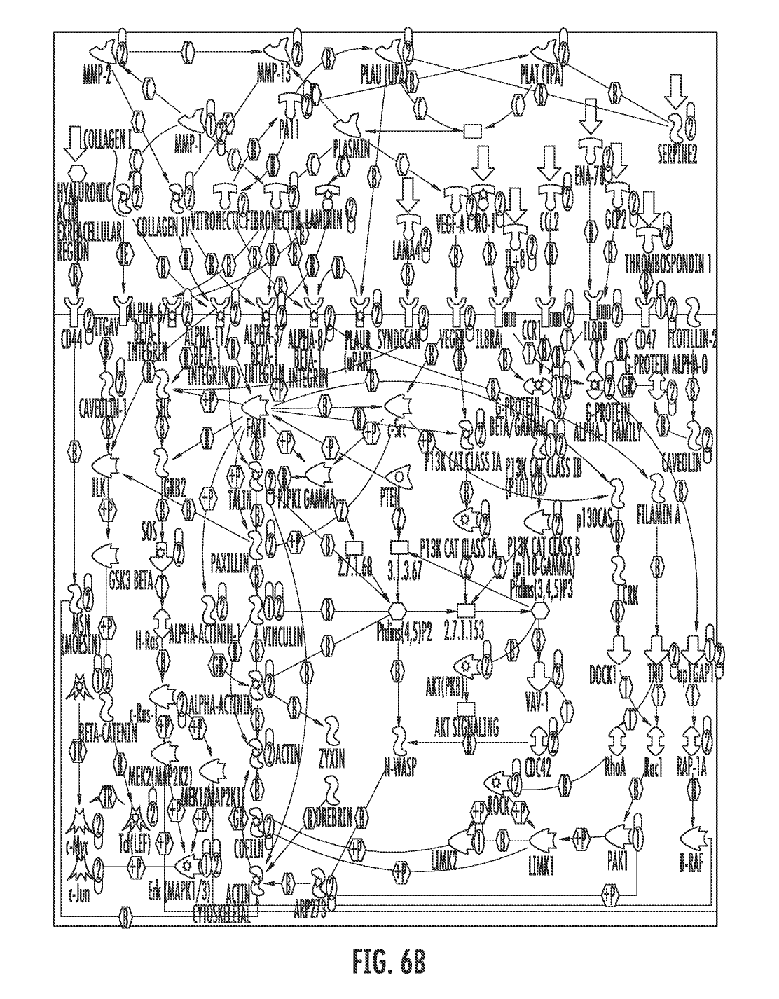

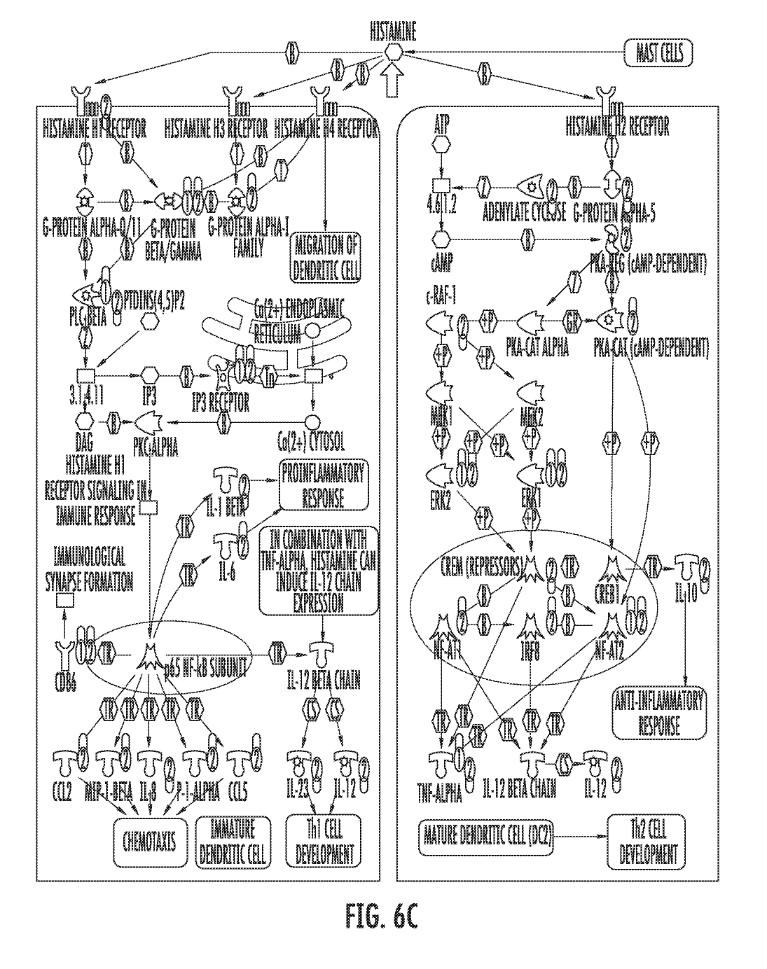

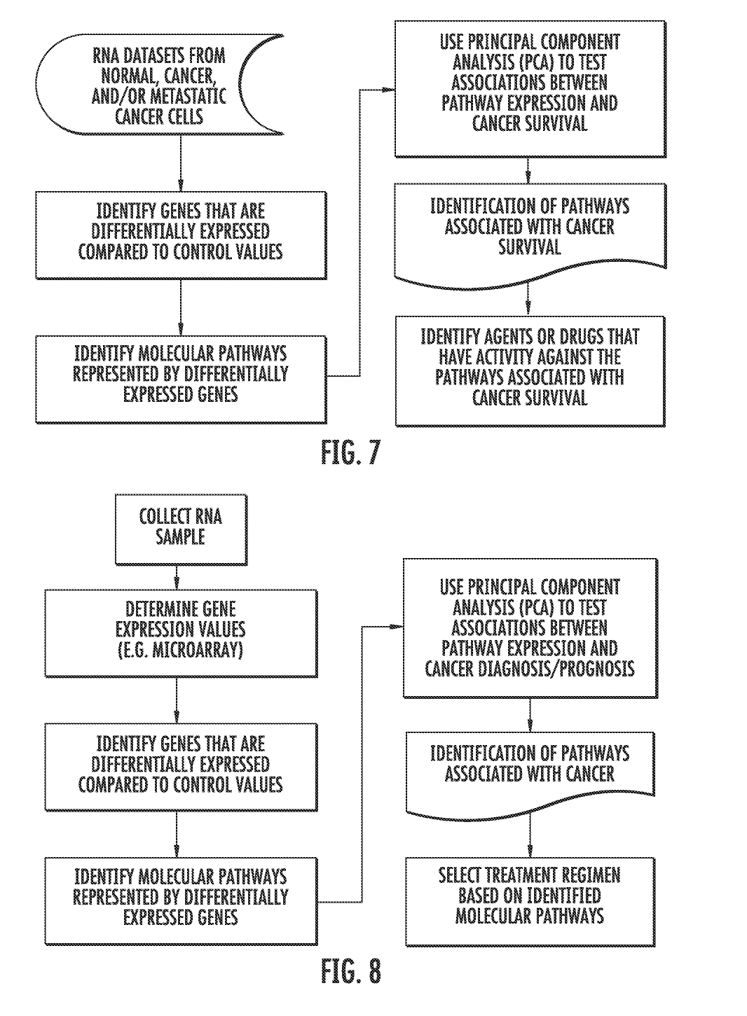

Expression of the TGF-WNT/cytoskeleton remodeling pathway was associated with survival from OVCA (n=218, P=0.006, FIG. 2A), colon cancer (n=177, P=0.004, FIG. 2B), and leukemia (n=182, P=0.047, FIG. 2C). The chemokines/cell adhesion pathway was associated with survival from colon cancer (n=177, P=0.005, FIG. 3), and the histamine signaling/immune response pathway was associated with survival from OVCA (n=142, P<0.001, FIG. 4A) and colon cancer (n=177, P=0.02, FIG. 4B).

Inhibition of the TGF-WNT/Cytoskeleton Remodeling Pathway Prevents Cell Migration

In light of the TFG-WNT/cytoskeleton remodeling pathway expression associations and its influence on metastatic activity in other cancer types, functional studies were performed to evaluate the effect of this pathway on OVCA cellular metastatic characteristics, specifically the influence of inhibition of this pathway using artesunate (Akhmetshina A, et al. Nat Commun 2012 3:735; Li P C, et al. Cancer Res 2008 68:4347-51) on OVCA cell migratory ability. Inhibition of TGF-WNT signaling using 25 mM or 50 mM artesunate decreased HeyA8 OVCA cell proliferation by approximately 42% and 64%, respectively, and impaired the ability of the cells to migrate into the denuded area (FIG. 5). In contrast, cells cultured in media containing DMSO vehicle completely filled in the gap within 2 days (FIG. 5).

Comments

The above findings indicate that advanced-stage OVCA has a unifocal origin in the pelvis. Disclosed are pathways associated with metastasis of OVCA as well as metastasis/recurrence and overall survival from multiple human cancers. These functional studies suggest that such pathways represent appealing therapeutic targets for patients with metastatic disease.

The p53 gene is known to be mutated in 30-80% of OVCAs (Okamoto A, et al. Cancer Res 1991 51:5171-6; Salani R, et al. Int J Gynecol Cancer 2008 18:487-91). Because there is a strong selection for these mutations to be distributed over the conserved regions of the gene, the sequence of p53, exons 5-8 was compared. Of 30 primary pelvic lesions tested, 11 (37%) containing DNA mutations. In every case, the matched extrapelvic implant contained an identical mutation. Subsequently, analysis of allele loss on chromosome 17 in 16 OVCA samples revealed identical patterns of allelic deletions in all samples resected from the same patient, irrespective of the collection site (Tsao S W, et al. Gynecol Oncol 1993; 48:5-10). In 4 of 16 informative samples, the analysis of the hypoxanthine phosphoribosyl transferase gene showed that the same parental allele was methylated in samples collected from the primary and metastatic sites (Tsao S W, et al. Gynecol Oncol 1993 48:5-10).

The data generated here support a unifocal origin of advanced-stage OVCA. Moreover, 3 pathways (TGF-WNT/cytoskeleton remodeling, chemokines/cell adhesion, and histamine signaling/immune response) were identified that are not only associated with advanced, metastatic, or recurrent disease but also with overall survival from a range of cancers.

Unless defined otherwise, all technical and scientific terms used herein have the same meanings as commonly understood by one of skill in the art to which the disclosed invention belongs. Publications cited herein and the materials for which they are cited are specifically incorporated by reference.

Those skilled in the art will recognize, or be able to ascertain using no more than routine experimentation, many equivalents to the specific embodiments of the invention described herein. Such equivalents are intended to be encompassed by the following claims.

1. An in silico method to identify therapeutic agents to treat cancer, comprising:
(a) evaluating gene expression datasets to identify genes differentially expressed in cancer and/or metastatic cells,
(b) identifying molecular pathways represented by the differentially expressed genes,
(c) evaluating the molecular pathways for associations with metastasis and/or cancer survival as an indication of biological relevance, and
(d) identifying agents or drugs that have activity against the pathways associated with metastasis and/or cancer survival.

2. The method of claim 1, wherein step (a) comprises identifying genes whose expression is increased or decreased in the cancer cells by at least 100%.

3. The method of claim 1, wherein the genes are identified with a False Discovery Rate (FDR) less than 0.05.

4. The method of claim 1, wherein step (b) comprises the use of principal component analysis (PCA) to summate the expression of each molecular pathway in cancer survival datasets into a single numeric value.

5. The method of claim 1, wherein the cancer is an epithelial cancer.

6. The method of claim 5, wherein the cancer is ovarian cancer.

7. The method of claim 1, wherein the molecular pathways are selected from the group consisting of TGF-WNT/cytoskeleton remodeling pathway, WNT2 pathway, integrin pathway, chemokines/cell adhesion pathway, and histamine signaling/immune response pathway.

8. The method of claim 1, wherein step (d) comprises in silico screening of a database of candidate agents catalogued by molecular pathway activity.

9. The method of claim 1, wherein step (d) comprises repurposing a drug not previously used to treat cancer.

10. A in silico method for selecting cancer treatment regimen for a subject, comprising:
(a) assaying an RNA sample from a tumor biopsy of the subject to identify genes differentially expressed compared to a control;
(b) identifying molecular pathways represented by the differentially expressed genes,
(c) generating a score that summarizes the overall gene expression of one or molecular pathways comprising differentially expressed genes; and
(d) selecting a cancer treatment regimen for the subject based on the molecular pathways associated with the subject's cancer.

11. The method of claim 10, wherein step (a) comprises identifying genes whose expression is increased or decreased in the cancer by at least 100% compared to the control.

12. The method of claim 10, wherein the genes are identified with a False Discovery Rate (FDR) less than 0.05.

13. The method of claim 10, wherein step (c) comprises the use of principal component analysis (PCA) to summate the expression of the one or more molecular pathways into a single numeric value.

14. The method of claim 10, wherein the cancer is ovarian cancer.

15. The method of claim 10, wherein the one or more molecular pathways are selected from the group consisting of TGF-WNT/cytoskeleton remodeling pathway, WNT2 pathway, integrin pathway, chemokines/cell adhesion pathway, and histamine signaling/immune response pathway.
